(19) United States
(12) Patent Application Publication
(10) Pub. No.: US 2010/0265179 A1
(43) Pub. Date: Oct. 21, 2010

(54) COMPUTER APPARATUS WITH ADDED FUNCTIONALITY

(76) Inventor: Pranil Ram, Makati City (PH)

Correspondence Address: MR. PRANIL RAM, c/o APT. 313, 6390 WILLINGDON AVE, BURNABY, BC, V5H2V5, CA

(21) Appl. No.: 12/816,531

(22) Filed: Jun. 16, 2010

Related U.S. Application Data
(63) Continuation of application No. 11/609,991, filed on Dec. 13, 2006.
Application No. 11/609,991 is a continuation-in-part of application No. 11/160,090, filed on Jun. 8, 2005, now abandoned.
(60) Provisional application No. 60/577,593, filed on Jun. 8, 2004.
(60) Provisional application No. 60/597,601, filed on Dec. 13, 2005.
(60) Provisional application No. 60/597,745, filed on Dec. 19, 2005.

(51) Int. Cl. G06F 3/033; G06F 3/02

(52) U.S. Cl. 345/163; 345/168

(57) ABSTRACT

A computer apparatus such as a mouse apparatus or a keyboard apparatus with additional functionality or features disposed within the apparatus enclosure. Each additional functionality enhances the overall functionality of the computer apparatus. In the preferred embodiments, the additional devices include a remote control, a multiple host mouse apparatus, a multiple host keyboard apparatus, various trackpoint-style devices and other control devices, mouse apparatus with various integrated displays and various means of extending or retracting said integrated displays, fingerprint readers, USB receptacles and hub devices, various mouse apparatus enclosure covers with various devices disposed within said enclosure cover, a fuel cell, a dual sensor mouse apparatus, miniature mouse apparatus and their associated wireless transmitters, keyboard apparatus with IR and IrDA remote control ports, solar panels as a power source, and the like.

### CROSS-REFERENCE TO RELATED APPLICATIONS

This application is a continuation of U.S. patent application Ser. No. 11/609,991, filed Dec. 13, 2006, and entitled “Computer Apparatus with added functionality” which is a continuation-in-part of U.S. patent application Ser. No. 11/160,090, filed Jun. 8, 2005, and entitled “Computer Apparatus with added functionality” which claims the benefit of priority to U.S. Provisional Patent Application Ser. No. 60/577,593, filed Jun. 8, 2004. U.S. patent application Ser. No. 11/609,991 filed Dec. 13, 2006 further claims the benefit of priority to U.S. Provisional Patent Application Ser. No. 60/597,601, filed Dec. 13, 2005, and U.S. Provisional Patent Application Ser. No. 60/597,745, filed Dec. 19, 2005. Each of the applications referred to above are incorporated by reference in their entirety into this application.

### COPYRIGHT NOTICE

This document contains material that is subject to copyright protection. The applicant has no objection to the facsimile reproduction of this patent document, as it appears in the U.S. Patent and Trademark Office (PTO) patent file or records or in any publication by the PTO or counterpart foreign or international instrumentalities. The applicant otherwise reserves all copyright rights whatsoever.

### FIELD OF THE INVENTION

This invention relates generally to computer peripherals such as a computer mouse apparatus and keyboard apparatus, and more particularly, to incorporating additional devices, functionality, or features within such computer apparatus.

### BACKGROUND OF THE INVENTION

The computer mouse has become an essential component of desktop computing since graphical user interface was popularized in the 1980s with by the introduction of the Apple Macintosh.

In the succeeding 20 years, the computer mouse has undergone a series of innovations including the addition of a right- and left-click button, a scroll wheel, an optical sensor, a track ball sensor, a laser sensor, and wireless communication to the host PC.

A mouse requires an ergonomic shape to fit comfortably into the hand, which is one factor that has kept its size relatively stable. However, the internal electronics of the mouse follows a trend to become miniaturized with many circuits integrated within a single chip, perhaps in an attempt by manufacturers to reduce costs as well as size. Computer peripherals are often distributed as stand alone products, with the cost of manufacturing and distribution to retailers is a significant portion of the retail cost.

There is room within a typical mouse enclosure, as well as the enclosures of other peripheral devices, for added functionality. With so many standalone devices connected to a host PC, there is a need to combine devices within a single device or apparatus for reasons of economy, practicality, and convenience. Thus, it is an objective of the present invention to combine one or more additional devices within a mouse apparatus, or a related computer peripheral such as a keyboard, to obtain additional functionality and convenience for the user without the need to carry multiple stand alone products that add clutter and bulk.

### BRIEF SUMMARY OF THE INVENTION

A computer apparatus of the present invention include a mouse apparatus or a keyboard apparatus with additional functionality or features disposed within the apparatus enclosure. Each additional functionality enhances the overall functionality of the computer apparatus. In the preferred embodiments, the additional devices include a remote control, a multiple host mouse apparatus, a multiple host keyboard apparatus, various trackpoint-style control devices, mouse apparatus with various integrated displays and various means of extending or retracting said integrated displays, fingerprint readers, USB receptacles and hub devices, various mouse apparatus enclosure covers with various devices disposed within said enclosure cover, a fuel cell, a dual sensor mouse apparatus, miniature mouse apparatus and their associated wireless transmitters, keyboard apparatus with IR and IrDA remote control ports, solar panels as a power source, and the like.

The present invention provides an optical computer mouse with an embedded wireless adapter connected to its host PC by a USB connector. A USB hub or hub/bridge is also embedded within the mouse enclosure to allow the wireless adapter to share the single USB connection to the host PC.

A Trackpoint device or a Trackball may be incorporated into the mouse enclosure to function as a cursor-pointing device and/or a window scroll-control device. The trackball device serves as the mouse's motion sensor and is used for cursor-pointing function.

The computer mouse may be configured as a wired or wireless device. In a wired configuration, any wireless communications adapter may serve to add wireless capability to the host PC or a network device. In a wireless configuration, the wireless communications adapter serves to enable the devices embedded within the mouse enclosure to communicate with and support the host PC or a network device.

RAM memory and/or a flash memory card reader may also be incorporated into either the base USB connector unit or the mouse enclosure. There is no need to install a separate wireless network adapter to the host PC. The wireless or Wi-Fi adapter is built-in into the mouse apparatus.

The computer mouse apparatus also discloses how multiple devices, commonly purchased by computer users, may share a common mouse enclosure to reduce manufacturing, packaging, and distribution costs relative to individually packaged USB or PC Card devices.

In accordance with another aspect of the present invention, a computer mouse may serve as a network mouse attached to a host PC or computer device via a USB connection or similar cable connection. A multiple port USB hub device may be embedded within the mouse enclosure and serves to network the embedded devices to the host PC. The computer mouse may be configured to function as a wired or wireless network mouse. The mouse can have a network connection that can access or provide input to a number of target devices connected to the network, not just the host PC.

In accordance with another aspect of the present invention, a computer mouse may also contain one or more of the following devices which may be integrated or removable from the mouse enclosure: a USB or network hub, a connector, a module, a modem, a sensor, an on/off switch, a temperature sensor, a USB on-the-go bridge controller device, an encryption chip or hardware, a digital signal processing device, a modem circuitry, a display device, a digital camera, a webcam, CPU and the like. Such devices may function individually and/or in combination with the other devices, sensors, and electronics to add to or enhance the function of the computer mouse apparatus. The additional components may share one or more wired or wireless paths to a host PC and to other devices, or to a network.

In accordance with an additional aspect of the present invention, a CPU and its associated chipsets or a system-on-a-chip device may be utilized within the computer mouse apparatus. Such a CPU or system chip may serve to manage computer processing tasks within the mouse enclosure rather than relying solely on the host PC's processing power. Such a mouse apparatus may run a proprietary OS, a Palm OS 3, 4 or 5, Pocket PC, SmartPhone, PalmSource, Symbian, Java, Microsoft, and Linux operating systems or any desktop O/S such as Windows XP. A built-in CPU or system chip would enable the mouse electronics and the remaining embedded devices to function as a small self-contained computer.

In accordance with yet another aspect of the present invention, the mouse apparatus may incorporate USB host capability that may store data to or retrieve data from the memory card utilizing the computer mouse's built-in wireless communications module.

The computer mouse apparatus of the present invention is environmentally friendly, as it reduces the manufacturing, packaging, and distribution costs of multiple discrete devices manufactured or sold as separate discrete devices.

Also disclosed, are software controls for mapping the mouse velocity to a cursor velocity and for controlling the function and settings of the Trackpoint device. Further disclosed is a method for assigning the mouse's data output to a variety of devices connected to a wired or wireless network.

The foregoing summary of the present invention is not intended to describe every implementation of the present invention. Additional aspects and advantages of the invention will be readily apparent from the following detailed description of preferred embodiments thereof, which proceeds with references to the accompanying drawings.

### BRIEF DESCRIPTION OF THE DRAWINGS

FIG. 1 illustrates a top view of a computer mouse apparatus incorporating a Trackpoint™ device.

FIG. 2 illustrates a top view of a computer mouse apparatus with a Trackpoint sensor in an alternative location to that shown in FIG. 1.

FIG. 3 illustrates a side view of the computer mouse apparatus as shown in FIG. 1.

FIG. 4 illustrates a front view of the computer mouse apparatus as shown in FIG. 1.

FIG. 5 illustrates a top view of a computer mouse apparatus with a Trackpoint sensor and a mouse scroll wheel.

FIG. 6 illustrates a top view of a cordless computer mouse apparatus with a mouse scroll wheel and a Trackpoint device in an alternative arrangement to that of FIG. 5.

FIG. 7 illustrates a top view of a computer mouse apparatus with two Trackpoint devices, a button, and a flash memory reader slot.

FIG. 8 illustrates a top view of a computer mouse apparatus with a Trackpoint sensor and a built-in wireless communication adapter module with an internal antenna.

FIG. 9 illustrates a front view of a computer mouse apparatus with a mouse scroll wheel control, a USB plug, a USB jack, and a built in Wi-Fi adapter module with its associated external antenna.

FIG. 10 illustrates a side view of the computer mouse apparatus as shown in FIG. 8.

FIG. 11 illustrates a perspective view of a wireless computer mouse apparatus with a Trackpoint device and an associated base unit having an integrated wireless communications adapter module and an internal antenna.

FIG. 12 illustrates a perspective view of a wired computer mouse apparatus with an embedded Trackpoint device and an in-line electronics housing and connection unit which incorporates an integrated wireless network adapter module and an external antenna.

FIG. 13 illustrates a top view of a computer mouse apparatus with a Trackpoint sensor and an internal group of peripheral devices which include a mini hard drive, a wireless adapter module, flash (RAM or ROM) memory, and a flash memory card reader.

FIG. 14 illustrates a top view of a computer mouse apparatus with a Touchpad cursor-pointing and/or scrolling device, and internal peripherals which include a mini hard drive, flash memory, and a flash memory card reader.

FIG. 15 illustrates a top view of a computer mouse apparatus with a 5-way navigation button.

FIG. 16 illustrates a block diagram of the representative system architecture for the computer mouse apparatus depicted in FIGS. 8 to 15, and FIGS. 17 to 25.

FIG. 17 illustrates a top view of a computer mouse apparatus with a Trackpoint sensor, a display, a flash memory card slot or SIM card reader, and a digital camera or webcam.

FIG. 18 illustrates a top view of a computer mouse apparatus with a Trackball cursor-pointing and window scrolling device, a display, a SIM card reader or flash memory card reader, and a digital camera or webcam.

FIG. 19 illustrates a side view of the computer mouse apparatus as shown in FIG. 17 with an integrated speaker or microphone element, a network connector, and a hinged display enclosure.

FIG. 20 illustrates a top view of a computer mouse apparatus with a Trackpoint cursor-pointing and window scrolling sensor, a display, a flash memory card slot, a digital camera, a number keypad or keyboard, and an optional recharging unit.

FIG. 21 illustrates a side view of the computer mouse apparatus as depicted in FIG. 20, showing a representation of a printed circuit board, a flash memory card slot, and a hinged display assembly.

FIG. 22 illustrates a top view of a computer mouse apparatus with a mouse scroll wheel device, a display, a flash memory card slot, and a digital camera.

FIG. 23 illustrates a top view of a computer mouse apparatus with a 5-way navigation button, a display, a flash memory slot, a digital camera, and a numerical keypad or keyboard.

FIG. 24 illustrates a top view of a computer mouse apparatus with a Trackpoint sensor, a display, a flash memory card slot, a digital camera, a biometric fingerprint scanner, and an ID card or SIM card slot.

FIG. 25 illustrates a top view of a computer mouse apparatus with a Touchpad cursor-pointing and/or window scrolling device, a display, a flash memory card slot, a webcam camera, and a group of keys which are representative of function keys, a numerical keypad, or a keyboard.

FIG. 26 is a block diagram of a simplified USB hub integrated in the computer mouse apparatus.

FIG. 27 shows a simplified block diagram of an 802.11 networking chipset; the host interface implements functions that allow the chipset to interface with a host system such as a computer.

FIG. 28 shows a system block diagram of a wireless computer mouse apparatus with an integrated USB OTG bridge controller and USB hub chip, mouse electronics, a wireless communications adapter, and several embedded devices.

FIG. 29 illustrates a perspective view of a USB-based PC headset apparatus with added device functionality.

FIG. 30 illustrates a top view of a wired keyboard apparatus with added device functionality.

FIG. 31 shows a representative display of a Properties Settings dialog box suitable for the mouse apparatus depicted in FIGS. 8 to 15 and FIGS. 17 to 25.

FIG. 32 illustrates a perspective view of a computer mouse apparatus with its enclosure door in an open position to show a mouse cavity with an integrated USB jack.

FIG. 33 illustrates a perspective view of a computer mouse apparatus as shown in FIG. 32, with the USB module connected into the USB jack via its associated USB plug.

FIG. 34 illustrates a perspective view of a computer mouse apparatus, similar to that shown in FIGS. 32-33, with its enclosure cover in an open position to show two module jacks of different sizes.

FIG. 35 illustrates a perspective view of a wireless computer mouse apparatus with an integrated PCMCIA slot.

FIG. 36 illustrates a perspective view of a wireless computer mouse apparatus as shown in FIG. 35, with the PCMCIA module connected into the PCMCIA slot via the PCMCIA connector.

FIG. 37 illustrates a perspective view of a wireless computer mouse apparatus with an integrated USB jack and a spring-loaded cover.

FIG. 38 illustrates a perspective view of a wireless computer mouse apparatus as shown in FIG. 37, with the USB module connected into USB jack via the USB plug.

FIG. 39 shows a computer mouse apparatus incorporating a gas sensor unit and its associated electronics.

FIG. 40 shows a computer mouse apparatus incorporating a dual cursor pointing device.

FIG. 41 shows a computer mouse apparatus on top of a companion solar panel or array of solar cells disposed within a mousepad.

FIG. 42 shows a computer mouse apparatus powered by solar energy.

FIG. 43 shows a computer mouse apparatus with an integrated optical drive disposed within the mouse enclosure and accessible through the enclosure cover.

FIGS. 44a-44b are simplified partial cross sectional views of a computer mouse apparatus taken along lines 44-44 of FIG. 1 showing a molded pressure absorbing spring that functions to reduce the stress on a miniature switch caused by a user's clicking of the mouse button.

FIGS. 45a-45b illustrate a fixedly attached pressure absorbing leaf spring, a variation of the spring design as shown in FIGS. 44a-44b.

FIGS. 46a-46b illustrate a pressure absorbing compression spring, a variation of the spring designs as shown in FIGS. 44a-45b.

FIG. 47 shows a cursor velocity tabpage, which is used to control the relationship between the velocity of the mouse movement and the velocity of the displayed cursor associated with the mouse movement.

FIG. 48 shows a simple flowchart process to control cursor velocity.

FIGS. 49-50 show in detail the operation of the two-dimensional graph of FIG. 47.

FIG. 51 shows a computer apparatus architecture typically associated with the mouse apparatus of FIGS. 17-25 in accordance with an embodiment of the present invention.

FIG. 52 shows one use of a mouse apparatus with added functionality in a PABX branch exchange telephone system located within an office environment.

FIGS. 53a and 53b show a partial view of a network mouse apparatus assigned to input data to a specific device.

FIG. 54 illustrates a typical operating environment for a network mouse apparatus.

FIG. 55 shows a configuration settings panel associated with a Trackpoint-style device present on a mouse apparatus, for example, the mouse apparatus of FIG. 40.

FIG. 56 illustrates a sensor function tabpage.

FIG. 57 illustrates a top view of a cantilevered printed circuit board (PCB), a variation of the pressure absorbing spring designs as shown in FIGS. 44a-46b.

FIG. 58 is a cross sectional view of the mouse apparatus as shown in FIG. 57 and a variation of the cross sectional views of FIGS. 44a-46b.

FIGS. 59a-59b show back views of a mouse apparatus with a built-in charger unit and a retractable wall plug located at its bottom side.

FIG. 60 shows a mouse apparatus architecture when the additional device is in a RAID system of mini hard drives.

FIG. 61 shows a block diagram of the two host PCs (host PC A and host PC B) in a wireless dual host mouse system.

FIG. 62 shows the electronic architecture block diagram of a dual host mouse apparatus enabled with Bluetooth technology.

FIG. 63 shows the schematic block diagram for the operation of the wired and wireless keyboard with multiple channels for different host PCs.

FIG. 64 illustrates the schematic block diagram of the interface of the keyboard transceiver to the host PC.

FIG. 65 shows the direct connection of the Bluetooth transceiver to the host PC.

FIG. 66 shows a perspective view of a mouse apparatus with an integrated remote control for controlling various electronic devices.

FIG. 67 shows a perspective view of a mouse apparatus with a USB port for receiving a small device such as a memory stick or flash memory device.

FIG. 68 shows a perspective view of mouse apparatus with an externally mounted serial port.

FIG. 69 shows a perspective view of mouse apparatus with an integrated biometric scanner located on the surface of the mouse apparatus.

FIG. 70 shows a perspective view of mouse apparatus with an integrated rotating control knob that may adjust the level of an assigned parameter.

FIG. 71 shows a perspective view of mouse apparatus with a Copy key, a Paste key, and a Cut key conveniently located on the top surface of the mouse apparatus.

FIG. 72 shows a perspective view of a mouse apparatus with an enclosure cavity for storing small items within the mouse apparatus, similar to the mouse cavity of FIG. 32 but without the USB jack.

FIG. 73 shows a perspective view of the mouse apparatus of FIG. 72 with its enclosure cover in the closed position.

FIGS. 74-75 show a perspective view of a mouse apparatus with enclosure cavity containing a USB jack with its enclosure cover in the open and closed position respectively.

FIG. 76 shows a perspective view of a mouse apparatus with two adjacent USB jacks contained within enclosure cavity.

FIG. 77 shows a perspective view of a mouse apparatus similar to the mouse apparatus of FIG. 74 but employing a side-mounted hinge design to secure the enclosure cover to the mouse apparatus body.

FIG. 78 shows a perspective view of a mouse apparatus similar to the mouse apparatus of FIG. 74 but employing a car trunk-style hinge design to secure the enclosure cover to the mouse apparatus body.

FIG. 79 shows a perspective view of a mouse apparatus with an integrated biometric scanner and a USB jack located within the mouse cavity.

FIG. 80 shows a perspective view of a mouse apparatus with an integrated fuel cell to power the mouse electronics.

FIG. 81 shows a perspective view of a mouse apparatus with an integrated rotating control knob similar to that depicted in FIG. 70 but located within the mouse cavity.

FIGS. 82-83 show a perspective view of the mouse apparatus with the integrated display enclosure in the open and closed position respectively.

FIG. 84 shows a perspective view of a mouse apparatus with an integrated display screen.

FIG. 85 shows a perspective view of the mouse apparatus illustrated in FIG. 84 with the display enclosure in its closed position.

FIG. 86 shows a perspective view of a mouse apparatus with an integrated clamshell-style display enclosure.

FIGS. 87-88 show perspective views of a mouse apparatus with the integrated display enclosure that is stored inside the body of the mouse apparatus in the closed and open position respectively.

FIG. 89 shows a perspective view of the mouse apparatus of FIG. 91 with its display enclosure in a closed or retracted position and stored within the mouse apparatus enclosure.

FIG. 90 shows a top view of the mouse apparatus of FIG. 89 showing the relative positions of the display enclosure and display screen in hidden outline.

FIG. 91 illustrates a schematic top view of the mouse apparatus of FIG. 89 depicting the display enclosure as it pivots from inside to outside the mouse apparatus enclosure.

FIGS. 92-94 show various views of a mouse apparatus with an integrated sliding display screen that is stored within the body of the mouse apparatus.

FIG. 95 shows a perspective view of a mouse apparatus with an integrated display enclosure and a built-in TV tuner.

FIG. 96A shows a top view of a mouse apparatus with two integrated displacement sensors.

FIG. 96B shows a representative host PC display screen and the resulting path of a GUI style cursor when the mouse apparatus of FIG. 96A.

FIG. 97 shows a top view of a mouse apparatus with an integrated display screen similar to the mouse apparatus of FIG. 95.

FIG. 98A shows a partial top view of a mouse apparatus with an integrated display screen fixedly attached to pivoting display enclosure similar to the mouse apparatus of FIG. 94.

FIG. 98B shows a diagram of the display icon highlight sequence as each display icon is selected as the scroll wheel is scrolled down the list of available applications presented on the display screen.

FIG. 99A shows a partial top view of a mouse apparatus with an integrated display screen (not shown) similar to the mouse apparatus of FIG. 92.

FIG. 99B shows a partial top view of a mouse apparatus with an integrated display screen (not shown) similar to the mouse apparatus of FIG. 86.

FIG. 100 shows a perspective view of a wireless multiple host mouse apparatus that may operate across multiple host PCs.

FIG. 101 shows a perspective view of a multiple host mouse apparatus that uses a toggle switch to switch between two host PCs in a convenient and intuitive manner.

FIGS. 102A-102C show isometric views of various wireless dongle designs, that may connect to a host PC when a multiple host mouse apparatus is used.

FIG. 103 shows an isometric view of a miniature USB mouse apparatus being connected to a USB extension cable.

FIG. 104 shows an isometric view of the miniature USB mouse apparatus illustrated in FIG. 103 being connected to a wireless dongle transmitter, the two components forming a wireless mouse.

FIG. 105 shows a perspective view of a cable-wired mouse apparatus being connected to a wireless dongle transmitter.

FIGS. 106A-106C show an isometric view of hybrid (wired and wireless) dongle adapters, suitable for supporting the function of a multiple host mouse apparatus as shown in FIGS. 100-101 or a multiple host keyboard apparatus as shown in FIGS. 107-115 and FIG. 117.

FIG. 107 shows a perspective view of a conventional keyboard attached to a host PC via a hybrid dongle.

FIG. 108 shows a perspective view of a wired multiple host keyboard apparatus with a switch to indicate the host PC to which the keyboard output (keystrokes) is directed towards.

FIG. 109 shows a perspective view of a dual keyboard apparatus containing two full sets of standard keys.

FIG. 110 shows a perspective view of a wired multiple host keyboard apparatus similar to the multiple host keyboard apparatus illustrated in FIG. 108 but with two different host PC connector ports.

FIG. 111 shows a perspective view of a hybrid multiple host keyboard apparatus that may support up to three (3) host PCs.

FIG. 112 shows a perspective view of a multiple host keyboard apparatus with an integrated remote control.

FIG. 113 shows a perspective view of a multiple host keyboard apparatus that can support multiple host PCs wirelessly.

FIG. 114 shows a perspective view of a multiple host keyboard apparatus that can support up to five (5) host PCs wirelessly.

FIG. 115 shows a perspective view of a multiple host keyboard apparatus with an integrated solar panel for powering the keyboard electronics and the wireless dongle transmitter (not shown).

FIG. 116 shows a perspective view of a multiple host keyboard apparatus similar to FIG. 112 with a wireless repeater puck that extends the range of the remote signal from the keyboard apparatus.

FIG. 117 shows a perspective view of a multiple host keyboard apparatus that supports Bluetooth and other mobile device wireless standards such as IR.

FIG. 118 shows a perspective view of a mouse apparatus with an integrated USB cable powered battery charger.

### DETAILED DESCRIPTION OF INVENTION

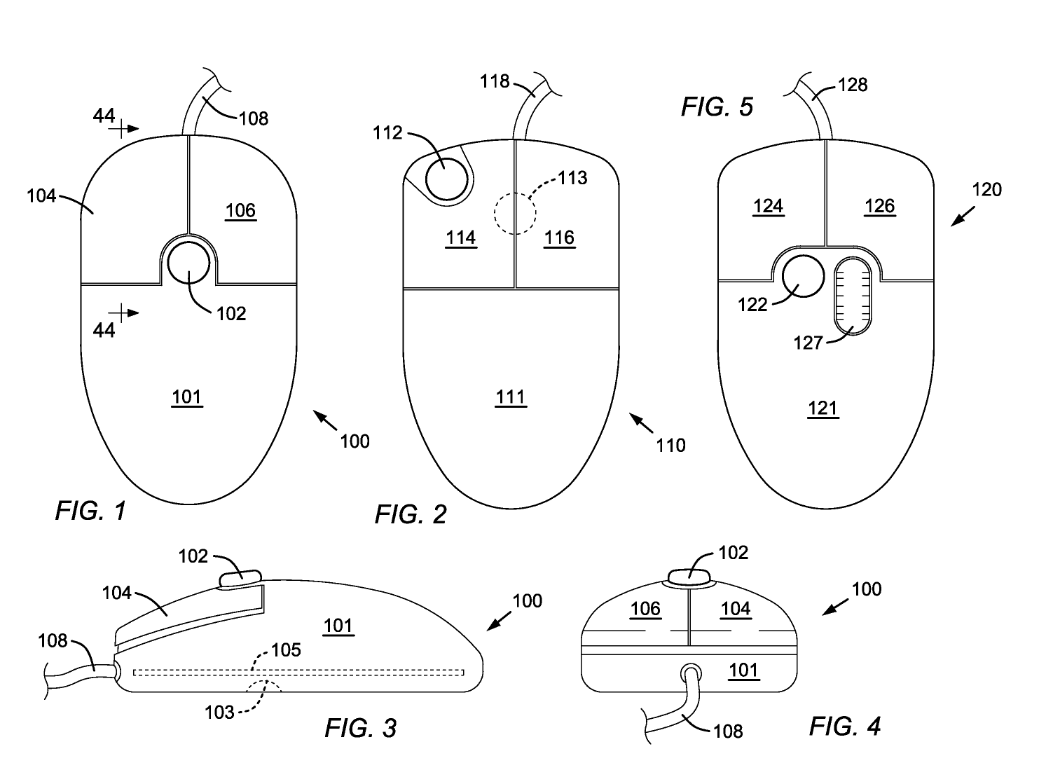

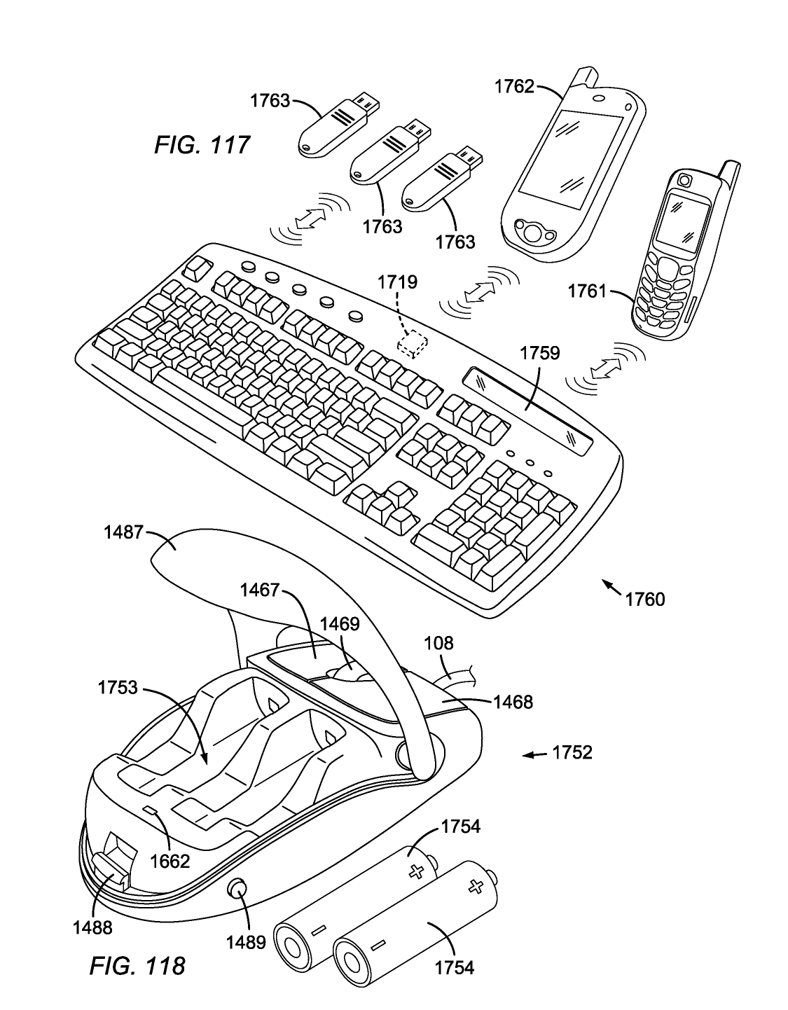

Each mouse apparatus or keyboard apparatus shown in FIGS. 1-118 with a unique reference character should be understood to be an embodiment or further embodiment of the present invention.

The present invention discloses a computer mouse apparatus with an integrated Trackpoint™ device or a similar device that functions both as a cursor-pointing device or a scroll control device. The Trackpoint device may control both cursor and scroll movements in four directions: left, right, up, and down. As a scroll control device, the Trackpoint device may replace the scroll wheel mechanism common to computer mouse devices. As a cursor-pointing device, the Trackpoint device may function in conjunction with the optical motion sensor typically located at the bottom of computer mouse devices or it may replace the function of the optical motion sensor. The Trackpoint device used in the present invention may function similarly to any generic Trackpoint device available and not necessarily the Trackpoint device manufactured and used by IBM in its computers.

The present invention also discloses how multiple devices may share a common mouse enclosure, which may drastically reduce manufacturing, packaging, and distribution costs relative to individually packaged USB or PC card (PCMCIA slot) devices such as flash memory sticks, GPS receivers, mini hard drives, Wi-Fi adapters, and network hubs. Such use of a mouse enclosure saves on the overall costs since multiple separate devices commonly purchased by computer users can be integrated or built into the mouse enclosure. With the present invention, there is no need to install a separate wireless network adapter PCI card or PCMCIA card or standalone USB wireless adapter to the host PC. The wireless or Wi-Fi adapter is built-in into the computer mouse or keyboard.

In the present invention, USB-based devices can have embedded or removable memory in the keyboard or mouse to store, backup, update, and synchronize data files. For example, a RAM in the mouse with USB or wireless connection may be adapted as a convenient backup device to store data files. A flash memory reader or flash memory incorporated within a mouse may have 32-1024 Megs of memory for back-up and data portability. This approach enables the user to take a wireless adapter and mouse with a laptop to access additional devices without a lot of tangled cords or the inconvenience of attaching separate devices one at a time. Generally, connection to all devices will be through a common USB cable.

The computer mouse apparatus may be used by travelers who desire convenience and may also be made available in hotels, restaurants, parks, bars, and other public hotspots to allow patrons to access a wireless network.

The preferred embodiment of the present invention is an optical computer mouse with an embedded wireless adapter and with the computer mouse connected to its host PC by a USB connector. A USB hub or hub/bridge is also embedded within the mouse enclosure to allow the wireless adapter to share a single USB connection to the host PC. A Trackpoint device may be incorporated into the mouse enclosure to function as a cursor-pointing device and/or a window scroll control device. RAM memory and/or a flash memory card reader may also be incorporated into the mouse enclosure or the USB connector. The computer mouse apparatus, as a wireless device, incorporates the wireless adapter, memory, and memory card reader in either the base USB connector unit or the mouse enclosure.

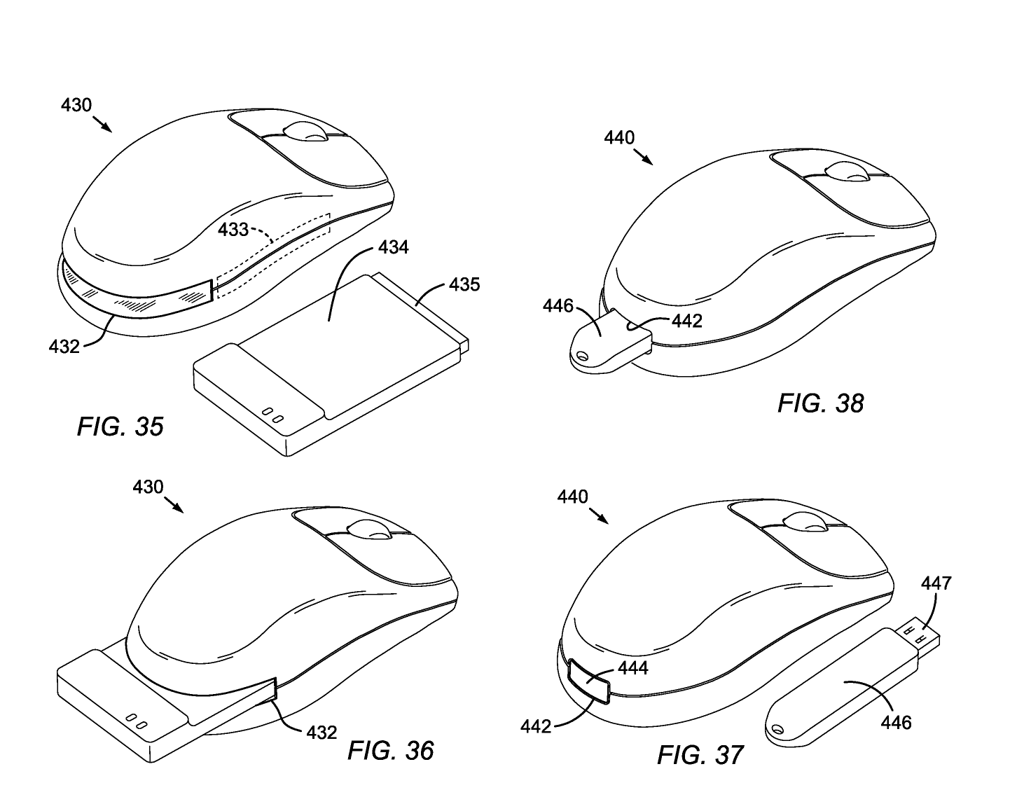

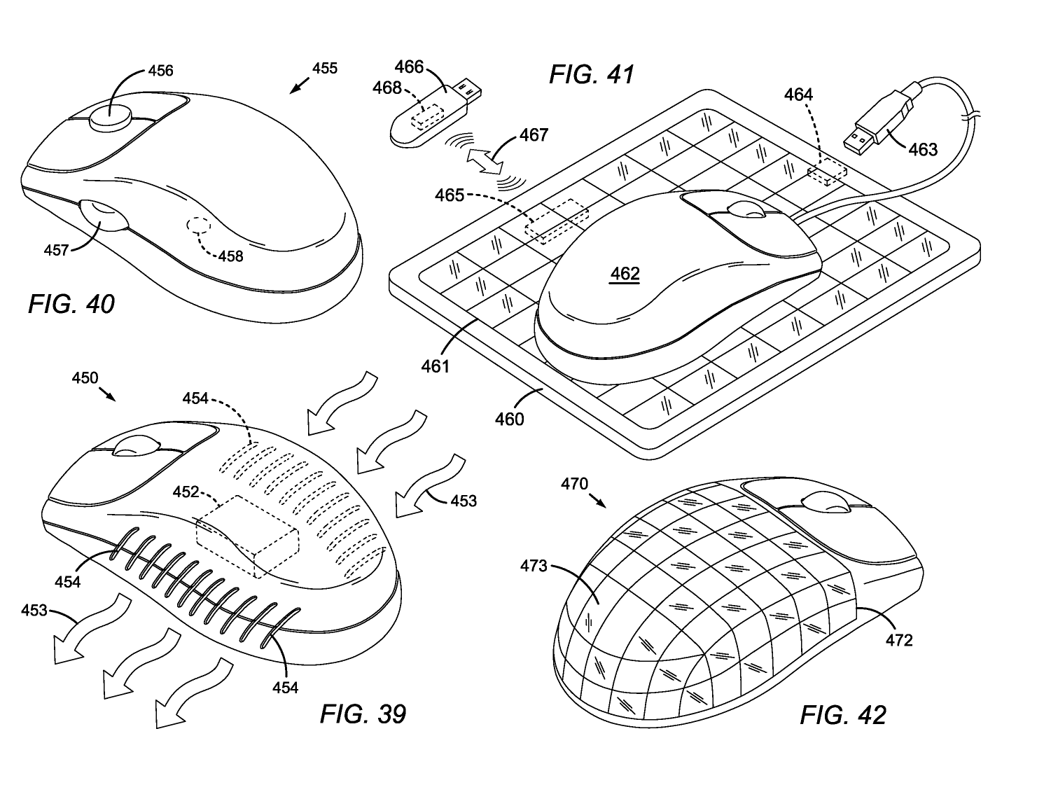

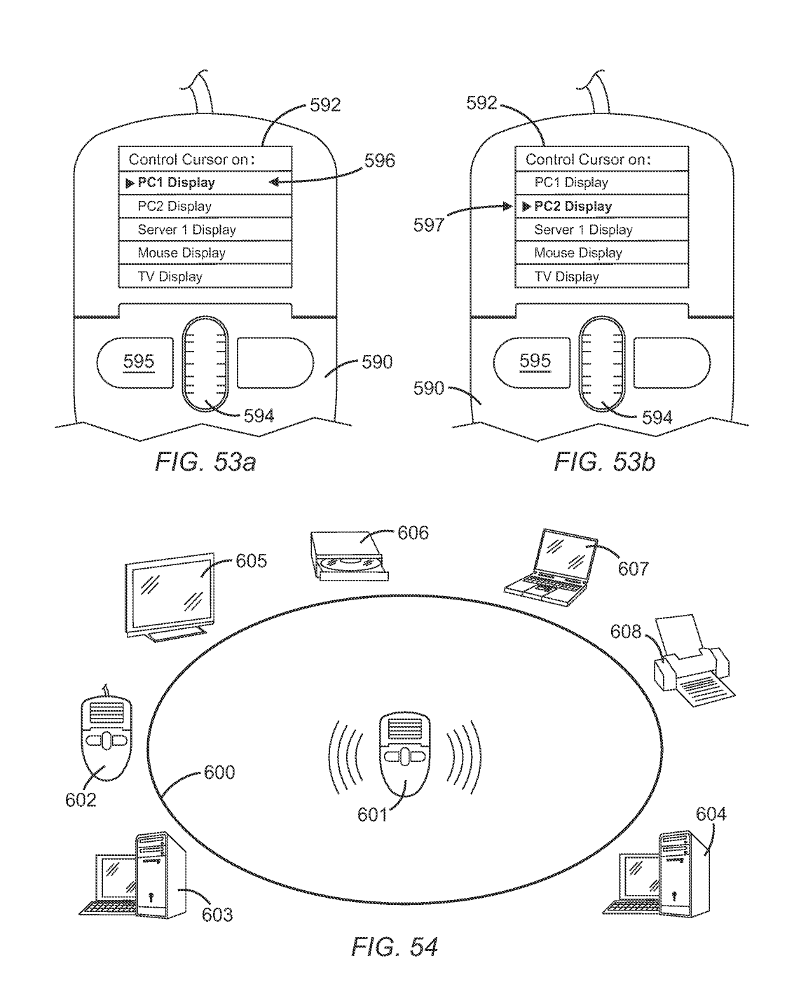

It should be understood that the preferred embodiment of the present invention and the additional functionality as described and shown in the drawings may also be incorporated within a Keyboard Apparatus, a PC Speaker Apparatus, a PC Headset Apparatus, and similar devices. For example, the gas sensor of FIG. 39 may be similarly integrated into a Keyboard Apparatus, as may be the solar panel as depicted in FIG. 42, the PMCIA slot of FIGS. 35-36, the flash drive as shown in FIGS. 37-38, the modules associated with FIGS. 32-34, the device assignments control of FIG. 53, the various architecture embodiments as shown in FIGS. 16, 26-28, 51, the Wi-Fi adapter as shown in FIGS. 8-9, and the like.

Although most of the figure drawings of the present invention display additional functionality related to a computer mouse apparatus, such additional functionality may be similarly integrated into a Keyboard Apparatus and other similar computer devices.

Turning now to FIG. 1. FIG. 1 illustrates a top view of a PC compatible computer mouse apparatus 100 with an integrated Trackpoint™ or Trackpoint-style device 102. The Trackpoint device 102, with its associated hardware and software components, functions as a cursor-pointing device or a window scrolling device.

Also shown are a left-click button 104, a right-click button 106, and a wired connection 108 to a host PC, PDA, Tablet PC, or mouse-enabled device. The buttons 104, 106 and Trackpoint device 102 are all embedded within the mouse enclosure 101.

The Trackpoint device 102 resembles a finger pad visible on the surface of the mouse enclosure 101, and four (4) strain gauges embedded within the mouse apparatus 100, which serve as directional pressure sensitive sensors similar in function to the IBM Trackpoint device typically found on the keyboards of IBM branded laptop computers.

The direction and speed of the cursor on the display screen is controlled by the amount of pressure and its orientation on the non-slip Trackpoint-style device. The speed at which the cursor-pointer moves, or the window contents scroll, corresponds to the pressure applied by the user to the Trackpoint-style device. Pointing, selecting, and dragging with the Trackpoint sensor are part of a single process that can be performed without the user moving his or her fingers away from the Trackpoint finger pad.

The smooth functioning of the Trackpoint device 102 is supported by a software control algorithm so users can move the cursor, select icons or texts, and scroll software contents within a window in a quick, accurate, and comfortable manner.

The Trackpoint device 102 may be based on any sensor capable of sensing force or pressure applied by the user (typically using fingertip pressure) in the four directions (left, right, up, and down) representative of movement on the display screen. The Trackpoint device 102 may also enable the use of buttons, left-clicks, right-clicks, and double-clicks of the types used in window-based graphical user interfaces.

The Trackpoint device 102 may function as a cursor-pointing device to complement the cursor-pointing function of the optical motion sensor 103 (shown in FIG. 3) located at the bottom of the mouse enclosure 101. The Trackpoint device 102 may also function as a window scrolling control device similar to the function of a scroll wheel in a conventional PC mouse. The Trackpoint device's function is chosen by adjusting the mouse configuration settings. A button (not shown) located on the mouse enclosure 101 may also toggle between the Trackpoint device's two functions.

The Trackpoint device 102 may also incorporate control software and/or additional sensors to control the display cursor movement or the window scroll direction of a 3D display and its associated graphical user interface.

FIG. 2 is a variation of the computer mouse apparatus as illustrated in FIG. 1.

FIG. 2 illustrates a top view of a computer mouse apparatus 110 with a Trackpoint sensor 112 in a location alternative to that shown in FIG. 1. The alternative location of Trackpoint device 112 permits the index fingertip of a right-handed user to easily reach the sensor. Another Trackpoint device alternative location 113 is also shown between the left-click button 114 and right-click button 116.

Also shown are a left-click button 114, a right-click button 116, and a wired connection 118 to a host PC, PDA, or mouse-enabled device. The buttons 114, 116 and Trackpoint device 112 are all embedded within the mouse enclosure 111.

FIG. 3 illustrates a side view of the computer mouse apparatus 100 illustrated in FIG. 1.

Electronic components for the Trackpoint device 102 and the remaining mouse electronics are located on a printed circuit board (PCB) 105 within mouse enclosure 101. Also shown is a bottom motion sensor area 103 typically associated with an optical or mechanical mouse.

FIG. 4 illustrates a front view of the computer mouse 100 as depicted in FIG. 1. It shows Trackpoint device 102, a left-click button 104, a right-click button 106, and a wired connection 108 to a host PC, PDA, or a related computer device. The buttons 104, 106 and Trackpoint device 102 are embedded within the mouse enclosure 101.

FIG. 5 is a variation of the computer mouse apparatus as illustrated in FIG. 1.

FIG. 5 illustrates a top view of a computer mouse 120 with a Trackpoint sensor 122 and a mouse scroll wheel 127. Also shown are a left-click button 124, a right-click button 126, and a wired connection 128 to a host PC, PDA, or mouse-enabled device. The buttons 124, 126 and Trackpoint sensor 122 are embedded within a mouse enclosure 121.

The Trackpoint device 122 and the mouse scroll wheel 127 may be programmed to serve different functions. For example, the left Trackpoint sensor 122 may be programmed to scroll the contents of the active window left, right, up, and down. The mouse scroll wheel 127 may be programmed for application-specific tasks, such as rotating an image in Adobe Photoshop or zooming in or zooming out of an object in a CAD/CAM program.

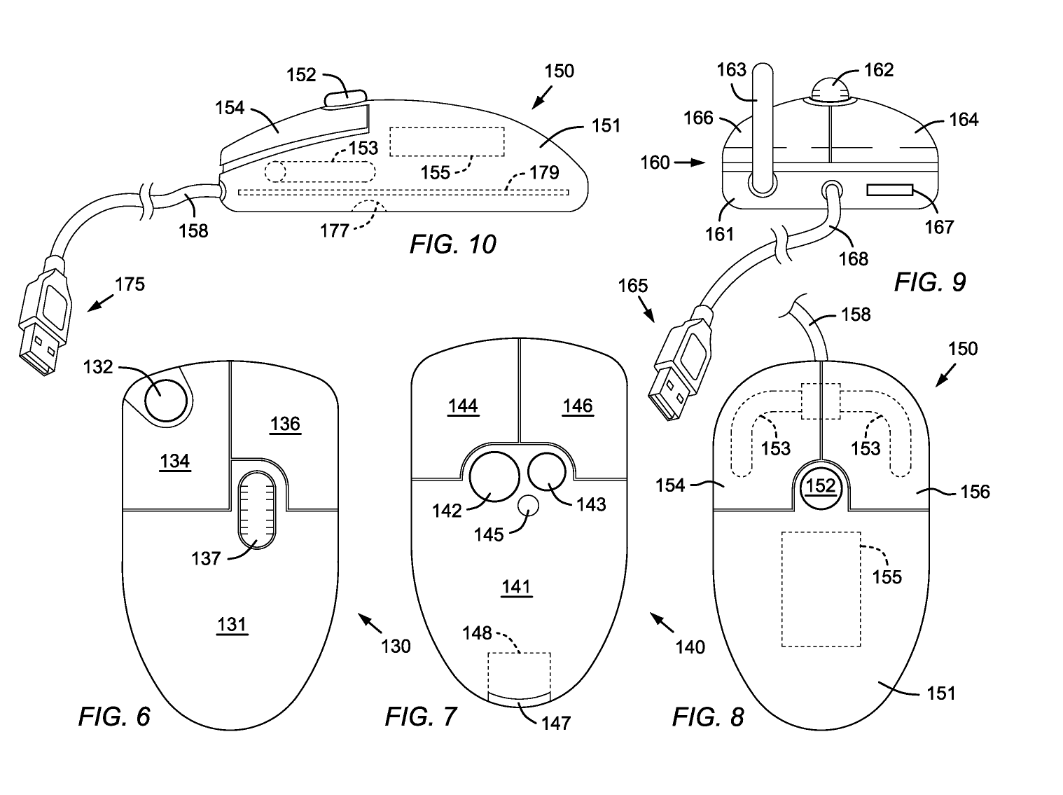

FIG. 6 is a variation of the computer mouse apparatus as illustrated in FIG. 5.

FIG. 6 illustrates a top view of a cordless computer mouse 130 with a mouse scroll wheel 137 and a Trackpoint device 132 in an arrangement alternative to that of FIG. 5.

Also shown are a left-click button 134 and a right-click button 136. The buttons 134, 136 and Trackpoint device 132 are all embedded within a mouse enclosure 131.

The mouse electronics includes a wireless connection to a host PC, PDA, or mouse-enabled device via a wireless communications technology. Such a technology may be proprietary or an industry standard such as Bluetooth, Wi-Fi, WiMax, or an optical IR infrared port.

FIG. 7 is a variation of the computer mouse apparatus illustrated in FIGS. 5 and 6.

FIG. 7 illustrates a top view of a cordless computer mouse apparatus 140 with two Trackpoint devices 142, 143, a function button 145, and a flash memory card reader slot 147. The memory card is inserted into the card slot 147 and rests within the memory card housing 148 until it is removed by the user.

Also shown are a left-click button 144 and a right-click button 146. The buttons 144, 146 and Trackpoint devices 142, 143 are all embedded within the mouse electronics housing 141. The two Trackpoint devices 142, 143 may be programmed to serve different functions. For example, the left Trackpoint device 142 may be programmed to scroll the contents of the active window left, right, up, and down. The right Trackpoint device 143 may be programmed for application-specific tasks, such as selecting a range of cells in Microsoft Excel, selecting a range of text in a Microsoft Word document, or moving the object nearest the cursor left, right, up, or down.

Removable digital memory products include memory card products such as Secure Digital (SD), mini SD, multimedia cards (MMC), compact flash and other flash memory products. Removable memory devices are typically utilized in digital cameras, mobile phones, music players and other consumer electronics that use the removable memory cards to store and transport data. Memory cards come in postage-stamp and matchbook sizes and currently use flash memory. However, other memory technologies such as magnetic random access memory (MRAM) are in development. MRAM will be able to store a substantial amount of data, consume little energy, and operate faster than conventional flash memory. The computer mouse apparatus of the present invention anticipates the use of this type of memory technology. Also becoming increasing popularly as a mass storage media for devices such as digital cameras, camcorders, and USB sticks, are non-volatile flash memories. The most advanced nonvolatile flash memory devices available today can permanently store one or two bits of information per memory cell without a supply voltage. Such memories have a feature size of around 90 nanometers, and shrinking this feature size to half using typical techniques has posed many problems because of nanoscale physical effects. The largest flash memory chips currently available exceed 1 GB and as costs drop, such devices may be incorporated into more electronic devices.

FIG. 8 is a variation of the computer mouse apparatus as illustrated in FIG. 1.

FIG. 8 illustrates a top view of a computer mouse 150 incorporating a Trackpoint sensor 152 and a built-in Wireless communications adapter module 155 with an internal antenna 153.

Also shown are a left-click button 154, a right-click button 156, and a wired connection 158 to a host PC, PDA, or mouse-enabled device. The buttons 154, 156 and Trackpoint device 152 are all embedded within a mouse enclosure 151.

A module, as the term is used in the foregoing, refers to electronics circuitry designed to perform a specific function. Hence, a Wi-Fi module refers to electronics circuitry designed to transmit and receive a Wi-Fi signal and to communicate the processed input and output data to a secondary device or application on the host PC. Its electronics circuitry may require EMI shielding to prevent signals from the wireless adapter's internal or external antenna from disrupting the electronics of other devices within the mouse enclosure.

The wireless communications adapter module 155 enables the host PC to support and communicate in one or more wireless technologies such as Wi-Fi, Bluetooth, WiMax, 2G, 2.5G, 3G, GSM, TDMA, CDMA, PCS, GPRS, WAP, GPS, mesh networks, satellite radio & video, AM, FM, FRS, RFID, ZigBee, optical IR, and the like. The signals may be received from a cellular network or from nearby Wi-Fi, WiMax, or Bluetooth hotspots.

Typically, the wireless adapter 155 includes support for Wi-Fi connectivity. Wi-Fi is also known as 802.11 in the IEEE standards and comes in a number of evolved variants such as 802.11a, 802.11b, 802.11g and the like. The range of the Wi-Fi signal is typically 75-300 feet. Handheld devices and other computers with wireless networking capability can access the host PC via the Wi-Fi adapter 155 embedded within the computer mouse apparatus 150. Intel manufactures chips that integrate the growing number of wireless technologies including Bluetooth, WiMax, and Wi-Fi, and permit detailed graphics on small devices.

A wireless adapter is used to establish a wireless network with other PCs and peripheral devices using at least one wireless standard. In order for the wireless communications module 155 to function as the wireless adapter for a host PC with no existing wireless communications ability, a wired connection 158 from the wireless adapter embedded in computer mouse apparatus 150 to the host PC or device is needed. This wired connection 158 may be based on any suitably supported connector type and data transfer standard. The various embodiments of a computer mouse with an integrated wireless adapter module will typically connect to its host PC via a single USB connector 175 (shown in FIG. 10). Any suitable connector style or data bus standard may be used such as USB 2.0/1.1, FireWire 400/800/1394a/1394b, serial, and parallel connectors.

USB 2.0 and FireWire 800 are both backward compatible. Hence, if the computer mouse apparatus 150 is attached to a system with only USB 1.1 or legacy FireWire 400/1394a ports, the embedded devices will still be able to function at the fastest possible speed available.

A button or switch can be incorporated within the mouse enclosure 151 which functions to toggle the wireless connection to an enabled or disabled state for added convenience and security. A multi-colored LED may also be incorporated within the mouse enclosure 151 to indicate status information or whether or not wireless data is incoming, outgoing, or both (green, red, or yellow LED indicator light respectively) via the built-in wireless adapter 155.

FIG. 9 is a variation of the computer mouse apparatus illustrated in FIG. 8.

FIG. 9 illustrates a front view of a computer mouse apparatus 160 with a mouse scroll wheel control 162, a USB plug 165, a USB jack or port 167, and a built-in wireless communications adapter module (not shown) with its associated external antenna 163. An external antenna 163 may be more suitable to wireless environments where antenna orientation, size, and obstruction are important considerations. The external antenna 163 may be pivoted to help aim in the right direction.

Also shown are a left-click button 164, a right-click button 166, a wired connection 168 to a host PC, PDA, or mouse-enabled device. The buttons 164, 166, antenna 163, and Trackpoint device 162 are all embedded within a mouse enclosure 161.

Turning now to FIG. 10. FIG. 10 illustrates a side view of the computer mouse apparatus 150 as illustrated in FIG. 8. The electronics of the mouse and the wireless communications adapter module 155 may be on a common PCB board 179 or on separate printed circuit boards.

If the Trackpoint device 152 is not enabled to control the position of the cursor on the host PC's display, then a separate motion sensor 177 is needed to serve the cursor-pointing function of the mouse. Typically, a cursor-pointing motion sensor 177 on a PC mouse is based on optical sensors or mechanical sensors to detect the motion of the mouse.

In the computer mouse apparatus of the present invention, it is expected that both a dedicated cursor-pointing motion sensor 177 and a Trackpoint device 152 that may be configured (through hardware jumpers or miniature switches or software preference settings) to serve the same function in a complementary dual use manner are present. Furthermore, the Trackpoint device 152 and/or the separate motion sensor 177 may be assigned the window scroll function which permits the contents of the active window within a Windows-style operating system to be moved to the left, right, up, or down.

The Trackpoint device 152 and/or the separate motion sensor 177 may also be assigned a zoom control function which permits the contents of the active window to be zoomed in or out or magnified more or less. The flexibility of assigning specific functions to the Trackpoint pressure sensor 152 and the mouse motion sensor 177 gives the computer mouse apparatus 150 of the present invention added functionality. For example, either or both sensors may be assigned the task of rotating or moving an object in a CAD/CAM or 3D application, moving an active window or icon within the displayed area of a Windows-style operating system, and other tasks often accomplished via a drag-and-drop operation, a select operation, a cursor move, a mouse scroll wheel operation, or a scroll bar or slider operation.

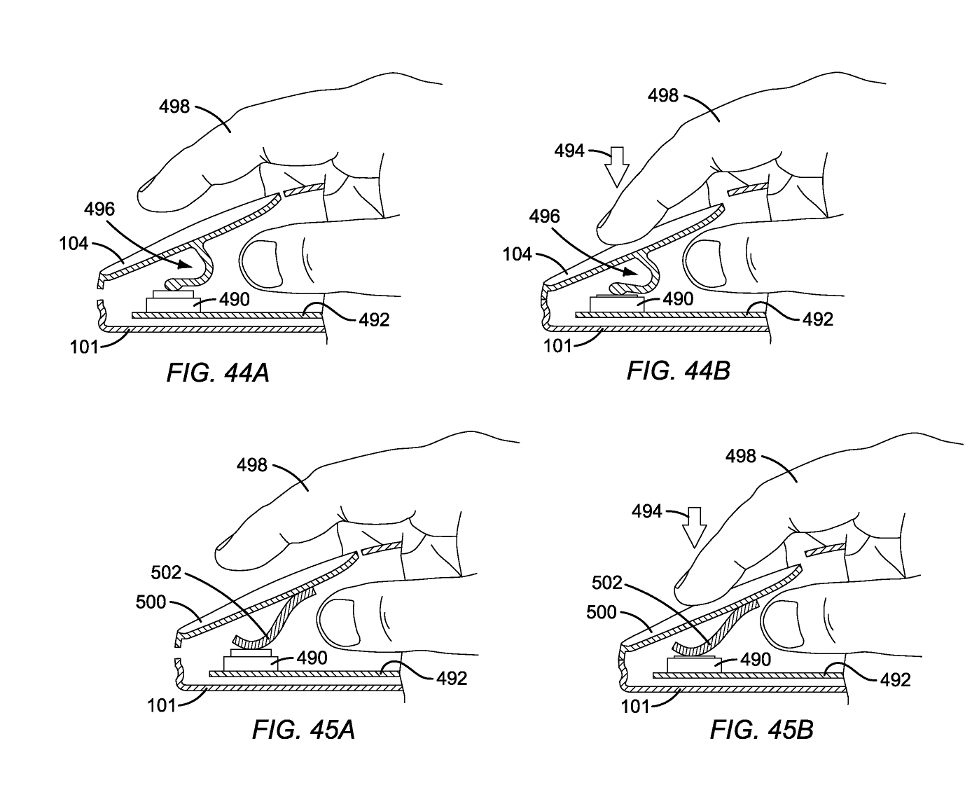

The use of an optical sensor typically located at the bottom of a conventional mouse may reduce mechanical components and, thus, improve the mouse's performance and reliability. A cordless mouse using RF technology has been used to reduce the intermittent failures generally associated with the wear and tear on a corded or wired mouse. On the remaining surfaces, however, the buttons and wheel are still mechanical. Optical sensors and strain gauges may be used to reduce the mechanical components. Optical- or LED-based switches may be used to replace mechanical contact style switches commonly used on a computer mouse. Where the conventional mechanical mouse is used, the switch can be mounted on a flexible circuit board or one with cut sections to reduce the amount of pressure that may be applied to such buttons, thus improving their time to failure or intermittent operation. This method is discussed further in FIGS. 57-58. Other means for shock absorption is discussed in FIGS. 44a-46b.

A control algorithm may be designed such that when a pressure is sensed at or above the threshold pressure, the switch will not move the mouse cursor until a period of time has passed to allow the mechanical motion of the mouse to not affect the cursor placement and its associated double click. The mouse may also sense the mechanical double click from the user but it will substitute a conditioned signal in lieu of the mechanical signal of the user.

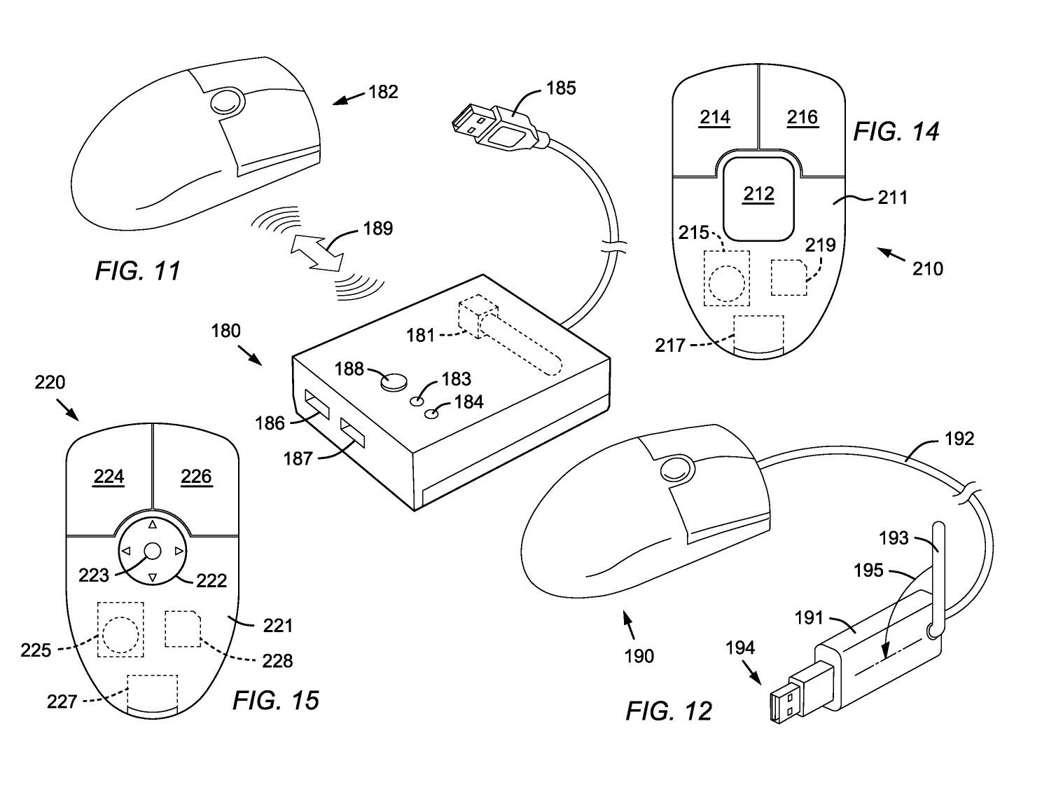

FIG. 11 is a variation of the computer mouse apparatus as illustrated in FIG. 8.

FIG. 11 illustrates a perspective view of a wireless computer mouse apparatus 182 with a Trackpoint device and a companion wired base unit 180 with an embedded wireless communications adapter module and its internal antenna 181. The base unit 180 is connected to the host PC via a suitable connector such as a USB connector 185.

A connect button 188 on the base unit 180 serves to reset wireless communications to the wireless mouse 182. LED indicators 183, 184 show status information and reception and transmission of wireless data. Extra serial bus ports such as USB 2.0 port 186, and FireWire port 187 permit other devices such as flash memory devices to be connected to the host PC via the base unit 180 and its built-in USB hub/bridge.

The shared USB wired connection 158 permits a Wi-Fi, 3G, GSM, or Bluetooth wireless adapter to be embedded within the mouse enclosure 151 (as shown in FIG. 10) rather than being installed in the host PC or connected externally to the host PC as a separate device. For the wireless computer mouse apparatus 182, the wireless adapter can be built-in into the mouse's companion base unit 180.

The wireless computer mouse apparatus 182 communicates to the wired base unit 180 using a wireless standard. The wired base unit 180 includes an embedded Wi-Fi adapter and antenna 181 and a USB hub connected to the host PC via a USB connector 185. The wireless computer mouse apparatus 182, thus, may use the same Wi-Fi standard signals to communicate mouse data to the base unit 180.

The wireless computer mouse apparatus 182 communicates motion sensor, button, and Trackpoint pressure data to the wireless adapter 181 using a suitable wireless signal (such as a Wi-Fi standard signal). The wireless computer mouse apparatus 182 may also communicate to the base unit 180 using a proprietary wireless signal. If a separate wireless standard is used for communicating the wireless data 189 from the wireless computer mouse apparatus 182 to the base unit 180, the wireless adapter 181 need not receive nor transmit the mouse specific data. Rather, separate communications circuitry associated only with the mouse data component are used.

FIG. 12 is a variation of the computer mouse apparatus as illustrated in FIG. 11.

FIG. 12 illustrates a perspective view of a wired computer mouse apparatus 190 with an embedded Trackpoint device and an in-line electronics and connection unit 191, which incorporates an integrated wireless network adapter module and its external antenna 193.

As shown in FIG. 12, the computer mouse apparatus 190 is attached to the in-line electronics and connection unit 191. The wireless network adapter is built-in into the in-line connection unit 191 and is used to establish communications using a wireless network to PCs and peripheral devices. The wireless adapter and the mouse data share a single common point of connection to the host PC. A USB connector 194 is the preferred connection means to the host PC. The external antenna 193 may be rotated 195 essentially along the connection unit 191 for better signal strength or for convenient storage.

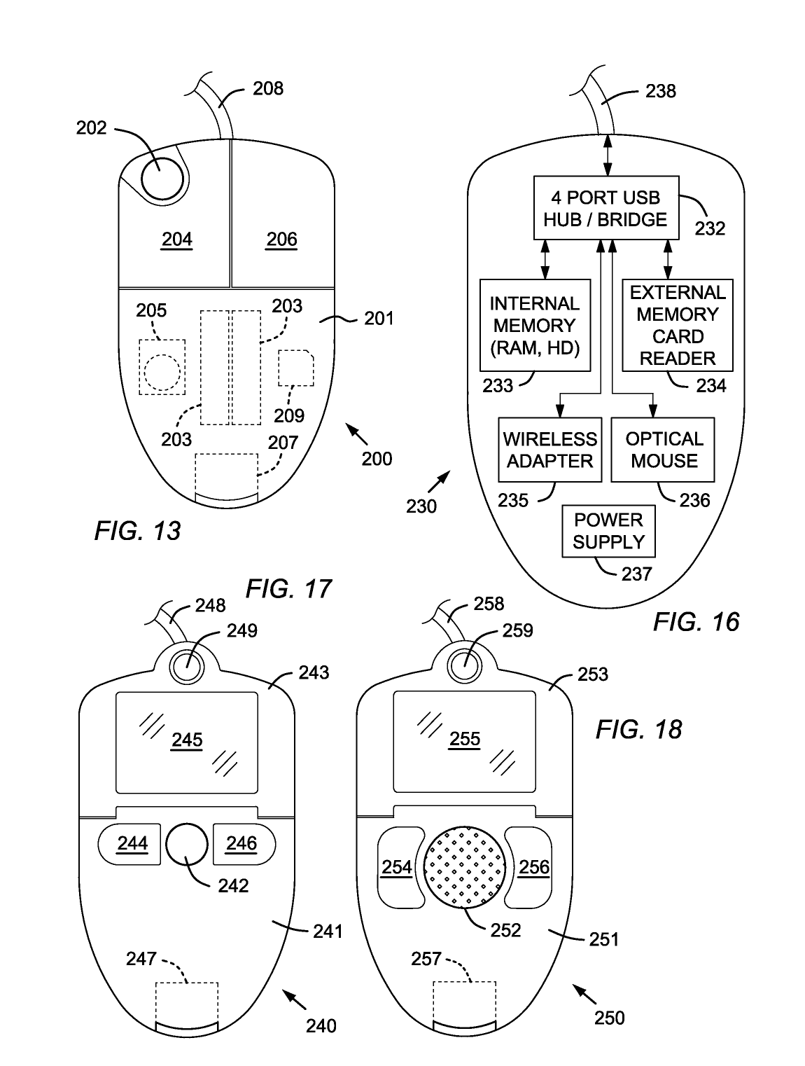

FIG. 13 is a variation of the computer mouse apparatus as illustrated in FIG. 8.

FIG. 13 illustrates a top view of a computer mouse apparatus 200 with a Trackpoint sensor 202 and an internal group of peripheral devices which include a mini hard drive 205, a wireless communications (for example, Wi-Fi standard) adapter module 203, flash (e.g. RAM, ROM) memory 209, and a flash memory card reader 207. The various embedded peripheral devices 203, 205, 207, 209 may be plug-and-play devices or the driver software may be stored on the embedded or removable memory within the mouse enclosure.

Also shown are a left-click button 204, a right-click button 206, and a wired connection 208 to a host PC, laptop notebook, PDA, Tablet PC, or SmartPhone. The buttons 204, 206 and Trackpoint device 202 are all embedded on the mouse enclosure 201. A PC card slot or PCMCIA slot may also be incorporated into the mouse enclosure 201, thus allowing any device which functions in a PCMCIA slot to be conveniently attached to the host PC.

The mini hard drive was introduced by IBM in the mid-1990s. Recently, mini hard drives have been further popularized by Apple Computer as used in its iPod and iPod Mini portable music players. Mini hard drives from companies like Cornice, Hitachi, Toshiba and others hold lesser data than standard hard drives. Typical capacities range from 1.5 GB to 4 GB. They are also smaller, measuring 1-2 inches across. In the second quarter of 2005, Hitachi introduced a 2.5-centimeter wide hard drive found inside some portable music devices that can hold up to 6 GB or 6 billion bytes of data. The company appraises that a device of the same size will be able to store 60 GB using perpendicular recording. IBM has shown off a working prototype of a ultra-high density storage technology dubbed “Millipede” that could cram in the equivalent of 25 DVDs in a space no larger than a postage stamp. As with most memory devices, mini hard drive capacity is expected to increase over time. Such mini hard drives may be adapted to store data files over a USB cable or wireless connection.

FIG. 14 is a variation of the computer mouse apparatus as illustrated in FIG. 13.

FIG. 14 illustrates a top view of a computer mouse apparatus 210 with a TouchPad™ cursor-pointing and/or scrolling device 212 or a similar device, and internal peripherals which include a mini hard drive 215, flash memory 219, and a flash memory card reader module 217.

Also shown are a left-click button 214 and a right-click button 216. The buttons 214, 216 and Touchpad cursor-pointing and/or scrolling device 212 are all embedded within the mouse enclosure 211. The Touchpad device used in the present invention may function similarly to any generic Touchpad device available and not necessarily the Touchpad device manufactured by Synaptics.

The computer mouse apparatus 210 and its peripheral devices may communicate to the host PC, PDA, or computer device using a wired or wireless connection. Data from the mouse and the embedded peripheral devices to a single wired or wireless connection may be multiplex or may be received and transmitted according to a suitable network standard specification. When a mouse is being used in a multiplex transmission, the mouse functions may be given priority or additional resource time to increase its performance.

FIG. 15 is a variation of the computer mouse apparatus as illustrated in FIG. 14.

FIG. 15 illustrates a top view of a computer mouse apparatus 220 with a 5-way navigation button 222. Also shown is a group of internal peripheral devices housed within the mouse enclosure 221, which includes a mini hard drive 225, flash memory 228, and a flash memory card reader module 227. There are also a left-click button 224 and a right-click button 226 embedded on the mouse enclosure 221. The computer mouse apparatus 220 and its peripheral devices may communicate to the host PC, PDA, or computer device using a wired or wireless connection.

The 5-way navigation button 222 may be used to scroll the contents of an active window, navigate menu items on a display, or serve as a cursor-pointing device. Such 4- or 5-way navigation buttons are also utilized on mobile phones, digital cameras & camcorders, and PDA devices such as the HP iPAQ Pocket PC h4350 Series. The navigation button also scrolls through lists, positions the cursor, accesses shortcuts, opens applications such as browsers, email, and Instant Messenger, and lists network devices.

The 5-way navigation button 222 contains a center button 223 which functions as a select or enter key. The center button 223 may also be assigned a specific function. A range of functions may also be programmed into the buttons 224, 226, 222, 223 in a context-sensitive manner according to the program application the mouse actions are associated with.

Turning now to FIG. 16. FIG. 16 illustrates a representative system architecture block diagram for the computer mouse apparatuses and their associated peripheral devices as depicted in FIGS. 8 to 15, and FIGS. 17 to 25.

Embedded within the mouse enclosure are electronics that serve the operational requirements of each embedded device such as the built-in memory (for example, flash RAM, ROM, and/or a mini hard drive) 233, the external memory card or SIM card reader 234, the computer mouse and its sensor electronics 236, and the wireless communications adapter (for example, a Wi-Fi, WiMax, 3G, GSM, GPRS, and/or Bluetooth adapter module) which serves to enable the host PC to communicate with other wireless devices and computers.

If the computer mouse is attached to a host PC or computer device via a USB connection or similar cable connection 238, a multiple port USB network hub module 232 is embedded within the mouse enclosure and serves to network the embedded devices to the host PC. The electronics and configuration of the hub/bridge device and/or the embedded peripheral devices may require modification to work optimally through the network hub/bridge module 232. Typically, standalone mouse and scanners need to be connected directly to one of the host PC's USB ports and will fail to operate if connected through a hub.

Thus, for a USB or serial connector mouse, the wireless adapter module 235 serves to provide the host PC with the capability to communicate with other wireless devices and other computers within the wireless network. The wireless adapter 235 is connected to the host PC via the internal network hub module 232. Settings for the mouse electronics and other embedded peripheral devices are adjusted through the host PC operating system and display device.

The operations of the wireless adapter module 235 and USB hub module 232 are different if the mouse is wirelessly connected to the host PC and no cable connection is present. If the computer mouse and the other embedded devices connect to the host PC or computer device using a wireless connection (for example, using a Wi-Fi, WiMax, Bluetooth, and/or a 3G standard), it is implied that the host PC already has some wireless capability to receive data from and to transmit data to the wireless mouse. Thus, the wireless adapter module 235 does not serve to give the host PC its basic wireless capabilities, but rather may enhance it by giving the host PC wireless capability at a different frequency band or with a different technology standard.

In the case of a wireless mouse, the primary function of the wireless adapter 235 is to enable the computer mouse data and the embedded peripheral device data to communicate wirelessly with the host PC or with other electronic devices within one or more established wireless networks.

In the case of a wireless mouse, the primary function of the USB network hub module 232 is to enable the computer mouse data and the embedded peripheral device data to communicate through the embedded wireless adapter module 235 with the host PC or other electronic devices within one or more established wireless networks. An On-The-Go USB bridge controller chip is used to give USB connectivity to embedded devices without the need for a USB connection to a host PC.

The USB On-the-Go chip such as Philips ISP1361, ISP1261, and ISP1262 enables portable devices to transfer data directly to another peripheral device without first having to connect to a PC. The USB On-the-Go spec, released in December 2001, is an addendum to the broadly implemented USB 2.0 standard. The supplemental spec allows direct connectivity between mobile handsets or portable consumer appliances without the aid of a host PC. Those conforming to the USB On-the-Go spec can dynamically set up a master-slave relationship between devices.

The power supply 237 provides a suitable voltage and current for the mouse electronics and the other peripheral electronic devices placed within the mouse enclosure. Power to the electronics may be from batteries housed within the mouse enclosure (if the mouse apparatus 230 is cordless) or may be supplied from the USB connector or an equivalent connector and its associated cable 238. If the batteries are rechargeable, they may be recharged by an AC/DC recharger unit attached to a wall receptacle or from the powered USB connection cable. The multi-function mouse apparatus of the present invention incorporates USB host capability, for example, by utilizing an OTG bridge controller chip.

The OTG chip is incorporated in FIG. 16 and FIG. 28. The 4 Port USB Hub/Bridge 232 in FIG. 16 and the USB Hub/Bridge 351 in FIG. 28 are equivalent. Normally, the USB Hub chip and the USB OTG chip (which acts as the USB bridge) are separate pieces of hardware (e.g. the Motorola USB Hub chip and the Philips USB OTG chip). However, they are shown in the drawings as a single block 232, 351 as the two functions (hub and bridge) may be integrated into a single piece of hardware such that there is no need to add a block for the USB OTG chip.

Note that the USB OTG chip (if packaged separately from the USB hub chip) only adds “bridging” capabilities to the mouse. Without the USB OTG chip, the mouse will still function as a USB hub and as a Wi-Fi access point. With the USB OTG chip, the mouse can function as a “bridge”—allowing two USB peripherals to communicate and transfer data without the need for a host computer.

Each computer mouse variation shown in FIGS. 1-15 and FIGS. 17-25 may contain one or more of the following devices: a mini hard drive, embedded or removable memory, flash memory, RAM, ROM, or MRAM, a wireless communications adapter suited for operation on one or more wireless standards, a USB or network hub, a USB on-the-go bridge controller device, an encryption chip or hardware, digital signal processing devices, audio/video components and processing circuitry, modem circuitry, and one or more CPU processors and supporting chipsets. Such devices may function individually and/or in combination with the remaining embedded devices, sensors, and electronics to add to or enhance the function of the computer mouse apparatus.

An encryption chip can be embedded within the mouse enclosure to decrypt and encrypt data files, store and manage such files on external or internal memory, and permit access to a network such as the Internet via proprietary and secure protocols which may be protected by software passwords, hardware, and biometric devices.

Other devices that may be embedded within the computer mouse apparatus include various connectors such as a RS-232 Port, an on/off switch, a temperature sensor, a gas sensor such as a CO, CO2 sensor, a smoke detector, a heat detector, a pulse monitor, a barometer, an equipment Status or Parameter status display, a blood pressure monitor, a network remote control, a microphone, a speaker, a telephone modem, a cable modem, a DSL modem, an IR remote control, a telephone keypad and headset connector, an RFID tag reader, a bar code reader, a printer port, a calculator, a timer, a mobile phone, an SMS/MMS text device, a pager, a clock, a TV monitor, a battery, a battery recharger, a voice-recognition chip, an MP3 player, a digital audio recorder, an AM/FM/SW radio, and a built in 916 MHz Transceiver. Further optional peripheral devices that may be embedded within the mouse apparatus are a solid state compass, atomic clock, super accurate clock, Wi-Fi module, PABX indicator, pager, mobile phone SIM, SMS device, projector, and smoke detector.

Turning now to FIGS. 17 to 25. The computer mouse electronics and additional mouse-embedded devices (for example, the built-in memory, mini hard drives, and the wireless communications adapter depicted in FIGS. 13-16) are typically connected to and seen by the host PC as a number of distinct peripheral devices. These devices are connected to the host PC using a USB cable connection or an equivalent wired or wireless network connection. The computer mouse's embedded peripheral devices support the function of the host PC by serving as distinct peripheral devices with distinct purposes such as a computer mouse, an external memory storage device, an external hard drive, and an external wireless adapter module.

It should be understood that a CPU processor and its associated chipsets or a system-on-a-chip device may be utilized within the computer mouse apparatus. Such a CPU processor or system chip may serve to manage computer processing tasks within the mouse enclosure rather than relying solely on the host PC's processing power. Thus, a mouse apparatus may run a proprietary OS, a Palm OS 3, 4 or 5, Pocket PC, SmartPhone, PalmSource, Symbian, Java, Microsoft, and Linux operating systems or any desktop O/S such as Windows XP.

In practical terms, a built-in CPU processor or system chip would enable the mouse electronics and the remaining embedded devices (for example, a mini hard drive, memory, input/output support and connectors, USB network hub or USB OTG bridge controller chip, wireless communications adapter, and the like) to function as a small self-contained computer. Such a device may store and run software applications, function as a distinct unit similar to a PDA, mobile phone, MP3 player, serve as a network device providing input or output support for other devices in a network, and still provide cursor-pointing and windows scroll control for an externally connected PC, PDA, or related computer device.

Similarly, the devices depicted in FIGS. 17-25 may be configured to function as a wired or wireless network mouse (as shown in FIGS. 53-54). The mouse or keyboard can have a network connection and can therefore access or provide input to a number of target devices connected to the network, not just the host PC. The mouse cursor will appear on whichever target device/display the mouse controls have been assigned to.

A network mouse is capable of transmitting input signals to and receiving output signals from a range of network addressable (for example, Internet Protocol devices) devices within a wired or wireless network. The selection of the network device which the mouse actions may have immediate effect upon may be selected via a menu list displayed on the built-in integrated display 245 or on the monitor display associated with the host PC or network selected device. A button (not shown in FIG. 17) on the network mouse enclosure 241 may toggle the mouse's target device between a default device such as the host PC and a second device (for example, a Server PC).

A wireless network mouse with an integrated display may use a number of wireless standards such as Bluetooth for short range networking and WiMax for wide-area networking. The display screen may, for example, display a list of target devices to which the mouse may interact within one or more wired or wireless networks. The user may select which target device in the displayed list the mouse will interact with and the buttons and display on the mouse are used to change the target to other devices on the list.

Conventional USB peripherals require a “host-peripheral” configuration wherein a computer acts as the host and USB peripherals act as passive devices. With the advent of the USB On-The-Go (OTG) specification, products that have been traditionally peripherals only (e.g. digital cameras, digital audio players, mobile phones, etc.) now have the capability to act as host to other USB peripherals. This means that devices compliant with the USB OTG specification can act as a “communication bridge” between two USB devices, without the need for a host computer. USB OTG capabilities can be added to current USB compliant products by adding a controller chip, such as Philips' ISP1261 and ISP1262 bridge controller chips, which can either be integrated on the circuit board or designed as an external “dongle”.

Most computers, laptops, and late model PDAs have a built-in USB host capability. The multi-function computer mouse apparatuses of FIGS. 8-15 and 17-25 may incorporate USB host capability. Such capability can be provided, for example, by utilizing an OTG bridge controller chip. With USB host capability built-in into a computer mouse 200 (as in FIG. 13), a flash memory card attached to a USB port or card reader 207 may store data to or retrieve data from the memory card utilizing the computer mouse's built-in wireless communications module 203.

Turning now to FIG. 17. FIG. 17 illustrates a top view of a computer mouse apparatus 240 with a Trackpoint sensor 242, a small display 245, a flash memory card slot or SIM card reader 247, and a digital camera or webcam 249.

Also shown are a left-click button 244, a right-click button 246, a hinged display enclosure 243, and a wired connection 248 to a host PC, PDA, or mouse-compatible device. The buttons 244, 246 and Trackpoint device 242 are all embedded on the mouse enclosure 241.

The preferred display 245 is a small black & white or color display of the type found on mobile phones and digital cameras. The display may also be an LCD or LED multi-segment display of the type found on calculators. The display technology may be of any commercial type including OLED and e-Ink technology. The display 245 may also be a dual screen display, a transflective display, or incorporated with touch screen capability. Small 1.8 inch LCD screens are available from such companies as Samsung.

Where privacy is a concern, 3M has a screen technology that prevents the display contents from being seen from the side, thus, protecting data from the prying eyes of strangers. The 3M privacy screens may be installed over the mouse display 245 or built into the display itself.

A mouse with a display and webcam or a stand alone network mouse may also play a role in the intelligent home and home networks of today in order to control a number of devices from one convenient place. For example, computer mouse apparatus 240 may screen visitors at the front door and permit entry at the touch of a mouse button. The computer mouse apparatus 240 may also select home entertainment options from items and menus displayed on home TV monitors or on the mouse's own embedded display 245.

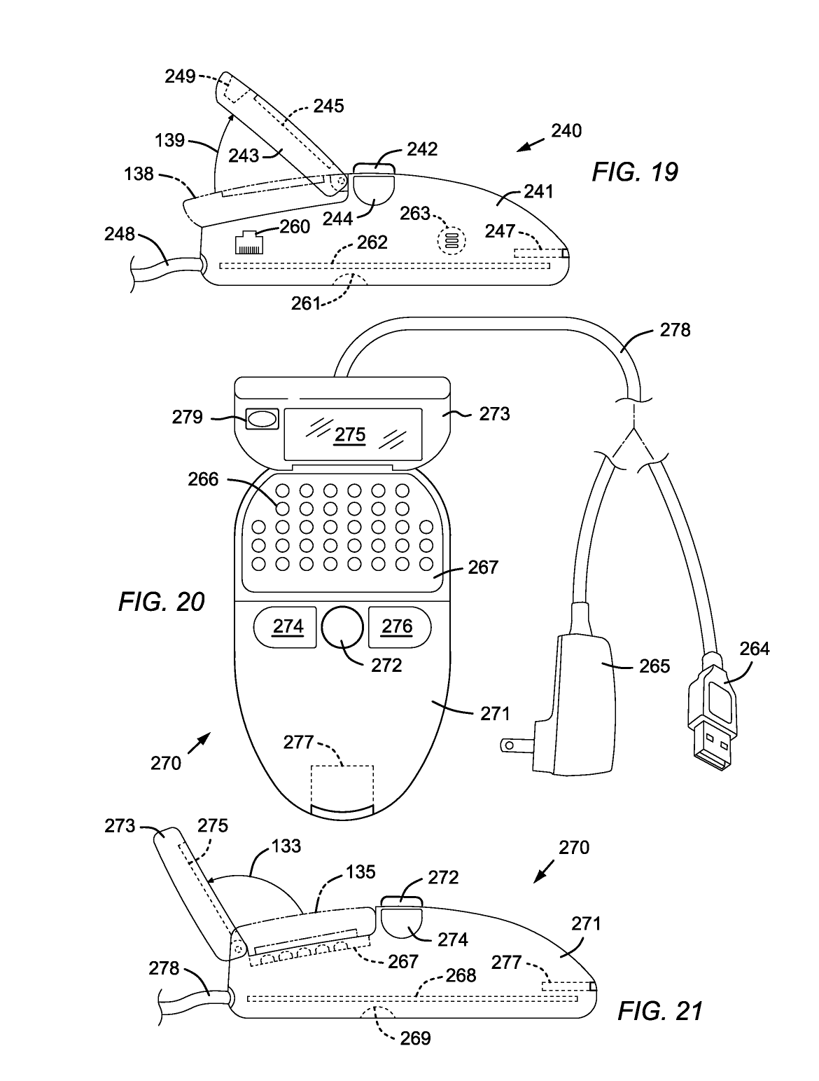

The display 245 may be used in association with the digital camera/webcam 249 on the mouse 240 to initiate or receive video conference calls. A built-in microphone and speaker 263 on mouse 240 as shown in FIG. 19 (or the use of a PC/VOIP headset connector on the PC or mouse) enables audible communication.

The computer mouse apparatus 240 may display email and inter-office communication, images, and reminders, and may also serve as a pager and alert device. Such activities may be present on the mouse display 245 and interacted with even when the host PC or its monitor display is turned off.

The computer mouse apparatus 240 with the embedded Trackpoint device 242 may be configured as a wired or wireless device. In a wired configuration, the power may be supplied via the wired connection 248 or internal batteries. In a wireless configuration, the power may be supplied via an AC/DC adapter or by internal batteries. In a wired configuration, any wireless communications adapter may serve to add wireless capability to the host PC or a network device. In a wireless configuration, the wireless communications adapter serves to use this capability to enable the devices embedded within the mouse enclosure 241, such as the mouse electronics and the built-in memory storage devices, to communicate with and support the host PC or a network device.

The computer mouse apparatus 240 may also contain any one or more of the following embedded devices: RAM memory, ROM memory, a mini hard drive, a wireless communications adapter, a network hub or bridge, a CPU and its associated circuitry, and a power supply. The embedded devices may function as peripheral devices connected via a USB or network connection to a host PC and under the control of a host PC. With the addition of a built-in CPU and its associated circuitry within the mouse enclosure 241, the embedded devices and CPU may be integrated into an autonomous computing device with wired or wireless connectivity to other computing devices on a network.

FIG. 18 is a variation of the computer mouse apparatus as illustrated in FIG. 17.

FIG. 18 illustrates a top view of a computer mouse apparatus 250 with a Trackball cursor-pointing and/or window scrolling device 252, a display 255, a SIM card reader or flash memory card reader 257, a digital camera or webcam 259.

Also shown are a left-click button 254, a right-click button 256, a hinged display enclosure 253, and a wired connection 258 to a host PC, PDA, or mouse-compatible device. The buttons 254, 256 and Trackball device 252 are all embedded on the top of mouse enclosure 251.

When a Trackball device 252 is used in a mouse 250, the Trackball device 252 serves as the mouse's motion sensor and therefore is used for the mouse's cursor-pointing function. When a Trackball device 252 is used, the mouse 250 position is typically held stationary as there is no motion sensor at the bottom of the mouse. However, with the added functionality present in the computer mouse 250, a bottom-mounted motion sensor may be used for the cursor-pointing function to complement or replace the cursor-pointing function of the Trackball device 252. This variation enables the Trackball device 252 to be used in other ways such as a scroll control device to move the contents of an active window, or as a menu selection device to select an item from a list displayed on the computer mouse display 255.

The computer mouse 250 with the embedded Trackball device 252 may be configured as a wired or wireless device. In a wired configuration, the power may be supplied via the wired connection 258 or internal batteries. In a wireless configuration, the power may be supplied via an AC/DC adapter or by internal batteries. In a wired configuration, any wireless communications adapter may add wireless capability to the host PC or a network device. In a wireless configuration, the wireless communications adapter uses this wireless capability to enable the devices embedded within the mouse enclosure 251, such as the mouse electronics and the built-in memory storage devices, to communicate with and support the host PC or a network device.

The computer mouse 250 may also contain any one or more of the following embedded devices: RAM memory, ROM memory, a mini hard drive, a wireless communications adapter, a network hub or bridge, a CPU and its associated circuitry, and a power supply. The embedded devices may function as peripheral devices connected via a USB or network connection to a host PC and under the control of a host PC. With the addition of a built-in CPU and its associated circuitry within the mouse enclosure 251, the embedded devices and CPU may be integrated into an autonomous computing device with wired or wireless connectivity to other computing devices on a network.

FIG. 19 illustrates a side view of computer mouse apparatus 240 as depicted in FIG. 17 showing an integrated speaker and/or microphone element 263, a network connector 260, a printed circuit board for the mouse apparatus electronics 262, and a cursor-pointing motion sensor area 261.

Also shown are a Trackpoint device 242, a display 245, a flash memory card reader or a SIM card reader 247, a digital camera or webcam 249, a left-click button 244, and a wired connection 248 to a host PC, PDA, or computer-related device.

The display 245 is housed within a hinged display enclosure 243 which is attached to the mouse enclosure 241. The hinged display enclosure 243 is normally positioned in a horizontal manner as indicated by phantom line representation 138, but may be rotated or pivoted upward as indicated by direction arrow 139 depending on the user's preference or to reduce overhead glare and improve the quality of the display 245 image and the webcam 249 image capture.

The built-in network connector 260 enables the computer mouse apparatus 240 to access other devices on a network and receive output data from such devices which may be displayed and interacted with on the mouse's built-in display 245. The computer mouse apparatus 240 may also interact with these network devices by sending control signals to the devices directly via the network connector 260.

The network connector 260 may be any suitable network connector such as an Ethernet-style connector or a USB connector. Additional input and output connectors may be present, such as an IEEE 1394 FireWire or i.LINK connector, an S-Video input/output connector, a digital component video connector, a microphone input and/or a PC headset connector, and an optical audio/video input or output connector.

A built-in microphone and/or speaker 263 enables the computer mouse apparatus 240 to serve as a VOIP-enabled device to conduct or participate in audio and/or video teleconference calls and to communicate with colleagues without the use of a stand alone telephone. The microphone 263 may be disabled in instances where the user chooses to only monitor a conference call or in-house communication. Set-up and participation in such teleconference calls may be facilitated by software installed on the host PC or the computer mouse apparatus 240. The Trackpoint device 242, display 245, and webcam camera 249 may facilitate the set-up and configuration process and provide video images to all the video teleconference participants.

The computer mouse apparatus 240 may be interfaced to audio and video conferencing services and avail of Internet Protocol for company-level collaboration. It may also be used with IP or non-IP end points to connect to real time inter-office or extra-office audio, video, Instant Messenger, VOIP, and webcam conferences.

FIG. 20 is a variation of the computer mouse apparatus as illustrated in FIG. 17.

FIG. 20 illustrates a top view of a computer mouse apparatus 270 with a Trackpoint cursor-pointing and window scrolling device 272, a display 275, a flash memory card slot 277, a digital camera or webcam 279, a hinged display enclosure 273, and a number keypad or keyboard 267.

Also shown are a left-click button 274, a right-click button 276, a wired connection 278 to a host PC, PDA, or computer-related device, an optional AC/DC power supply or recharging unit 265, and an optional wired USB connector 264 attached to the mouse enclosure 271.

The computer mouse apparatus 270 can communicate to a PDA or mobile phone through a wired connection or a wireless connection such as Wi-Fi, WiMax, or Bluetooth using short range radio waves.

A typical key 266 on the mouse's embedded numeric keypad or keyboard 267 is of a size and shape similar to that found on mobile phones and embedded PDA keyboards. Numbers, letters, and/or symbols may be printed on each key 266.

A projector may also be mounted on computer mouse apparatus 270, which could be a dual or single LED projector on a thin panel or dual thin panel or projected on a wall. The projector lens may be located in front of the screen mounted adjacent to the keyboard or on the keyboard itself. Ostar, the latest high-performance LED from Osram, is 50 times brighter than comparable predecessor models, small in size at 3 cm.×1 cm., and has a high brightness of 120 lumens (lm), thus making it ideally suited for use in mini projectors. The LED itself takes up only a fraction of the device's surface area, generating an extremely bright and uniform light for its size.

FIG. 21 illustrates a side view of the computer mouse apparatus 270 depicted in FIG. 20 showing a representation of an electronic printed circuit board 268, a flash memory card slot 277, an upright hinged display enclosure 273, and a motion sensor area 269 at the bottom of the mouse enclosure 271. Also shown are a left-click button 274, a Trackpoint device 272, and an optional wired connection 278 from a host PC, USB connection, or a computer-related device.

The hinged display enclosure 273 is rotated or pivoted upright as indicated by direction arrow 133 to permit the user to view the display 275 according to his/her preference and in order for the webcam 279 (as shown in FIG. 20) and keyboard 267 to be used. The hinged display enclosure 273 is folded closed as indicated by phantom line representation 135 when the computer mouse apparatus 270 is stored or operated without the need for its display 275 or keyboard unit 267.

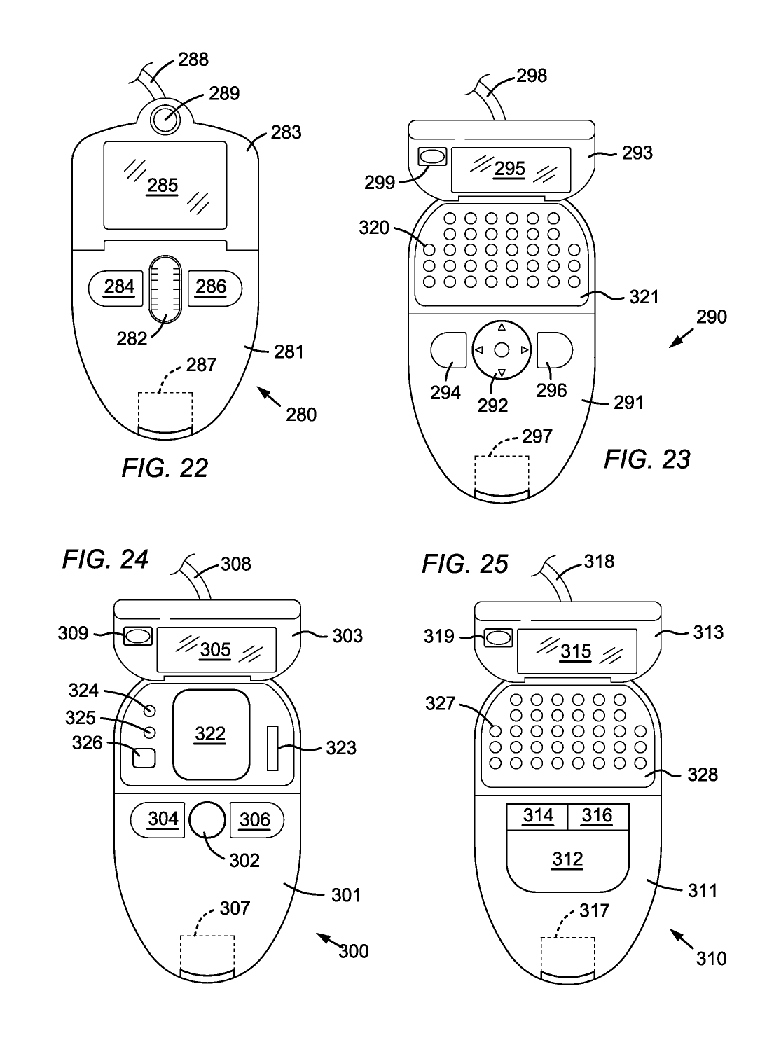

FIG. 22 is a variation of the computer mouse apparatus as illustrated in FIG. 17.

FIG. 22 illustrates a top view of a computer mouse apparatus 280 with a mouse scroll wheel 282, a display 285, a memory card slot 287, and a digital camera or webcam 289.

Also shown are a left-click button 284, a right-click button 286, a hinged display enclosure 283, and a wired connection 288 to a host PC, PDA, or mouse-compatible device. The buttons 284, 286 and the mouse scroll wheel 282 are all embedded within the mouse enclosure 281.

FIG. 23 is a variation of the computer mouse apparatus as illustrated in FIG. 20.

FIG. 23 illustrates a top view of a computer mouse apparatus 290 with a 5-way navigation button 292, display 295, a flash memory card slot 297, a digital camera or webcam 299, and a numerical keypad or keyboard 321.

Also shown are a left-click button 294, a right-click button 296, a hinged display enclosure 293, and a wired connection 298 to a host PC, Pocket PC, or mouse-compatible device. The buttons 294, 296, the 5-way navigation button 292, and each keyboard key 320 are all embedded within the mouse enclosure 291.

FIG. 24 is a variation of the computer mouse apparatus as illustrated in FIG. 20.

FIG. 24 illustrates a top view of a computer mouse apparatus 300 with a Trackpoint-style device 302, a touch screen display 305, a memory card slot 307, a video camera 309, a biometric fingerprint scanner 322, and an ID chip or SIM card reader slot 323. Also shown are a left-click button 304, a right-click button 306, a hinged display enclosure 303, and a wired connection 308 to a host PC, Pocket PC, or mouse-compatible device which is embedded within the mouse enclosure 301.

The fingerprint reader 322 may be used to authenticate a user's identification to allow access to confidential information, encrypted or password-protected data files or applications stored on the host PC or on the computer mouse apparatus 300. A start scan button 326 and “pass”, “fail” status indicator lights 324, 325 enable the fingerprint reader 322 to function without the use of a GUI dialog box on the host PC or the display 305. It should be understood that other biometric scanning devices may be embedded within the mouse enclosure 301 in lieu of the representative fingerprint reader 322 shown.

The fingerprint reader 322 embedded within the mouse enclosure 301 may also be placed on the surface of the mouse enclosure 301 to allow frequent verification of the person's fingerprint ID or similar biometrics. For example, the fingerprint reader 322 may be positioned near the thumb, index, or middle finger resting location on the mouse enclosure 301 so files requiring such a biometric authentication may be opened conveniently in one step.

FIG. 25 is a variation of the computer mouse apparatus as illustrated in FIG. 20.

FIG. 25 illustrates a top view of a computer mouse apparatus 310 with a Touchpad cursor-pointing and/or window scrolling device 312, a display 315, a flash memory card slot 317, a webcam or video camera 319, and a group of keys 327 which serve as function keys, a numerical keypad, or a keyboard 328.

Also shown are a left-click button 314, a right-click button 316, a hinged display enclosure 313, and a wired connection 318 to a host PC, PDA, or mouse-compatible device. The buttons 314, 316 and Touchpad device 312 are all embedded on the mouse enclosure 311. The Touchpad 312 may also be used to input Graffiti-style characters which may be displayed on the built-in display screen 315.

A computer mouse apparatus with an embedded or removable memory device (RAM, ROM, MRAM), a memory card reader, or a mini hard drive may be connected directly to a printer to print data or files from the embedded or removable memory of the computer mouse apparatus. Such a connection may be wired, with a USB cable for example, or wireless through a Bluetooth, Wi-Fi, IR connection, and the like. Where an application is necessary to facilitate the printing function, the application may be accessed on the network, host PC, or available from the memory of the computer mouse apparatus.

It should be understood that the following devices are packaged within a common mouse housing or enclosure: keyboard, the display, the hard drive, other memory (such as RAM, ROM, MRAM, and/or its equivalents), a memory card reader, the power source, the CPU and its associated chipsets and circuitry, the Wi-Fi module, the GPS receiver module, the modem module, the network connection and its associated circuitry, the RFID tag reader, the 3G module and/or any wireless or wired electronics designed to provide data bus connectivity according to any proprietary or industry standard communication specification or protocols. Such embedded devices may function in an integrated manner with features that complement and add value to the functioning of the other embedded devices within the computer mouse apparatus.

A GPS module refers to electronics circuitry designed to receive a GPS signal and communicate the processed output data to a secondary device or application within the mouse enclosure or the host PC. A GPS receiver module may be embedded within the mouse enclosure and used by a user to locate its position on a map and search for nearby companies and services.

It should also be understood that any one or more of the embedded devices may function independently of the other devices packaged within the mouse enclosure. For example, in FIG. 20, the integrated keyboard 267 within the mouse enclosure 271 may be an independently functioning keyboard device with its own input and output data stream provided by the USB bus port. It need not be associated with the embedded display 275 and hence, may function independently of such a display. In such a case, the two devices share only a common enclosure and network connection to the host PC and the host PC treats each device as a separate peripheral device without regard to their proximity.

The computer mouse apparatus is environmentally friendly as it reduces the manufacturing, packaging, and distribution costs of multiple discrete devices manufactured or sold as separate discrete devices.

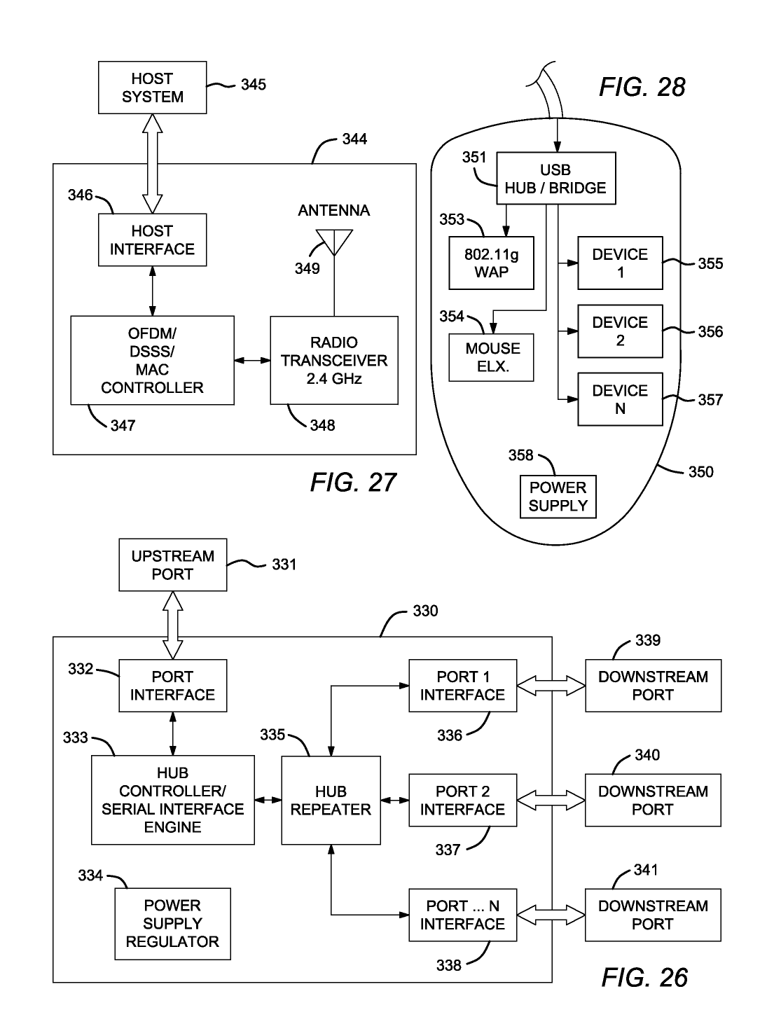

FIG. 26 is a block diagram of a simplified USB Hub 330 integrated into the computer mouse apparatus.

A USB hub 330 is essentially a “wiring concentrator” that makes possible the multiple device attachments characteristic of USB technology. USB hubs are typically implemented as a single physical chip, such as the Motorola MC141555.

A USB hub 330 consists of two core components: the hub controller 333 and the hub repeater 335. The hub controller 333 incorporates circuitry for controlling the communication between the host system (i.e. the computer) and USB peripherals or other USB hubs. The hub controller 333 also implements the serial interface engine which manages the serialization of data packets to and from the upstream port 331 and the downstream ports 339, 340, 341.

The hub repeater implements a “data switch” or “data bus” that manages the flow of data packets to and from the upstream port 331 and the downstream ports 339, 340, 341. The hub repeater typically also implements support for reset, suspend, and resume signaling.

Port interfaces 332, 336, 337, and 338 implement circuitry for interfacing with USB peripherals, USB hubs, or the host system. The power supply and regulator circuits 334 supply the chip electronics with power.

FIG. 27 shows a simplified block diagram of an 802.11 networking chipset 344. The host interface 346 implements functions that allow the chipset to interface with a host system 345 such as a computer. The host interface 346 typically uses USB, PCI, or PCMCIA technology to interface with the host system 345.

The OFDM/DSSS/MAC controller 347 is typically packaged as a single physical chip and implements the core functions of the various 802.11 versions such as 802.11g networking standard. These functions are Orthogonal Frequency Division Multiplexing (OFDM), Direct Sequence Spread Spectrum (DSSS) signal processing, and Media Access Control (MAC). In addition, encryption and Quality of Service (QoS) functions may also be implemented on the same controller chip 347 (or on a separate chip).

The radio transceiver 348 implements circuitry required for RF and other analog functions. It typically incorporates the signal amplifier, oscillator, RF filters, and frequency synthesizer.

The antenna 349 may be a directional or omni-directional Wi-Fi antenna. The antenna 349 may also be packaged as a chip antenna. An omni-directional antenna transmits a wireless signal across a 360-degree range, while a directional antenna increases the signal strength and range in a focused direction. The mouse apparatus may typically have an omni-directional antenna.

FIG. 28 shows a block diagram of a computer mouse apparatus 350 with an integrated USB OTG bridge controller and USB hub chip 351, mouse electronics 354, a wireless communications adapter 353, a portable power supply system 358, and several embedded devices such as a mini hard drive 355, integrated flash memory 356, and a flash memory card reader 357. The wireless communications adapter 353 also includes a suitable antenna(s) to transmit and receive the RF signals.

The computer mouse apparatus of the present invention incorporates USB host capability if necessary, for example, by utilizing an OTG bridge controller chip. A USB OTG bridge controller chip or chipset typically consists of the following:

1) Port interfaces, which implement circuitry for interfacing with USB peripherals. Typically, two USB peripherals will be “bridged” together by the chipset through the port interfaces. The two USB peripherals will be logically connected in a “master-slave” configuration.
2) The USB host component, which implements circuitry that allows one of the two USB peripherals to act as host. This function has traditionally been performed by a computer, because the USB host circuitry is integrated into the computer's motherboard.
3) The USB OTG controller, which contains circuitry that implements the USB OTG specifications. Typically this component contains a protocol engine which facilitates (through data translation) the exchange of data between the USB peripherals that are “bridged” together, memory for buffering data during read/write operations, as well as circuitry that allows the chip to also function as a USB peripheral.

Regardless of whether the computer mouse 350 is wired or wireless, the USB OTG chip interfaces directly to the USB Hub chip 351 and it is shown in FIG. 28 as a single block 351. The USB OTG chip utilizes the USB Hub chip because the hub chip controls the USB port interfaces on the mouse. USB peripherals that need to be “bridged” together must connect though the ports. The USB OTG chip may have its own dedicated USB ports that could remove the need to connect the USB OTG chip to a separate USB Hub chip.

It should be understood that other peripheral devices may also incorporate embedded devices which add utility beyond the basic device functionality. For example, RAM memory or a mini hard drive may be incorporated within a VOIP headset, a keyboard, a USB compatible mobile phone, a Wi-Fi or wireless communications adapter, a PC speaker system, a graphics tablet, an external display, a DSL modem, a cable modem, and the like. Data from the embedded or removable memory component of such devices may be transferred to and from the host PC, PDA, or related computer device via a wireless connection such as a Wi-Fi connection or via a wired connection such as a USB connection.

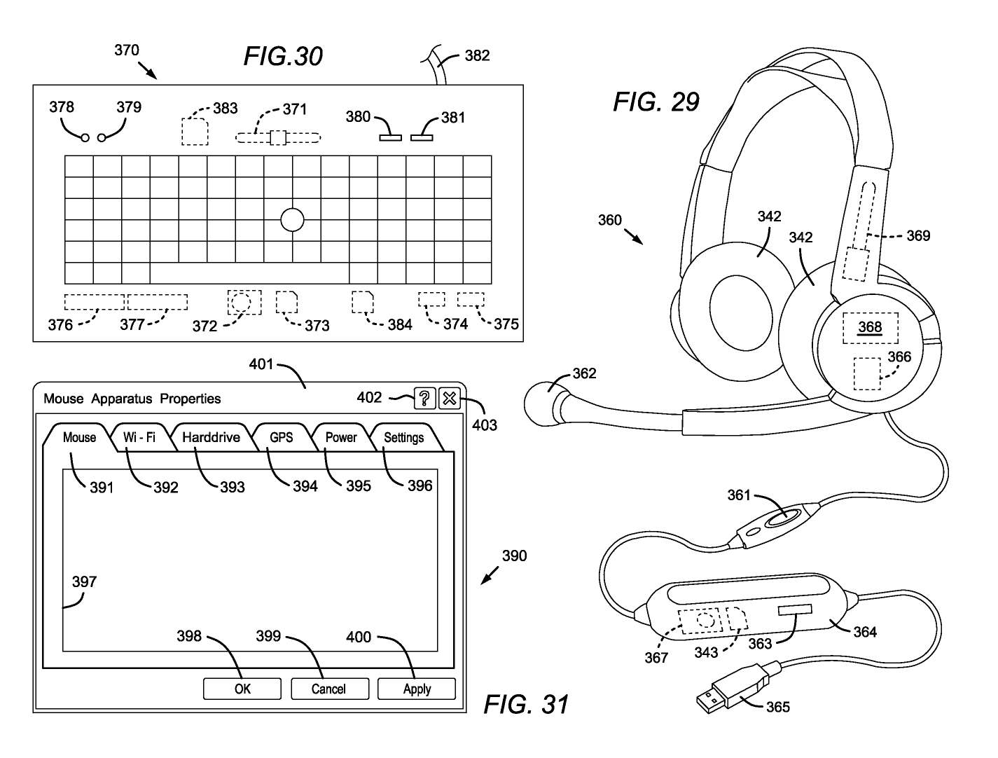

FIG. 29 illustrates a perspective view of a USB-based PC headset apparatus 360 with added functionality. It shows a wireless communications adapter and antenna 369, built-in flash memory 368, voice recognition circuitry 366 for application control and biometric authentication, a noise cancellation microphone 362, and headphone earpieces 342. The PC headset apparatus 360 plugs directly into the USB port of a host computer or device.

Also shown are in-line volume, power and mute controls 361, a USB connector 365, an in-line electronics enclosure 364 which contains a digital signal processor and circuitry 343 to digitize the analogue audio signal and send it through the USB bus to a VOIP application, a mini hard drive 367 that may serve as a digital call recorder or provide music on hold, and a flash memory card slot 363.

FIG. 30 illustrates a top view of a wired keyboard apparatus 370 with added functionality and its internal electronics circuitry. It shows an embedded wireless communications adapter 383 and associated antenna(s) 371, built-in flash memory 375, microphone & voice recognition circuitry 374 for application control and biometric authentication, keyboard electronics 384, a mini hard drive 372, and a USB hub and bridge controller chip 373.

Also shown are a wired connection 382 to a host device, a flash memory card slot 381, an external USB or FireWire port 380, status and power LEDs 378, 379, a back-up power source 376, and a voltage regulator 377.

Thus we have seen from FIG. 29 and FIG. 30 that headsets and keyboards may also benefit from the additions of embedded devices which enhance the basic device and wireless capability to their host systems.

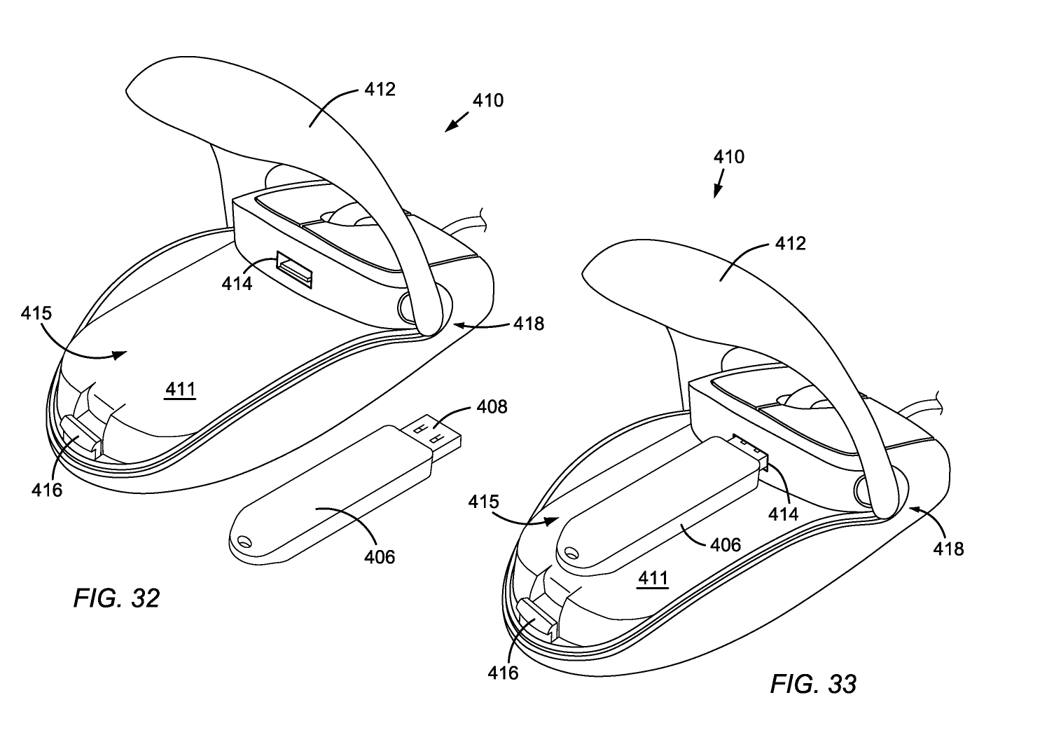

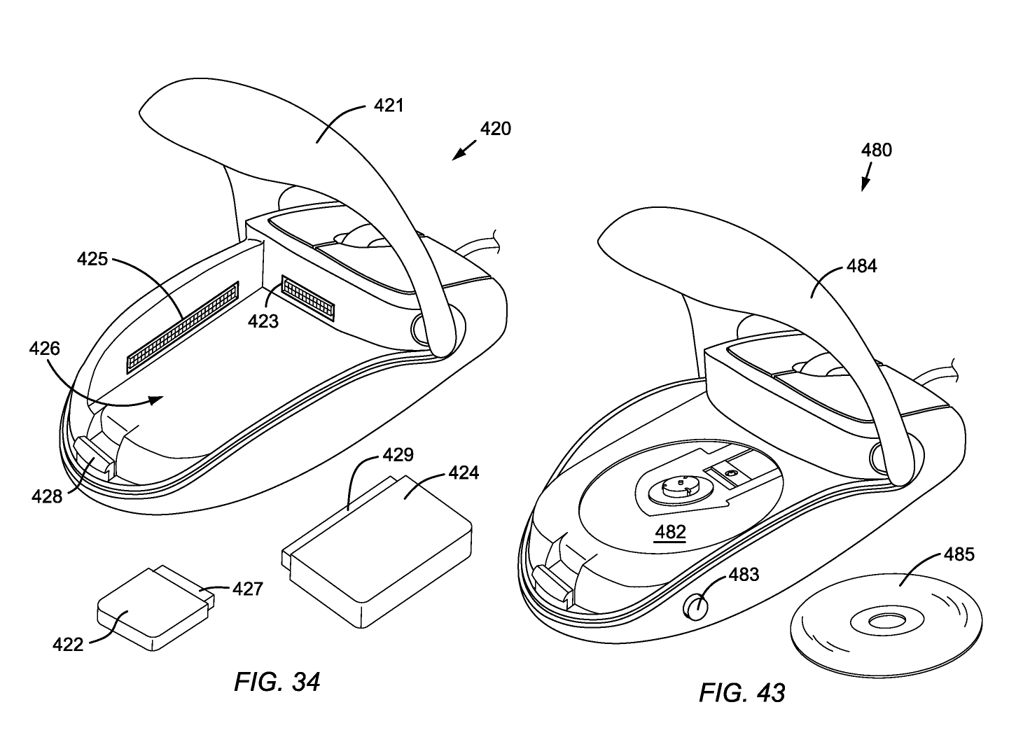

FIG. 31 shows a representation of a Properties Settings dialog box 390 suitable for the mouse apparatus depicted in FIGS. 8 to 15 and FIGS. 17 to 25. Each functional device embedded within the mouse apparatus 350, as shown in FIG. 28, may be controlled from a single tabbed dialog box 390.

The mouse tab 391 contains a control and settings area 397 for the mouse electronics and software similar to that found in a computer mouse in the Control Panel area of a typical Windows operating system. Additional tabs shown include tabs associated with the wireless adapter function 392, the mini hard drive device 393, a GPS chipset 394, power management 395, and general user settings 396.

Changes to any device settings are effected using the apply button 400. Also shown are a cancel button 399, an OK button 398, a help button 402, a dialog box title bar 401, and a dialog box close button 403.

It should be understood that upcoming technological advances may affect or may cause to replace the embedded devices of the computer mouse apparatus with future equivalent devices, standards, and connection means. These may also be similarly embedded and utilized within the mouse apparatus without departing from the spirit and scope of the present invention.

FIG. 32 is a perspective view of a computer mouse apparatus 410 with its enclosure cover 412 in an open position showing a mouse cavity 415 with an integrated USB jack 414, and with USB module 406 removed and shown beside computer mouse apparatus 410.

In FIG. 32, the removable USB module 406 is shown fixedly attached to USB plug 408 and removed from the mouse cavity 415 as the bottom surface 411 of mouse cavity 415 is shown bare. A cavity is formed by the walls of the bottom surface 411 and the bottom of enclosure cover 412 when closed. Mouse cavity 415 can receive and house various types of modules such as USB module 406 and other USB-based devices, examples of which are flash memory drive, Wi-Fi adapter module, GPS module, USB-connected mini hard drive, gas sensor, temperature sensor, vibration sensor, accelerometer, humidity sensor, gas and smoke sensor, keypad, touchpad, speaker, camera, network card, display, light meter, magnetic sensor, fingerprint reader, web cam, light sensor, altimeter, custom module, scientific module, USB hub, indicator module, and the like.

FIG. 33 illustrates a perspective view of a computer mouse apparatus 410, as shown in FIG. 32, but with USB module 406 connected into USB jack 414 via its associated USB plug 408.

The various types of modules, such as USB module 406, may be fixedly attached to a USB plug 408, which in turn is slidably received by USB jack 414 as shown in FIG. 33. The modules rest on bottom surface 411 when inserted. The various module types may be manufactured in such a form that the enclosure cover 412 can be sufficiently closed and secured against the bottom surface 411 using the securing hook 416. USB module 406 is protected by enclosure cover 412 and can be secured by pulling down enclosure cover 412 via enclosure hinge 418 and fastened by securing hook 416. A release mechanism (not shown) is provided for manually releasing enclosure cover 412.

In keeping with the present invention, USB module 406 may be integrated or built into the mouse cavity 415 or it could be separated from the computer mouse apparatus 410. USB module 406 rests on the bottom surface 411 as USB plug 408 (partly shown) is locked into its associated USB jack 414. Inserting a USB module 406 permits a convenient storage and allows ready access for back-ups or to store data files. For example, a flash USB module may have sufficient memory for back-up and data portability. Generally, connection to the host PC is via a common USB cable or via wireless as previously described. The removable modules may have internal power supply or it may be powered externally via a USB connector.

FIG. 34 illustrates a perspective view of a computer mouse apparatus 420, similar to that shown in FIGS. 32-33, with its enclosure cover 421 in an open position showing module jack A 423 and module jack B 425, which are of different sizes. Module A 422 with fixedly attached module plug 427 and Module B 424 with fixedly attached module plug B 429 are shown beside computer mouse apparatus 420.

The mouse apparatus 420 illustrated in FIG. 34 differs from the mouse apparatus 410 illustrated in FIGS. 32-33 in that the two module jacks 423, 425 are built-in into the mouse cavity 426. The two module jacks slidably receive respective module A plug 427 and module B plug 429, which are associated with various connectors and modules. Mouse cavity 426 may contain one or more module jacks and which can slidably receive various forms of connectors and modules, such as module A 422 and module B 424. Typically, such modules may be memory modules of various standards such as: Secure Digital (SD), mini SD, Multimedia cards (MMC), Compact Flash, Sony memory stick, and other memory module products. These removable memory modules, which are inserted singularly, are typically utilized to store and transport data in digital cameras, cell phones, music players and other consumer electronics. The modules may also be specialized modules of the type associated and enumerated in FIGS. 32-33. Enclosure cover 421 protects the modules in a closed position as the cover is secured and released via securing hook 428.

Computer mouse apparatus 420 may contain suitable interface electronics to allow the modules and connectors to share information and content access to the host PC.

FIG. 35 illustrates a perspective view of a wireless computer mouse apparatus 430 with an integrated PCMCIA slot 432, and a PCMCIA module 434 that is fixedly attached to a PCMCIA connector 435, removed and shown beside wireless computer mouse apparatus 430.

PCMCIA slot 432, as depicted in FIG. 35, may be made of sufficient height and size and may be positioned in a way to suitably and slidably receive PCMCIA connector 435 and the fixedly attached PCMCIA module 434 from the back or rear position as shown in FIG. 36 or from the side position alternate location of PMCIA slot 433. A suitable connector may be located within the slot cavity (not shown) which connects to the PC card slot.

FIG. 36 illustrates a perspective view of a wireless computer mouse apparatus 430 as shown in FIG. 35, but with PCMCIA module 434 connected into the PCMCIA slot 432 via PCMCIA connector 435.

An associated internal PCMCIA jack (not shown) slidably receives PCMCIA connector 435 (shown in FIG. 35) as PCMCIA module 434 is inserted into PCMCIA slot 432. PCMCIA module 434 is fixedly attached to PCMCIA connector 435.

PCMCIA modules perform a variety of functions and are readily available, such as USB 2.0 adapters, Wi-Fi adapters, 3G adapters, memory drives, flash memory sticks, GPS receivers, mini hard drives, network hubs, modems, Ethernet, and the like.

FIG. 37 illustrates a perspective view of a wireless computer mouse apparatus 440 with an integrated USB jack 442, the latter protected by a spring-loaded cover 444. Also shown also is a USB module 446 with fixedly attached USB plug 447, removed from and shown beside wireless computer mouse apparatus 440.

Wireless computer mouse apparatus 430 may also be connected to the host PC via a USB cable. If it is wired, power is supplied via the USB connector. The PCMCIA module 434 has suitable interface electronics to communicate to the host PC via Wi-Fi or W-USB (wireless USB) connection, provided that communication capability is built-in into the mouse apparatus and its associated base and that a suitable portable power supply is available.

The slot formed by USB jack 442 is protected by a visible spring-loaded cover 444 to prevent entry of foreign bodies such as dust and pests when USB module 446 is removed from wireless computer mouse apparatus 440 as shown in FIG. 37. The tensioning of the spring-loaded cover 444 is accomplished by a metallic or plastic spring or by a magnet. The door may contain a compressed or stretched spring pressing one part against the other so that it is able to retract into the mouse apparatus when a module is inserted and slidably received by a USB jack.

FIG. 38 illustrates a perspective view of a wireless computer mouse apparatus 440 as shown in FIG. 37, but with USB module 446 connected into USB jack 442.

USB plug 447, which is fixedly attached to USB module 446, is inserted into and slidably received by USB jack 442 in such a way that spring-loaded cover 444 is moved out of the way and hinged internally. The size and height of USB jack 442 and spring-loaded cover 444 may be made to match a specific type of module. Alternatively, they may be made to accommodate a variety of module sizes.

The wireless computer mouse apparatus 440 may communicate with the host PC via an integrated USB wireless adapter such that there is no need to install a separate wireless network in the host PC. USB module 446 and other USB-based devices may have an embedded or removable memory in the mouse apparatus to store, back-up, update, and synchronize data files.

FIG. 39 shows a mouse apparatus 450 incorporating a gas sensor unit 452 and its associated electronics.

Ventilation holes 454 permit airflow 453 to the gas sensor unit 452. A low vibration fan may be incorporated within the mouse enclosure to assist airflow and ventilation through the mouse apparatus 450. The ventilation holes 454 are so designed as to prevent the entry of insects or other pests into the unit. Gas sensor 452 may detect specific gases such as carbon monoxide (CO), CO2, methane, and the like. Such a mouse apparatus may find use in an industrial environment to prevent possible suffocation risk from inadvertently inhaling odorless, colorless, and flammable gases. Incorporation of gas sensor 452 within a mouse apparatus permits the user to be protected from site to site without the need for a stand alone gas detector unit. The mechanical parts and electronic circuitry of the mouse, such as the optical sensor, scroll wheel, and buttons are unaffected by the operation of the gas sensor.

It should be understood that a smoke alarm or heat sensor with their associated electronics may also be embedded within the mouse apparatus. Such safety sensors and their associated electronics may obtain their power directly through the host PC USB cable connection or ideally, through a rechargeable battery with sufficient capacity to operate for several weeks without recharging.

FIG. 40 shows a mouse apparatus 455 incorporating a dual cursor pointing device.

A Trackpoint device 456 is located between the right-click button and left click button of the mouse apparatus. An optical sensor 458 (shown in hidden outline) is located on the bottom surface of the mouse apparatus 455. A scroll wheel 457 is located on the left side of the mouse and operated with the thumb for scrolling purposes. A push button may be incorporated within the scroll wheel 457 as is the convention. The scroll wheel 457 may function similarly to the wheel mouse typically found in a Logitech mouse.

It should be understood, that the Trackpoint device 456 may be assigned a separate function from the optical sensor 458. For example, the Trackpoint device may be configured through the Control Panel within Windows XP to scroll the contents of a window. The use of both the Trackpoint device 456 and the optical sensor 458 as cursor pointing devices would enable the user to move the cursor great distances without lifting the mouse off the surface of the table or desk. The mouse apparatus 455 may be connected to the host PC via a wired or wireless connector. If the mouse apparatus is wired, it will typically receive power through the wired connection as is the convention.

FIG. 41 shows a computer mouse apparatus 462 on the top of a companion solar panel or array of solar cells 461 disposed within a mousepad 460.

The computer mouse apparatus 462 may be a generic mouse or one specifically designed for low power use with the solar panel mousepad 460. The larger solar panel area of the mousepad 460 may provide a higher power output for continuous mouse operation than the computer mouse apparatus 470 shown in FIG. 42.

A clear transparent or translucent polycarbonate material may be used to expose the solar cells 461 to solar energy. The top enclosure material may be finely patterned to permit the mouse sensor to detect mouse movement even when the sensor is an optical sensor. Such a pattern may include a crisscross arrangement of fine frosted lines or dots incorporated within the top polycarbonate material.

The solar panel mousepad 460 may be available in a range of functionalities. In its most basic form, the mousepad 460 contains a solar panel 461 with the necessary electronic components to serve as a power supply or battery recharger (not shown). Such a power supply or battery recharger may function to recharge other devices such as cell phones, MP3 players, and the like through a suitable connector jack or cable adapter. It is expected that the mouse will receive power from the solar panel mousepad 460 through its USB connector plug 463 that is plugged into the USB jack 464 on the side or rear of the mousepad. A specific battery charger connector may also be used to recharge the mouse batteries.

The mousepad may communicate through a wireless-USB, Bluetooth, Wi-Fi, or similar wireless connection 467 to the host PC. A wireless-USB (UWB), Bluetooth, Wi-Fi or similar wireless dongle 466 is connected to the host PC's mouse connector or USB connector to facilitate signal transfer from the mouse to the host PC with its wireless receiver chip 468. Laptops or future PCs and wireless devices may have a built-in support for wireless-USB, Bluetooth, or Wi-Fi and thus, may not require the use of a separate USB dongle 466.

The mousepad may also include appropriate electronics to serve as an external USB hub with its associated downstream USB connection ports (not shown). Similarly, for wireless networks such as mesh networks, the solar panel mousepad and its associated circuitry 465 may serve as a connection point or relay point to extend the range of wireless devices and networks.

FIG. 42 shows a mouse apparatus 470 powered by solar energy.

Disposed within the mouse enclosure and accessible to solar energy through a translucent or transparent enclosure cover 472 is a solar panel or array of solar cells 473. The enclosure material 472 may be of a clear polycarbonate material to permit adequate access to solar radiation. The solar panel material may be of a rigid structure or a flexible structure. The solar cells 473 may be used to supplement the power needs of the mouse device and its additional components. For example, the solar cells may be used to recharge internal batteries for wired or wireless mouse operation. A booster circuit, DC to DC converter, and/or voltage regulators may be used to stabilize the voltage and operate the mouse electronics at a suitable voltage in a variety of lighting conditions.

The solar cells for the solar cell mouse apparatus 470 of FIG. 42 and the solar cell mousepad 460 of FIG. 41 may be made of a flexible material such as H-AS solar film panel or of the more rigid but common Polymorphous silicon.

FIG. 43 shows a mouse apparatus 480 with an integrated optical drive 482 located within the mouse enclosure and accessed by opening the enclosure cover 484.

The optical drive 482 typically reads data from a mini CD-ROM disc 485. It should be understood that optical drive 482 may also write data to a smaller version of CD-R, CD-RW, and various DVD disc formats. Push button 483 is pressed to release enclosure cover 484 to permit easy insertion and removal of the optical disc 485. The enclosure cover 484 is spring-loaded and damped to gently lift it to an open position.

The mouse apparatus 480 may be connected to a host PC or similar electronic device through a shared USB cable connection facilitated by the hub architecture of FIG. 16 or FIG. 28. The mouse and the optical drive electronics receive their power through the USB powered connection.

A smaller 1- or 2-inch form factor disc 485 is used with the optical device. The technology may be based on CD-ROM or DVD disc including the newer standards such as HD-DVD, Blu-Ray Disc, or Iomega's AO-DVD. The functionality supported allows such smaller discs to be used for data storage, video games, music, movie recording and playback, as a boot device, and for installing software programs. Optional Buttons (not shown) located internal or external of the mouse apparatus may permit the user to stop, start the device, and allow the device to play, rewind, and fast forward through presentations, music, or movie content.

Turning now to FIGS. 44a to 46b. It is not uncommon for a mouse apparatus and a keyboard apparatus to occasionally fail or become intermittent as a result of frequent and intense use of their associated mouse buttons and keyboard keys. This may result in putting too much stress on the miniature switch mounted on the printed circuit board (PCB) because of the continuous and heavy clicking and thus may eventually damage the said switch. Accordingly, to prevent or minimize such an occurrence, FIGS. 44a-44b and 57-58 incorporate several shock absorbing means to reduce and dampen stress on the miniature switch.

FIGS. 44a-44b are simplified partial cross sectional views of a computer mouse apparatus taken along lines 44-44 of FIG. 1, showing a molded pressure absorbing spring 496 that functions to reduce the stress on a miniature switch 490 caused, for example, by frequent heavy clicking of a user.

In FIG. 44a the hand and the finger 498 (usually the index or middle finger) of the user are shown in a disengaged position. Molded pressure absorbing spring 496 is integrated into the bottom of mouse button 104 (such as a left-click button) and rested on a miniature push button switch or microswitch 490. Also shown are a printed circuit board (PCB) 492 where the switch 490 is mounted, as well as a portion of mouse enclosure 101.

FIG. 44b shows the hand and finger 498 in an engaged position as the tip of the finger 498 presses on mouse button 104, as indicated by finger pressure direction arrow 494. The stress caused by the continuous pressing down of mouse button 104 is borne by the molded pressure absorbing spring 496. However, there is still enough force transmitted to the spring 496 to actuate miniature push button switch 490.

FIGS. 45a-45b illustrate a fixedly attached pressure absorbing leaf spring 502, a variation of the spring design as shown in FIGS. 44a-44b.

FIG. 45a shows a hand and finger 498 of the user in a disengaged position. The pressure absorbing leaf spring 502 is fixedly attached to the bottom of mouse button 500 as it rests on miniature push button switch 490. The spring 502 may be of a different material from the mouse button 500 as it could be metallic or plastic and ultrasonically welded. Just as in FIGS. 44a-44b, the fixedly attached pressure absorbing spring 502 also functions to reduce the stress caused, for example, by frequent heavy clicking of a user.

FIG. 45b shows the hand and finger 498 of the user in an engaged position as the tip of the finger 498 presses on mouse button 104, as indicated by finger pressure direction arrow 494. As the leaf spring 502 bears the stress caused by a continuous pressing down of mouse button 500, the leaf spring 502 still transmits enough force to actuate the switch 490.

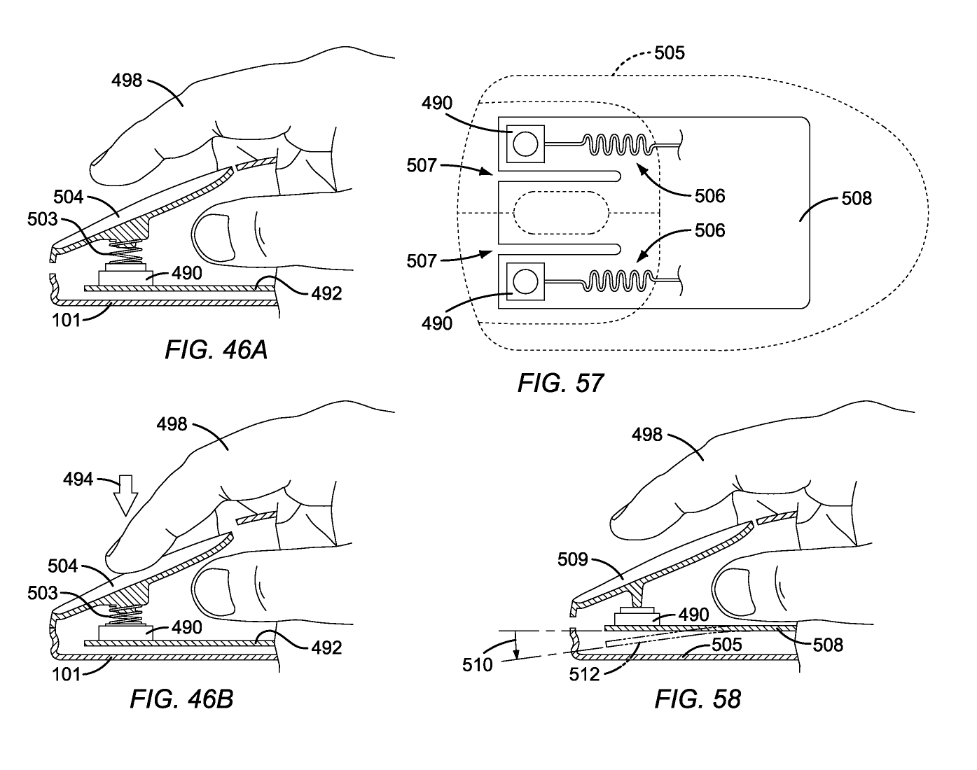

FIGS. 46a-46b illustrate a pressure absorbing compression spring 503, a further variation of the spring designs as shown in FIGS. 44a-45b.

The hand and finger 498 of the user are shown in a disengaged position in FIG. 46a with a pressure absorbing compression spring 503 in a rested position. The spring 503 may also utilize a traditional spring that may be compressed or stretched pressing one part against another to take in stress when finger 498 pushes down mouse button 504.

FIG. 46b shows the hand and finger 498 of the user in an engaged position as the tip of finger 498 pushes down on mouse button 504 and flattens the compression spring 503, as indicated by finger pressure direction arrow 494. The stress caused by the continuous pressing down of mouse button 504 is borne by the compressed spring 503. However, there is still enough force transmitted to the spring 503 to actuate miniature push button switch 490.

It should be understood that the various spring designs illustrated in FIGS. 44a-46b can limit or reduce the amount of force applied to switch 490 and printed circuit board (PCB) 492 when the mouse button is pushed down continuously but can still apply enough force to easily actuate the switch 490.

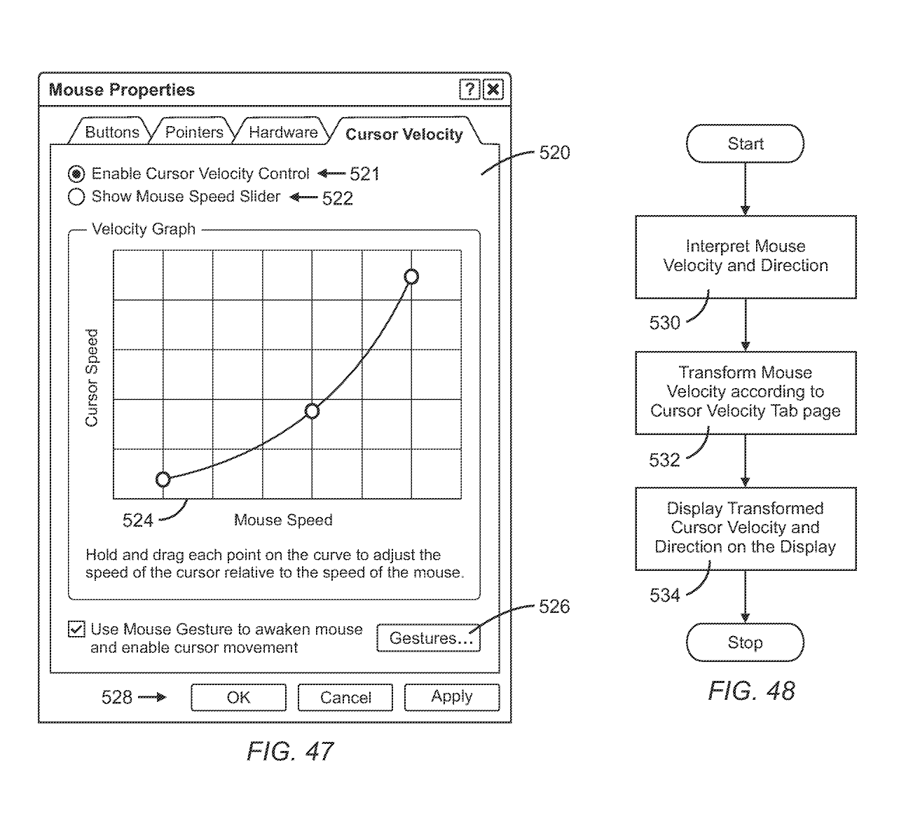

FIG. 47 shows a cursor velocity tabpage 520, which is used to control the relationship between the velocity of the mouse movement and the velocity of the displayed cursor associated with the mouse movement.

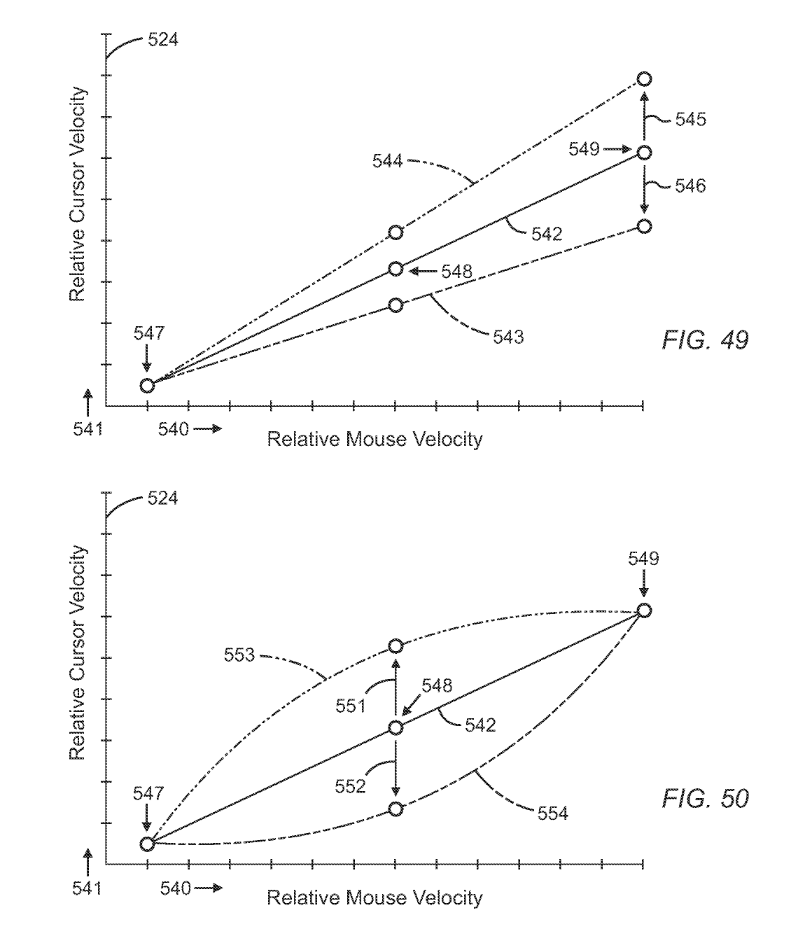

Shown in tabpage 520 is a two-dimensional graph 524 which maps the mouse's physical velocity (shown on the X axis 540 of FIGS. 49-50) to the displayed cursor velocity (shown on the Y axis 541 of FIGS. 49-50). The function of the graph and its control points is explained in more detail in FIGS. 49-50.

A mouse gestures settings button 526 is also indicated. Specific mouse gestures may be used to enable the display cursor if the mouse has been inactive for some time. Examples of mouse gestures include circular clockwise or counter-clockwise movements, zigzag movements, and sideways movements. This is helpful in environments where there is vibration or accidental movements of the mouse and the user does not wish these accidental movements to move the display cursor.

The two-dimensional velocity graph is shown when radio button 521 is selected. If radio button 522 is selected, a more conventional one-dimensional slider velocity control appears (not shown). Any change to the settings of the cursor velocity tabpage 520 is effected by pressing the option buttons 528.

FIG. 48 shows a simple flowchart process to control cursor velocity.

With each movement of the mouse, the optical, laser, or mechanical sensor that is associated with the mouse measures the displacement of the motion sensor and make this data available to the host or target device. The software under the control of the host or target device interprets the mouse displacement, for example the motion's velocity and direction 530, and prepares to map this information to the display cursor 532 according to the settings of the cursor velocity tabpage. The mouse displacement data is then displayed as a cursor movement with a specific direction and an adjusted cursor velocity 534.

FIGS. 49-50 show in detail the operation of the two-dimensional graph 524 of FIG. 47. The graph 524 permits the user to adjust how the speed of the physical mouse maps to the speed of the mouse cursor on the display device. A line or curve 542 and curve control points 547, 548, 549 are shown on the graph 524. Each curve point may be held and dragged up or down as indicated by direction arrows 545, 546, 551, 552 to change the shape of the curve 542 to 544, 543, 553, or 554 respectively. The function of the curve control points 547, 548, 549 are similar to the function of the curve control points in the Duotone Curve dialog box available in Adobe Photoshop CS.

The default straight line shape shown in FIG. 49 is consistent with the speed control function of a mouse apparatus set using the Control Panel in Windows XP. Two alternative curve shapes 553, 554, are shown in FIG. 50. In the top curve 553, a slow mouse speed results in exaggerated cursor speed movements in the same direction. Further increases in mouse speed result in a diminishing cursor speed response. In the bottom curve 554, slow mouse speed results in slower cursor speed movements in the same direction. Further increasing mouse speed results in a more exaggerated cursor speed response. Thus the user can customize cursor speed response as a function of various mouse speeds.

The curve 542 shape may be constrained to prevent a negative slope in the curve 542 as this may confuse some users of the velocity control graph 524. Similarly, the leftmost point 547 of the curve 542 should not cross the Y axis 541 (the relative cursor velocity axis). Otherwise, it would imply that the cursor should move when the mouse is stationary and there is no mouse velocity.

The leftmost point 547 may however, be placed on the X axis 540 (the relative mouse velocity axis) to imply that there is a certain threshold velocity necessary with the mouse in order for the display cursor to respond to the mouse movement. Although the controls shown in FIGS. 47, 49-50 are shown for 2D mouse speed adjustment, it should be understood that the same graph technique may be used to control mouse speed to display cursor velocity in a 3D environment. Similarly, although the control is directed towards cursor velocity, it will be available when a 2D or 3D object is moved in a program or game. Cursor velocity control may also be adapted for use with a Trackpoint™ device, a Trackball™ device, or a Touchpad™ device. The following discussions are intended to provide a brief, general description of the computer apparatus architecture. Accordingly,

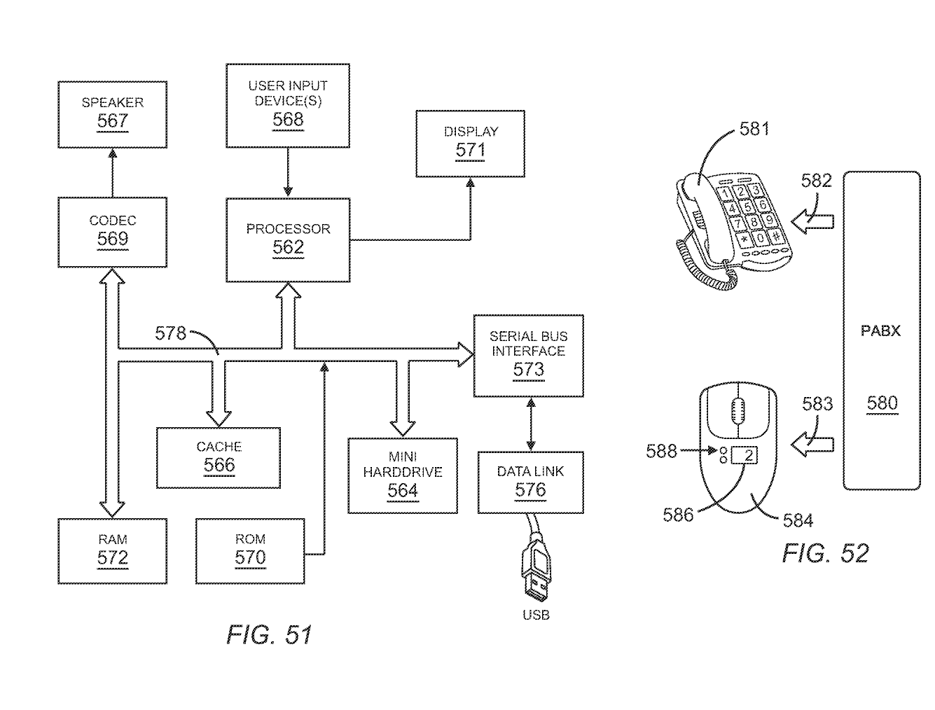

FIG. 51 shows a computer apparatus architecture typically associated with the mouse apparatus of FIGS. 17-25 in accordance with an embodiment of the present invention.

The mouse apparatus architecture permits the mouse to act as a network device in any wired or wireless network or USB connection. The computer mouse apparatus of FIG. 51 includes a processor 562 that pertains to a microprocessor or controller for controlling the overall operation of the mouse apparatus. This processor 562 is typically a low power consumption processor or a system-on-a-chip design. The mouse apparatus stores different kinds of data such as audio, media, documents, and the like in a mini hard drive 564, cache 566, or RAM 572. The mini hard drive 564 is typically a small storage disk fitting within the form factor of a mouse apparatus. The mini hard drive 564 typically provides data storage capability for the mouse apparatus and back-up storage for other devices. However, since the access time to the mini hard drive 564 is relatively slow, the mouse apparatus may also include cache memory 566. The relative access time to the cache 566 is substantially shorter than for the mini hard drive 564. However, the cache 566 does not have the large storage capacity of the mini hard drive 564. Furthermore, when active, the mini hard drive 564 consumes more power than does the cache 566. Power consumption is particularly important when the mouse apparatus is a stand alone mouse powered by a battery (not shown). The mouse apparatus also includes random-access memory (RAM) 572 and read-only memory (ROM) 570. The ROM 570 can store programs, utilities or processes to be executed in a non-volatile manner. The RAM 572 provides volatile data storage such as for the cache 566.

The mouse apparatus also includes a number of user input device(s) 568 such as a scroll wheel, keypad, left-click and right-click buttons, touchpad input, Trackpoint device, and the like that allow a user to interact with the mouse apparatus.

Still further, the mouse apparatus includes a display 571 such as an LCD display that can be controlled by the processor 562 to display the output and other information to the user. A system bus 578 facilitates data transfer between at least the mini hard drive 564, cache 566, processor 562, and CODEC 569. The mouse apparatus also includes a serial bus interface 573 that couples to a data link 576 such as a USB connection. The data link 576 allows the mouse apparatus to couple to and become submissive to a host device. If the mouse apparatus detects that there are no host devices nearby, the mouse apparatus may serve as the host device itself. The audio CODEC 569 produces analog output signals for a speaker 567. The speaker 567 can be a speaker internal or external to the mouse apparatus.

FIG. 52 shows one use of a mouse apparatus with added functionality.

A PABX branch exchange telephone system 580 is shown in an office environment setting. Incoming calls are routed to an extension telephone unit 581 through a wired connection 582. However, if the recipient of the call is not present in their office (or does not wish to be disturbed), a message waiting indicator 586 or voicemail waiting indicator may be shown on the mouse apparatus 584. Messages can be transmitted to the mouse using a wired or wireless connection 583. The mouse apparatus may have additional buttons and lamps 588 to cancel or scroll through call data or to reset the indicator display. With the added functionality and processing capability of the mouse, keyboard, and PC headset apparatus depicted herein, it is desirable to network or assign the apparatus output to a specific device through a wired or wireless connection. Accordingly,

FIGS. 53a and 53b show a partial view of a network mouse apparatus 590 assigned to input data to a specific device.

The network mouse apparatus 590 may be connected to a network device, a host PC, or a peripheral device using a suitable wired connector or wireless communications standard such as Wi-Fi. The network mouse apparatus 590 includes a power supply, a right-click button and left click button 595, a scroll wheel 594 with its associated button (located beneath the scroll wheel and not shown), an optical sensor (not shown) located at the bottom of the network mouse apparatus 590 for providing mouse displacement information, and an LCD display 592 or low power display accessible to the user with a form factor suitable for use on a mouse apparatus. Electronics circuitry to support the mouse function and the electronics and software to permit the network mouse apparatus 590 to interface with suitably configured network devices such as PCs and servers are self-contained within the mouse enclosure.

In FIG. 53a, the network mouse apparatus 590 is assigned to PC1 as indicated in display 592 by direction arrow 596. To change the target device for the mouse's displacement data, the user accesses the change target function of the network mouse (not shown) and uses the scroll wheel 594 to scroll down to the next target device, for example PC2 as indicated in FIG. 53b by direction arrow 597. To change the target device, the user has only to enter the new device on the mouse using the left-click on button 595. After the target device for the network mouse is changed from PC1 to PC2, the mouse movement or displacement data from the network mouse apparatus moves the cursor display associated with PC2, not PC1.

It should be understood that a network keyboard apparatus may also be assigned to input data to a specific device either on a network or through a direct connection. Similarly, both the network mouse apparatus and the network keyboard apparatus may be assigned to a single target device simultaneously for fast and convenient access.

The display 592 of the network mouse apparatus 590 may show a list of target devices accessible or assignable to the network mouse's data output, including its displacement data output. As detailed in FIGS. 53a and 53b, the mouse display 592 enables the network mouse apparatus to access key functions within a target device, such as to move the cursor associated with the target device, or to control various functions on the device through the interface or GUI menu displayed.

FIG. 54 illustrates a typical operating environment for network mouse apparatus 601, 602.

Network mouse apparatus 601 is a wireless device such as a wireless-USB device, while network mouse apparatus 602 has a wired connection to a network or a second device. Other devices on the representative network 600 include PC 603, server PC 604, printer 608, laptop PC 607, optical or magnetic storage device 606, and a TV or LCD display 605.

A network mouse apparatus may connect to different devices directly or via a network connection. Such connections may be enabled through a variety of wired or wireless standards and protocols such as USB, Ethernet ports, Wi-Fi, Bluetooth, wireless-USB, and the like.

Administrative permissions may be required to enable a device to accept input or displacement data from the network mouse apparatus 601, 602, either through a direct connection or through a network connection, be it wired or wireless. Such administrative access settings, permissions, and security restrictions or firewalls are typically on the target device side but may also be implemented on the network mouse apparatus. For example, the mouse may have the ability to exercise administrative control over one or more devices on a wired or wireless network. Once configured, the network mouse apparatus and the target device to which it directs its displacement data will have the necessary software, hardware, and drivers to communicate and exchange data in a seamless but secure environment.

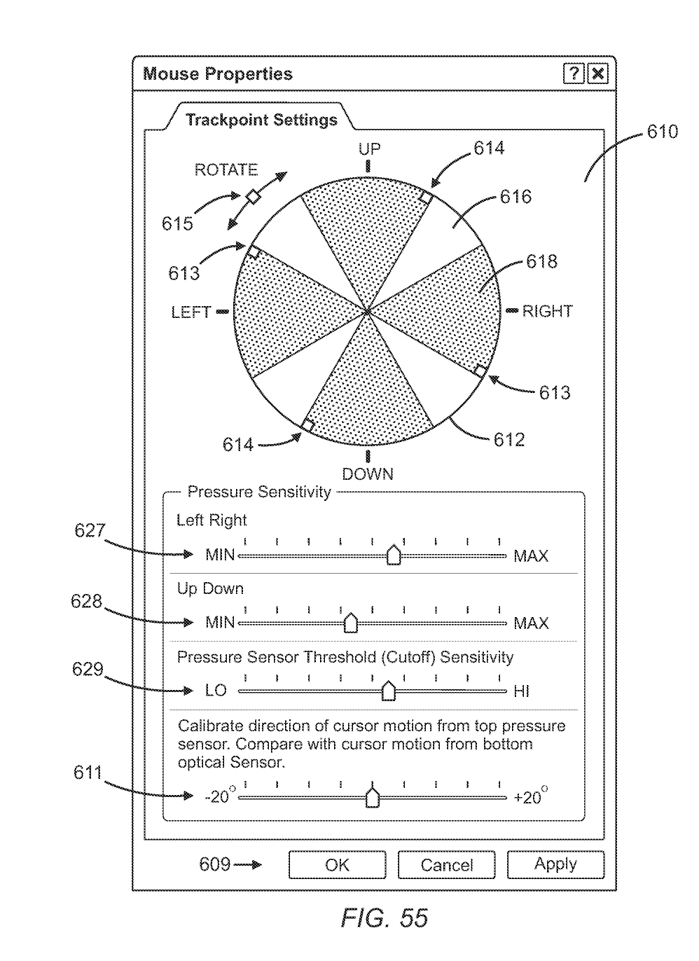

FIG. 55 shows a Trackpoint settings tabpage 610 associated with a Trackpoint device should it be present on a mouse apparatussuch as mouse apparatus 455 of FIG. 40.

The Trackpoint device possesses properties and characteristics that are different from the optical sensor typically located at the bottom of the mouse apparatus 455 of FIG. 40. Thus, both the optical sensor and the Trackpoint device need to be calibrated separately and with respect to each other. For example, the pressure exerted by the index finger on the Trackpoint device may make the display cursor skew in a direction different from that of the optical sensor. Control 611 permits the user to rotate the Trackpoint device cursor direction relative to the optical sensor so that both sensors move the displayed cursor in a similar intended direction for a specific user.

Similarly, there are Trackpoint pressure sensitivity controls 627, 628 for the left-right and up-down pressure respectively, exerted on the Trackpoint device by the index finger of the user. A threshold pressure level may be set with control 629 wherein the display cursor will not move if the pressure is below such a threshold. This control 629 is especially useful if the user rests his or her finger on the Trackpoint device during normal mouse operation.

The Trackpoint device controls may also be effected graphically using the circular graphical control 612. For example, control 615 will rotate the direction of the displayed cursor travel when pressure is applied to the Trackpoint device. The square control point is held and dragged with a cursor similar to the circular control points shown in FIGS. 49-50. The user should notice the changes to their cursor characteristics in essentially real time. Changes to any settings are effected by pressing button 609.

Similarly, square control points 613 adjust the direction angle of pressure exerted on the Trackpoint device that results in a left-right scroll operation. Square control points 614 adjust the direction angle of pressure exerted on the Trackpoint device that results in an up-down scroll operation. As square control points 613, 614 are held and dragged, the angle shown graphically by the dotted pattern 618 expands or contracts for the respective square control point. The empty space 616, if present, will result in a no scroll action if pressure is exerted on the Trackpoint device in such a direction. It should be noted that a generic strain gauge with its associated control algorithm may be used in lieu of the Trackpoint device, and similar generic substitutions may be made in relation to the Touchpad device and other branded and trademarked devices.

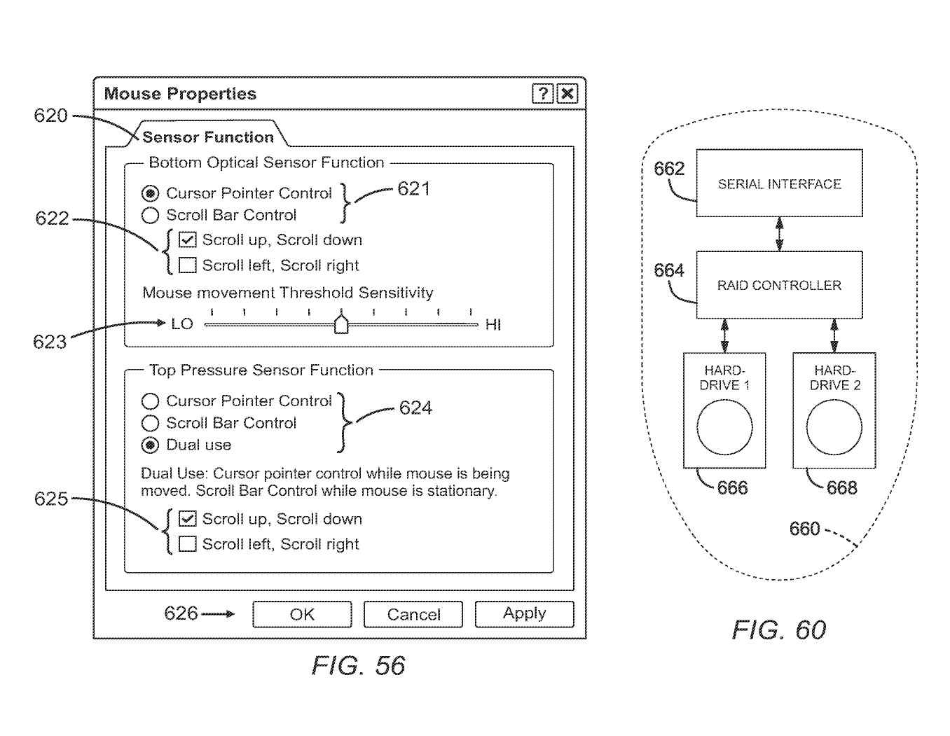

FIG. 56 illustrates a sensor function tabpage 620. The sensor function tabpage 620 assigns the function of each of the dual sensors on the mouse apparatus. For example, when displaced, the bottom optical sensor may function to scroll a window's contents or as a cursor pointing device. Such settings are made with radio buttons 621. Checkboxes 622, 625 permit the scroll bar movement to be limited to the up-down or left-right direction if desired. A threshold level sensitivity control 623 may be used to limit cursor movement if vibration is present, such as in an industrial setting or when traveling. The top pressure sensor or Trackpoint™ device as depicted in FIG. 40 may be used as an additional cursor pointing device, a scroll bar control, or both, depending on whether the bottom cursor is detecting movement or a stationary mouse. Such settings are made with radio buttons 624. Changes to any settings are effected by pressing buttons 626.

FIG. 57 illustrates a top view of a cantilevered printed circuit board (PCB) 508 that serves as a means of pressure absorption, a variation of the pressure absorbing spring designs as shown in FIGS. 44a-46b.

The cantilevered printed circuit board (PCB) 508 is partly mounted to the bottom of mouse enclosure 505 with two cut-out portions 507 to separate the two mouse buttons. Also shown are two copper wire conductors 506, each one composed of two wires or conductors that serve as contact points. The wires are somewhat curved to reduce stress and prevent the wire from cracking when the printed circuit board (PCB) 508 is bent as a result of pushing down the mouse button 509.

FIG. 58 is a cross sectional view of the mouse apparatus shown in FIG. 57 and a variation of the cross sectional views of FIGS. 44a-46b.

In FIG. 58, a hand and finger 498 are shown in a disengaged position as mouse button 509 rests on miniature push button switch or microswitch 490. The cantilevered printed circuit board (PCB) 508 flexes when pressure is applied on mouse button 509 during, for example, continuous clicking by a user. The flexing action of the cantilevered PCB 508 reduces the amount of stress exerted on the switch 490 as the cantilevered PCB 508 moves down to its PCB flex position 512 as indicated by flexing direction arrow 510. As the cantilevered PCB 508 reduces the force applied to the switch 490, there is still enough force applied to easily actuate switch 490.

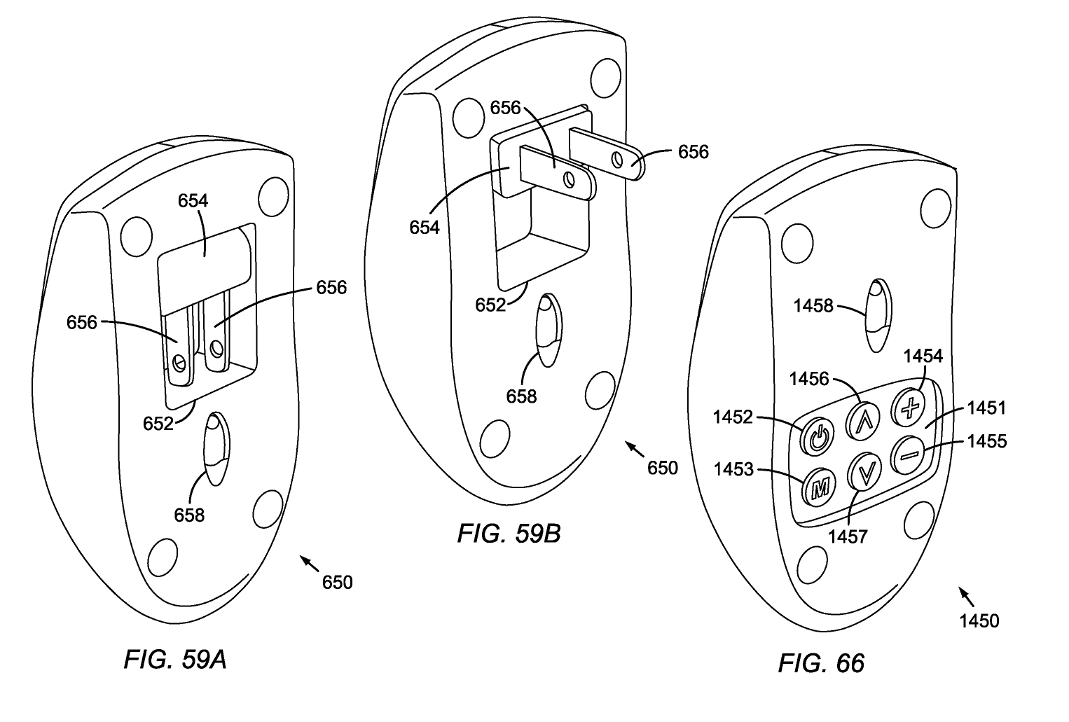

FIGS. 59a and 59b show bottom views of a mouse apparatus 650 with a built-in charger unit and a retractable wall plug 654 at its bottom.

The retractable wall plug 654 is housed in a wall plug cavity 652 located at the bottom of the mouse unit near the mouse displacement sensor 658 (typically an optical sensor). When not in use, the wall plug's metallic prongs 656 are normally recessed within the mouse enclosure 650 and wall plug cavity 652 and do not touch the surface on which the mouse operates. When the unit requires charging, an indicator light (not shown) on the top surface of the mouse apparatus may indicate a low power condition. The mouse apparatus is charged by rotating the wall plug 654 essentially 90 degrees outward and pushing the wall plug's metallic prongs 656 into a power receptacle. Once fully charged, the mouse apparatus may be removed from the power receptacle and the wall plug retracted to its original stored position. An indicator lamp may indicate a fully charged condition. It should be understood that the mouse apparatus and its internal rechargeable batteries may be charged over a range of voltages, for example, from 110-220 volts, and may also be used to operate some of the devices on the mouse apparatus with relatively higher power consumption.

FIG. 60 shows a mouse apparatus architecture when the additional device is in a RAID system of mini hard drives. Redundant array of independent (or inexpensive) disks (RAID) system components include at least two hard drives 666, 668 within the mouse apparatus enclosure 660. The hard drives 666, 668 are typically mini hard drives with performance suitable for use within a RAID system for faster read/write times or mirroring of data to both hard drives. The hard drives 666, 668 are connected to the controller chip 664 that interfaces with the serial interface 662 to ultimately connect to the target device or host PC. The mouse architecture (not shown) also interfaces with the serial interface to share a common path to the target device or host PC.

It should be understood that with the rapid developments of wireless device technology, each device may have an independent wireless path or channel to the target device or host. In this arrangement, the bandwidth need not have to be shared among all the devices. For example, the mouse-specific data may be communicated via a USB cable that also supplies power to all devices within the mouse enclosure 660. However, the RAID data may be received and transmitted wirelessly using a wireless adapter (not shown) integrated within the enclosure.

When multiple devices are networked or share a common wired or wireless bus connection, the mouse specific functions within the mouse apparatus may be given priority or additional bandwidth when the mouse is being used to increase its performance. When a mouse is used on a desktop PC, it is often connected directly to a USB port rather than through a hub to improve performance.

The present invention discloses how multiple devices may share a common mouse enclosure, which may drastically reduce manufacturing, packaging, and distribution costs relative to individually packaged USB or PC card (PCMCIA slot) devices such as flash memory sticks, GPS receivers, mini hard drives, Wi-Fi adapters, and network hubs. Such use of a mouse enclosure saves on the overall costs because multiple separate devices commonly purchased by computer users can be integrated or built into the mouse enclosure. With the present invention, there is no need to install a separate wireless network adapter PCI card, PCMCIA card, or standalone USB wireless adapter to the host PC. The wireless or Wi-Fi adapter is built-in into the computer mouse or keyboard.

In the present invention, USB-based devices can have embedded or removable memory to store, backup, update, and synchronize data files. For example, RAM in a mouse with USB or wireless connection may be adopted as a convenient backup device to store data files. A flash memory reader or flash memory incorporated within a mouse may have 32-1024 Megs of memory for back-up and data portability. This approach enables the user to take a wireless adapter and mouse with a laptop to access additional devices without a lot of tangled cords or the inconvenience of attaching separate devices one at a time. Generally, connection to all devices will be thru a common USB cable.

The computer mouse apparatus may be used by travelers who desire convenience and may be made available in hotels, restaurants, parks, bars, and other public hotspots to allow patrons to access a wireless network.

The preferred embodiment of the present invention is an optical computer mouse with an embedded wireless adapter and with the computer mouse connected to its host PC by a USB connector. A USB hub or hub/bridge is also embedded within the mouse enclosure to allow the wireless adapter to share a single USB connection to the host PC. A Trackpoint device may be incorporated into the mouse enclosure to function as a cursor-pointing device and/or a window scroll control device. RAM memory and/or a flash memory card reader may also be incorporated within the mouse enclosure or the USB connector. As a wireless device, the computer mouse apparatus incorporates the wireless adapter, memory and memory card reader in either the base USB connector unit or the mouse enclosure.

It should be understood that the preferred embodiment of the present invention and the additional functionality as described and shown in the drawings may also be incorporated within a Keyboard Apparatus, a PC Speaker Apparatus, a PC Headset Apparatus, and similar devices. For example, the gas sensor of FIG. 39 may be similarly integrated into a Keyboard Apparatus, as may be the solar panel as depicted in FIG. 42, the PMCIA slot of FIGS. 35-36, the flash drive as shown in FIGS. 37-38, the modules associated with FIGS. 32-34, the device assignments control of FIG. 53, the various architecture embodiments as shown in FIGS. 16, 26-28, 51, the Wi-Fi adapter as shown in FIGS. 8-9, and the like.

Although most of the figure drawings of the present invention display additional functionality related to a computer mouse apparatus, such additional functionality may be similarly integrated into a Keyboard Apparatus and other similar computer devices as mentioned herein.

There are four methods that a single USB device can use to present multiple devices to a host: Compound, Composite, Complex, and Common class. USB devices, whether wired or wirelessly connected to their host, should support such interface methods if they present multiple devices to their host or to multiple alternating hosts. Information on the USB standard are readily available: see “An Analysis of Wireless Device Implementations on Universal Serial Bus”, USB Wireless White Paper, Jun. 3, 1997 and “USB Complete: Everything you need to developed custom USB peripherals”, Axelson, J., 2005.

A compound device appears as a hub to the system. The individual devices supported by a compound device appear to the system as devices that are attached or detached from the ports on the hub. The key difference between a compound device and a hub is that individual devices supported by a compound device are made to attach or detach electronically rather than by physically inserting or removing a cable. The advantage of this approach is that full software support is in place. The attachment and removal of wireless devices would be the same to the system as the attachment and removal of wired devices on a standard hub. The disadvantage is that additional silicon would be required to present a 15-port compound device.

Another method of introducing multiple devices to a host through a single USB device is the composite method. A USB composite device is basically a device with multiple independent interfaces. It appears to the system as a single USB address that uses multiple interfaces to present the individual devices. These interfaces are defined by the interface descriptors stored in the device.

A composite device has one address on the bus but each interface has different function and specifies its own device driver on the host. For example, a composite device could have one interface for an audio device and another interface for the control panel. Comparing this to a compound device, a compound device includes both I/O and hub functionality. A keyboard apparatus that includes additional USB downstream ports is such an example. The advantage of this approach is that full software support is in place. The disadvantage is that individual devices can only be attached or removed by forcing a disconnect which takes down all the devices on the dongle and reconnecting with new configuration, interface, and Endpoint descriptors that define a new set of devices attached to the dongle.

Composite devices implement two or more sets of device functions. For example, an eye camera with a camera, dual audio channels, and a microphone is a composite device. Composite devices appear to the system as a single USB address that uses multiple interfaces to present the individual devices. A (Human Interface Device) HID class device requires 2 endpoints: Control and Interrupt In. The term endpoint is used to describe a point where the data enter or leave the USB system. When implemented as a Composite Device, the control endpoint (0) is shared by all the devices while separate interfaces need to be allocated to contain each interrupt endpoint.

The advantage of this approach is that full software support is in place. The disadvantage is that individual devices can only be attached or removed by forcing a disconnect, which takes down all the devices on the dongle, and reconnecting with new Interface (which is collection of endpoints and is directly related to the real-world connection), Configuration (which is a collection of interfaces and defines attributes and features of a specific model), and Endpoint Descriptors that defines the new set of devices attached to the dongle. The USB Endpoint Address is a 4-bit field, which limits the number of HID devices that can be supported by a composite implementation to 15. Typical silicon implementations support 4 endpoints therefore only 3 HID class devices.

Complex devices are defined only by the HID class. In the HID Report Descriptor, a complex device is created by declaring multiple top level Application Collections. This approach is similar to a Composite implementation. However, all devices defined in the Complex device share the same interrupt endpoint. The advantage of this approach is that full software support is in place. The disadvantage is that individual devices can only be attached or removed by forcing a disconnect that takes down all devices on the dongle and reconnecting with a new Report Descriptor that defines the new set of devices attached to the dongle. Another disadvantage is that a Complex Device is only defined within the HID specification. A general purpose solution should not assume that all wireless devices will be HID devices.

In general, the set-up of a wireless mouse is composed of an electronic mouse and a host adapter such as a dongle. The mouse communicates with the dongle by means of radio frequency (“RF”) signals. The dongle is connected to a host system such as a personal computer (“PC”) typically through the USB port. Some present configurations of a wireless mouse use the short-range RF technology that operates at 2.4 GHz called Bluetooth. In recent years, Bluetooth has become a popular solution for interfacing different PC peripherals such as trackballs, keyboards, and game joysticks. Bluetooth is also being used with mobile devices such as PDAs, smart phones, mobile phones, and laptops to wirelessly synchronize and transfer data among devices. Reasons behind the growing use of Bluetooth in different devices can be attributed to its key features: robustness, low complexity, low power, and low cost. These make Bluetooth very suitable for mobile devices and PC peripherals, especially human interface devices (“HID”).

With these key features, HID devices enabled with Bluetooth wireless technology such as a keyboard or a mouse can be used to alternately control different computers or host PCs without concern for connecting cables. In a particular embodiment, a Bluetooth-enabled mouse is used to control two host PCs. The user is provided with two manually-operated buttons that facilitate the host selection process. A user can select a particular host by pressing a button that makes the mouse “virtually-cabled” to one host PC. To select the other PC, a user presses the other button to “unplug” from the first host PC and “plug” to the second host PC. Accordingly, the invention is an implementation of a dual-host mouse by embedding host-selectors in the form of manually operated buttons on the present embodiment of a wireless mouse.

FIG. 61 shows a block diagram of the two host PCs (host PC one 1411 and host PC two 1412) in a wireless dual-host mouse apparatus 1410 system. Two host adapters in the form of dongles 1415, 1416 facilitate the communication between the wireless dual-host mouse apparatus 1410 and the two hosts, host PC one 1411 and host PC two 1412. The dongles 1415, 1416 are typically connected to the host PCs through the USB port. The wireless dual-host mouse apparatus 1410 includes a connect button 1413 that facilitates the temporary pairing procedure as part of the initialization process. After the hosts' system start-up, the user presses the connect button 1413 on the mouse to start the initialization process by putting the dual-host mouse apparatus 1410 into discoverable and connectable mode. Any of the two hosts may now discover the wireless dual-host mouse apparatus 1410 establish a virtual cable connection to it. However, only a single host connection is supported at a time. The first host PC that successfully initiates a pairing procedure with the wireless dual-host mouse apparatus 1410 is typically designated as host PC one 1411. For now, the host PC designated as host PC two 1412 is not allowed to establish a connection to the mouse. The wireless dual-host mouse apparatus 1410 also includes two host-selector buttons 1417, 1418. The upper housing of the wireless dual-host mouse apparatus 1410 serves as the platform where the host-selector buttons 1417, 1418 are located. The host-selector buttons 1417, 1418 allow the user to select a desired host PC. The host-selector buttons 1417, 1418 are disabled until after the initialization process and the user presses one of the host-selector buttons 1417, 1418. The connect button 1413 and the host-selector buttons 1417, 1418 comprise the mechanical portion of the invention. Accordingly, FIG. 62 shows the block diagram of the electronic architecture of a dual-host mouse apparatus enabled with Bluetooth wireless technology. The electronic portion includes a processor 1422 that pertains to a dedicated processor or one that is shared with the other blocks on the wireless dual-host mouse apparatus 1410. The processor can be a microprocessor or a microcontroller. The processor 1422 controls the overall operation of the invention for the case of a dedicated processor or the whole mouse system for a shared processor. The wireless dual-host mouse apparatus 1410 also includes storage for two different authentication sequences. An authentication sequence is composed of the ID code of the host and a key generated by random-number generator 1426. The storage is typically RAM or Read-Only-Memory or ROM 1424. Again, the ROM 1424 can be dedicated storage or can be shared with the entire mouse system. In a particular embodiment, both processor 1422 and ROM 1424 are shared by the invention. The invention is composed of the connect button 1413, host-selector buttons 1417, 1418, and the random-number generator 1426 with the other components in the mouse apparatus system diagram 1420 such as the transceiver 1427, the Bluetooth Profile, Application and Protocol Stack 1428 and the mouse electronic circuitry 1429. The processor 1422 and ROM 1424 contain enough resources such as memory and I/O ports in order to support this set-up. The invention can either be connected directly to the processor or share a connection through a bus interface with one of the mouse components such as the transceiver 1427 as shown in FIG. 62.

The authentication sequence stored in the ROM 1424 is used by the wireless dual-host mouse apparatus 1410 to authenticate a host after the host-initiated pairing procedure. Usually, only the host is required to authenticate a HID device. However, it is mandatory to have a two-way authentication process after the initialization procedure in order to distinguish the two hosts. The authentication sequences are transmitted and assigned to the two host PCs sequentially. The host designated as host PC one 1411 is assigned the first authentication sequence. Host PC one 1411 then initiates an unplug operation that removes the virtual cable from between the host and the wireless dual-host mouse apparatus 1410. The wireless dual-host mouse apparatus 1410 returns to the discoverable and connectible mode after the unplug operation initiated by host PC one 1411. At this point, the Host PC two 1412 may now discover the wireless dual-host mouse apparatus 1410 and establish a connection to it. The host PC one 1411 may still discover the wireless dual-host mouse apparatus 1410. However, with the assignment of an authentication sequence, host PC one 1411 is expecting a two-way authentication process that is still not enabled during the initialization procedure and thus cannot establish a connection to the wireless dual-host mouse apparatus 1410. After the pairing procedure of Host PC two 1412 and the wireless dual-host mouse apparatus 1410, the other authentication sequence is assigned to Host PC two 1412. Host PC two 1412 then immediately initiates an unplug operation and the initialization process completes.

The wireless dual-host mouse apparatus 1410 returns to the discoverable mode but not to the connectible mode. Any of the two hosts may now discover the mouse apparatus although no host is allowed to establish a connection to the mouse apparatus until the user presses the host-selector button 1417, 1418 of a particular host. At this point, the one-way authentication process is still in effect such that both hosts, already configured as requiring two-way authentication process, are refused by the wireless dual-host mouse apparatus 1410. When a user presses one of the host-selector buttons 1417, 1418 to connect to a particular host, the two-way authentication process is enabled and the wireless dual-host mouse apparatus 1410 is in the dual-host mode. Upon the selection of a host, the processor 1422 decodes which button was pressed and fetches the corresponding authentication sequence from the ROM 1424. The processor 1422 then loads the authentication sequence to the Bluetooth stack 1428 in order for the wireless dual-host mouse apparatus 1410 to authenticate the selected host after the host-initiated pairing procedures are completed. When the host is authenticated, a virtual-cable connection is established between the selected host and the wireless dual-host mouse apparatus 1410. The selected host can now communicate with the wireless dual-host mouse apparatus 1410. At this point, a typical PC-mouse relationship exists between the selected host and the dual-host mouse apparatus 1410. To select a new host, the user presses the corresponding host-selector button 1417, 1418. It should be understood that the mouse electronic circuitry 1429 is exemplary of the prior art electronics associated with a mouse. Thus, the dual use functionality may be implemented in other input and output devices such as a keyboard, a graphics tablet, a webcam, a PC headset, and the like.

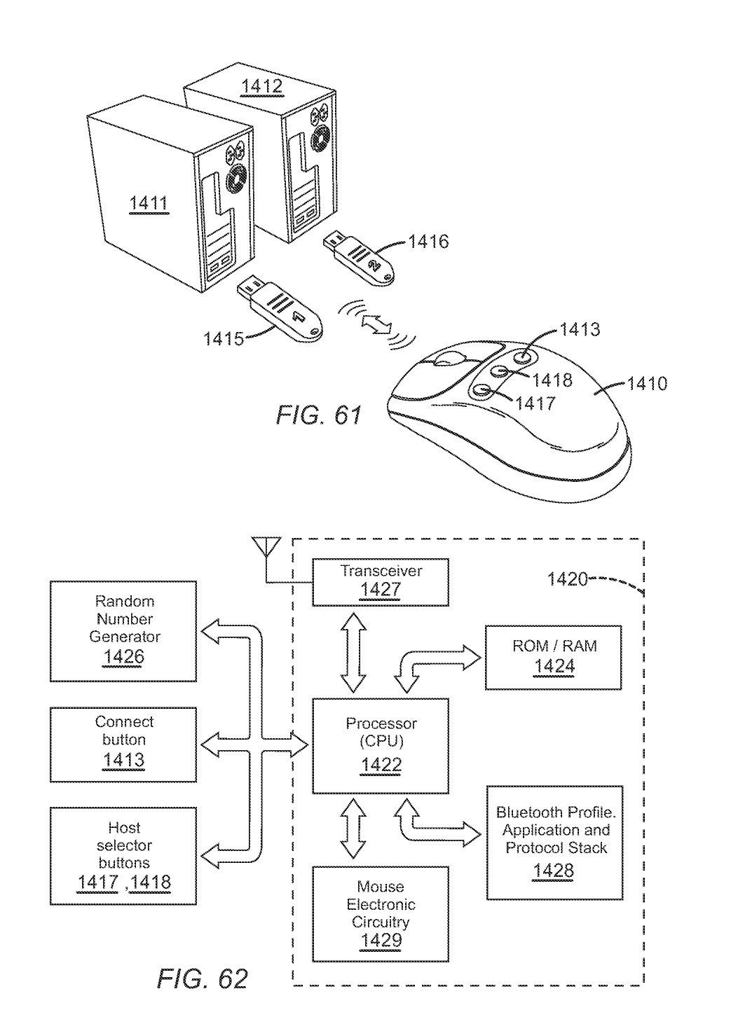

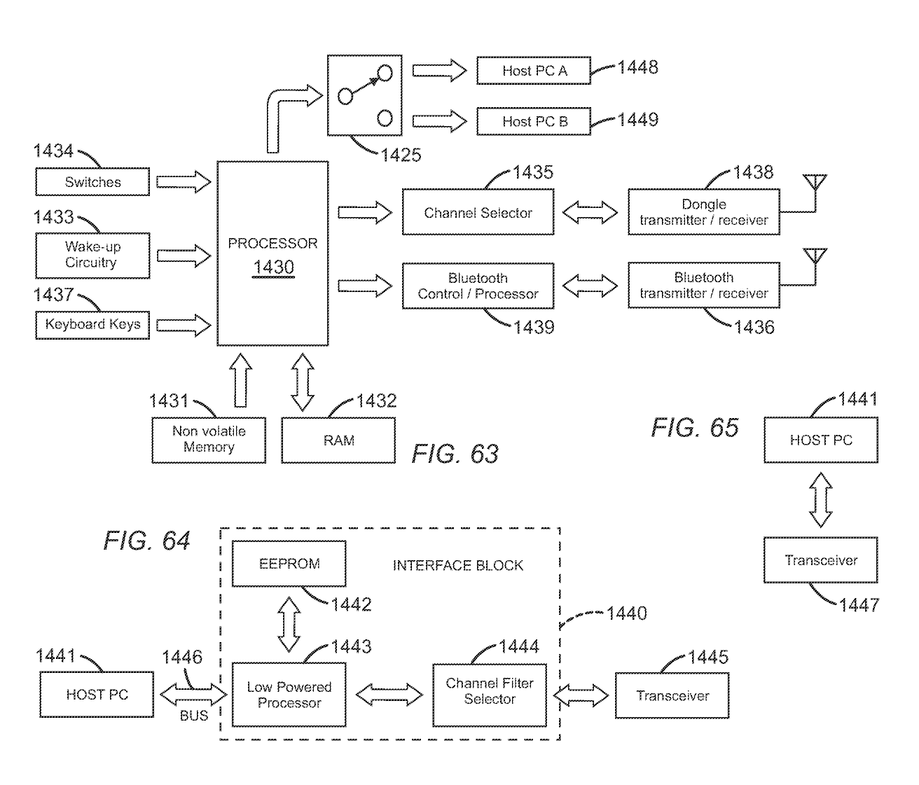

FIGS. 63, 64, and 65 show an alternative architecture to that presented for a dual host mouse apparatus presented in FIGS. 61 and 62. The descriptions of FIGS. 63-65 are directed to a multiple host keyboard apparatus. It should be understood that the architecture may be adapted and implemented in other devices such as a mouse, a graphics tablet, a webcam, and the like to give them multiple-host functionality.

FIG. 63 shows the schematic block diagram for the operation of the wired and wireless keyboard apparatus with multiple channels for different host PCs. The keyboard apparatus is able to communicate with different hosts whether wirelessly or through wired connection. A user is able to choose which host PC to direct the input of the keyboard apparatus through the host select switch 1425 which may be found on the top of the keyboard apparatus. In addition, it allows communication with Bluetooth-enabled devices such as PDAs and cellular phones. In FIG. 63, the invention of the wireless keyboard apparatus with multiple channels consists mainly of a processor 1430, nonvolatile memory 1431, RAM 1432, wake-up circuitry 1433, switches 1434 for choosing between channels, the channel selector 1435 when data is transmitted wirelessly, and the Bluetooth transmitter/receiver 1436 for communicating with Bluetooth enabled devices. (NOTE: what's the difference between the switches and the channel selector? Difference is not explained very well.)

The keyboard apparatus' power is from the wired connection to a host PC or from a battery in the keyboard apparatus (not shown in FIG. 63) if the keyboard apparatus is to be used wirelessly. When the keyboard apparatus is powered, the processor 1430 gets information from the nonvolatile memory 1431, which includes the default data channel (for example the wired connection to either host PC A 1448 or host PC B 1449), the available channels for transmission, instructions that control the flow of data on different channels, and other codes for identification of the hosts. The codes downloaded from the nonvolatile memory will be ID codes that correspond to the destination host PCs. The use of nonvolatile memory 1431 allows the storage of ID codes when the power is down.

Once the user selects one PC to be the host using the switches 1434, the processor 1430 of the keyboard apparatus sends the data (pressed key) together with the ID code to the input/output block of the Bluetooth transmitter/receiver 1436 (wireless connection) or directly to the cable (wired transmission). When the user chooses to send information through a dongle transmitter/receiver 1438, the Bluetooth transmitter/receiver 1436 and other transmitters will be in sleep mode. WUSB or any other proprietary standards may be used for the dongle transmitter/receiver. Multiple transceivers require a channel selector circuitry that can be hardwired or microprogram controlled. In case multiple wired connectors are used, a switch for choosing between the connectors may be added.

Preferably, power for the system will be provided by the cable to the host PC or an inexpensive power source such as a battery. If desired, a low voltage detector may be provided to signal low battery conditions to the user.

Power saving mode of the preferred embodiment adopts the power saving mode of the wireless mouse apparatus. The keyboard apparatus operates in three power modes—normal, standby and sleep—to conserve energy. In normal mode, the processor 1430 is clocked at its nominal speed and pressed key data is sent continuously to the host PCs. The keyboard apparatus enters standby mode when it is idle for a short period of time, such as 20 milliseconds. In this mode, the processor 1430 continues to work at normal speed. However, to further conserve power in standby mode, the processor 1430 switches off power to the Bluetooth transmitter/receiver 1436 and other transmitters. After a further period of nonuse, for example 10 seconds, the keyboard apparatus enters a sleep mode in which the processor 1430 enters a stop mode and the remainder of the circuitry is in full static condition.

Wake up circuitry 1433 periodically checks if any activity has occurred. If it senses any activity, it sends a signal that revives the processor 1430 out of its stop mode. If any activity (i.e. a pressed key or movement of the channel selector) does occur in either standby or sleep mode, the processor 1430 returns to normal mode and powers up the rest of the circuitry except for the inactive transmitters.

In wireless transmission from the processor 1430 to the input/output block of the dongle transmitter/receiver 1438 or Bluetooth transmitter/receiver 1436, the data and ID code will be processed for framing, encryption and encoding. This will then be filtered and modulated to RF frequency for transmission. The use of Bluetooth, WUSB or any proprietary standard for the transmitter allows minimal collision and confusion on the data sent.

The keyboard project may come with its own transceiver 1445 dongle to communicate with the host PC 1441 or may use any available wireless interface of the host such as Bluetooth or wireless USB. Shown in FIG. 64 is the interface 1440 of the keyboard transceiver 1445 to the host PC 1441 (the wireless keyboard apparatus comes with its own dongle for the host PCs). The block diagram is composed of an EEPROM 1442, a low-powered processor 1443, a channel filter selector 1444, and the compatible transceiver 1445, which comprise the interface 1440 of the wireless device to the host PC 1441. The transceiver 1445 may be any proprietary standard for wireless communication. The interface 1440 of the wireless device communicates to the host PC 1441 using a bus 1446.

In powering the device, the low-powered processor 1443 downloads the instructions from the EEPROM 1442. This includes the ID code for the keyboard apparatus and other transactions in order to decode and demodulate the signal from the device. Every time that the receiver of the host PCs 1441 receive and decode the signal from the transmitting keyboard, the processor identify the code and acknowledge the data when the code is correct. ID code determination of the host may be thru the installation software, data entry, or by out-of-band channel. Adding a channel filter selector 1444 to the interface 1440 of the transceiver 1445 to the host PC 1441 results in the user having the flexibility to select a particular channel.

FIG. 65 shows the direct connection of the Bluetooth transceiver 1447 to the host PC 1441. This allows the wireless keyboard to connect to or use the built-in Bluetooth device in the host PC 1441 or the available Bluetooth dongle of the user. Software should be provided to allow the host PC 1441 to interpret the decoded data of the Bluetooth transceiver 1447 as the keyboard data.

FIG. 66 shows a perspective view of a mouse apparatus 1450 with an integrated remote control. The remote control functions are accessed through buttons or equivalent control means which are typically located on the bottom surface of the mouse apparatus 1450 where they do not interfere with the placement of the user's hands on the mouse apparatus. The buttons are housed within a recessed cavity 1451 in such a manner that the buttons do not touch the surface on which the mouse apparatus 1450 rests or slides.

The integrated remote control may be used to control a variety of electronic devices such as TVs, DVD players, stereo systems, video recorders, fans, air conditioners, and the like. The mouse apparatus 1450 of FIG. 66 shows a limited number of exemplary buttons such as power on/off button 1452, mute button 1453, volume increase button 1454, volume decrease button 1455, channel up button 1456, and channel down button 1457 for use on a television, radio, or stereo system. Depending on the target device, the integrated remote control may signal remote devices using IR or optical LEDs, radio frequency transmitters (general purpose RF, Bluetooth, w-USB, Wi-Fi, mesh, and the like), or both.

The integrated remote control is operated by inverting the mouse apparatus 1450 and pointing its optical sensor, remote control LED 1458 toward the device(s) it controls. The LED associated with the optical mouse displacement sensor may also serve as the LED signal source for the remote control. Alternatively, a separate LED for the remote control may be used and located on the mouse apparatus. If a separate LED is used, it would typically be located toward the front of the mouse apparatus to conveniently direct the LED signal toward its target device in a manner similar to a conventional remote control. The mouse apparatus 1450 housing the integrated remote control may be wired to a host device but is typically wireless, in keeping with the operation of a conventional remote control. A wireless USB connection or a Bluetooth dongle (not shown) connects the mouse apparatus to the host PC.

The remote control may be pre-programmed to operate a specific device or may be programmed to operate a variety of devices in a manner similar to programming a universal remote control. The remote control function may also be programmed from software resident on the host PC associated with the mouse function. If the integrated remote control is software programmable, its target device may be assigned by the user through a configuration settings panel displayed on the host PC's display screen. The remote control software may also have GUI buttons present on the display screen that modulate the optical sensor, remote control LED 1458 to send signals to a variety of target devices. Software buttons present on a display screen may extend the function of the remote control beyond the limited number of physical keys located on the mouse apparatus. With appropriate software, the remote control's users may also set and save preferences for different devices and different users.

The functionality associated with the integrated remote control requires electronic circuitry located within the mouse apparatus 1450 and may require optional software present on the host PC to support the extra functionality described. The power for the electronic circuitry associated with the integrated remote control and in general any device integrated within the mouse, keyboard, or computer apparatus of the present invention may be supplied from the cable (typically terminating in a USB connector) connecting the mouse apparatus to the host PC, from disposable or rechargeable batteries located within the mouse apparatus (in the case of a wireless mouse apparatus), from an external AC/DC adapter, and the like.

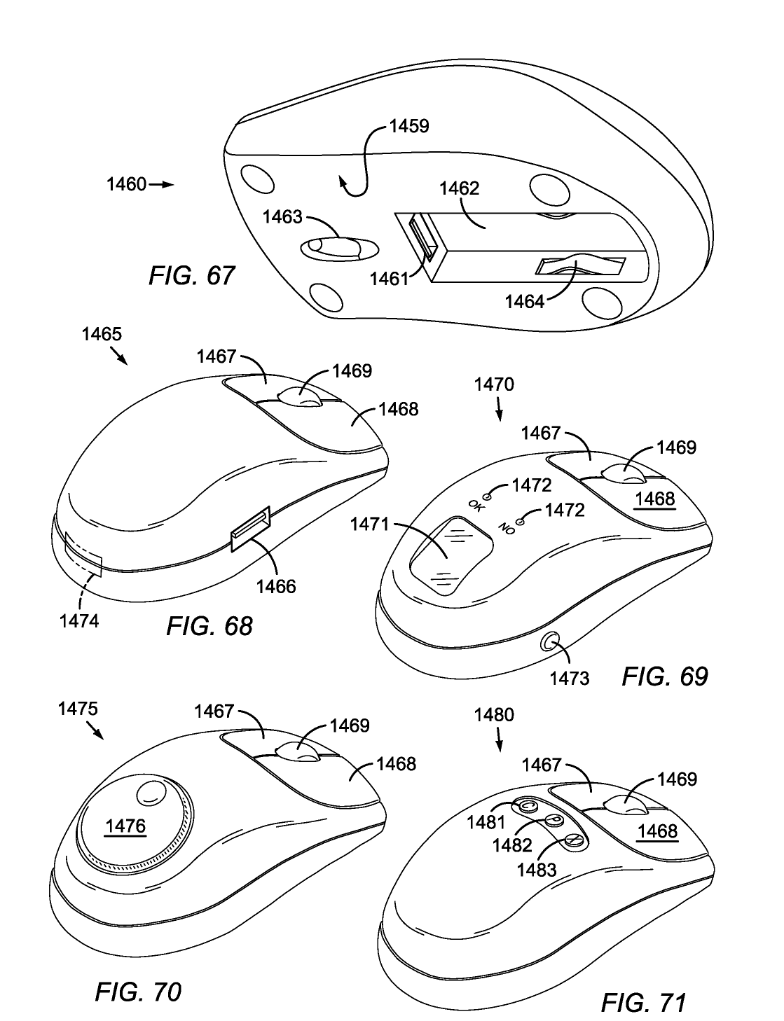

FIG. 67 shows a perspective view of a mouse apparatus 1460 with an integrated USB port 1461 for receiving a small device such as a memory stick or flash memory drive. The mouse apparatus 1460 of FIG. 67 is similar to the mouse apparatus 410, 440 of FIGS. 32-33 and FIGS. 37-38. However, the device cavity 1462 is disposed onto the bottom surface 1459 of the mouse apparatus 1460. Thus, the memory device may be attached in a convenient and inconspicuous manner to a host PC for extended periods of time. A lid or cover attachment (not shown) may be fitted to the cavity to keep any ropes, key rings, or clasps attached to the memory device from dragging on the surface on which the mouse apparatus 1460 rests. As shown on FIG. 67, the optical sensor 1463 is moved toward the front of the mouse apparatus 1460 from its conventional centered position to allow for the length required by the device cavity 1462 to accommodate the typical memory device form factor. Spring pads 1464 located on the sides of the device cavity 1462 are designed to press against most memory devices to help stabilize and secure them within the device cavity 1462. The memory device is inserted into a USB port 1461 or Firewire receptacle (not shown) located on one side of the device cavity 1462. It should be understood that more than one type of connector or port can be present within the cavity. For example, a USB connector and a Firewire connector may be located at opposite ends of the device cavity 1462. Furthermore, the connector may be used with an extension cable to connect devices such as a camcorder or digital camera to the host PC. In addition, one or more types of memory card readers may be disposed onto the remaining surfaces of the device cavity 1462 to extend the functionality of the mouse apparatus without creating clutter near the desktop PC.

FIG. 68 shows a south-east perspective view of a mouse apparatus 1465 with an externally mounted USB serial port 1466. The USB serial port 1466, such as a USB or Firewire port, may be located on any surface of the mouse apparatus 1465. Typically, the USB serial port 1466 is on the right side or rear portion of the mouse apparatus 1465 to reduce the chance of a connected device, such as a flash memory drive, from touching the right-side of a keyboard or bumping desktop clutter or beverages near the front of the mouse apparatus. Phantom line representation 1474 shows an alternative location for USB serial port 1466. Multiple similar or different connector or port types may be disposed on the mouse apparatus surface as a convenient method of connecting occasional use devices to a host PC.

FIG. 69 shows a south-east perspective view of a mouse apparatus 1470 with an integrated biometric scanner 1471 disposed on the surface of the mouse apparatus 1470. A biometric scanner 1471 such as a fingerprint reader or an iris scanner provides convenient means to enable access to files, programs, or services which require some form of biometric authentication. Indicator LEDs 1472 are provided on the mouse apparatus 1470 surface for a go, no-go verification indication. A reset button 1473 is also provided to abort a biometric scan or reset software on the host PC associated with the biometric scan. The biometric scanner 1471 may also provide authenticated access to files or data stored within the mouse apparatus 1470. In such an implementation, the files or data may be stored in a restricted or partitioned section of memory requiring authentication or decrypted with the aid of the biometric scanner 1471.

FIG. 70 shows a south-east perspective view of mouse apparatus 1475 with an integrated rotating control knob 1476. The rotating control knob 1476 may be based on an optical sensor (similar to the function of a scroll wheel on an optical mouse), on resistance (such as a potentiometer or a resistive polymer strip), or on inductance, capacitance, or magnetic changes. The rotating control knob 1476 may be rotated clockwise or counterclockwise, similar to the operation of a volume knob or tuner knob on a stereo receiver. The rotating control knob 1476 outputs a digital signal that may control the level of an assigned parameter and configured for a variety of tasks such as to adjust the volume of music, scroll up and down a window, adjust the speed of a process, increase the performance or resources assigned to an application, and the like.

FIG. 71 shows a south-east perspective view of a mouse apparatus 1480 with a Copy key 1481, a Paste key 1482, and a Cut key 1483 conveniently located on the top surface of the mouse apparatus 1480. The keys 1481, 1482, 1483 may vary in size and location but are typically grouped together in an orderly arrangement and include words, letters, or symbols printed on or near each key that are consistent with the “copy”, “paste”, and “cut” functions in Windows, Linux, or Mac O/S applications. Similar copy, paste, cut, and other function keys may also be implemented on other computer apparatus. Although the mouse apparatus 1480 of FIG. 71 may be directed toward users who organize and edit considerable content from one application to another, it may be used to swap content between different host PCs. For example, the multiple host keyboard apparatus 1760 of FIG. 117 may use similar copy, paste, and cut keys to copy-and-paste or cut-and-paste data or content from one host device to other host devices connected to a mouse apparatus or keyboard apparatus that supports multiple host interoperability and connectivity. Content swapped between host devices, be it images, selected text or data, files, or folders, may be stored in the integrated memory present in the mouse apparatus or keyboard apparatus. The computer apparatus of the present invention that support multiple hosts may utilize a software program to manage the copying, storing, and movement of such content between hosts.

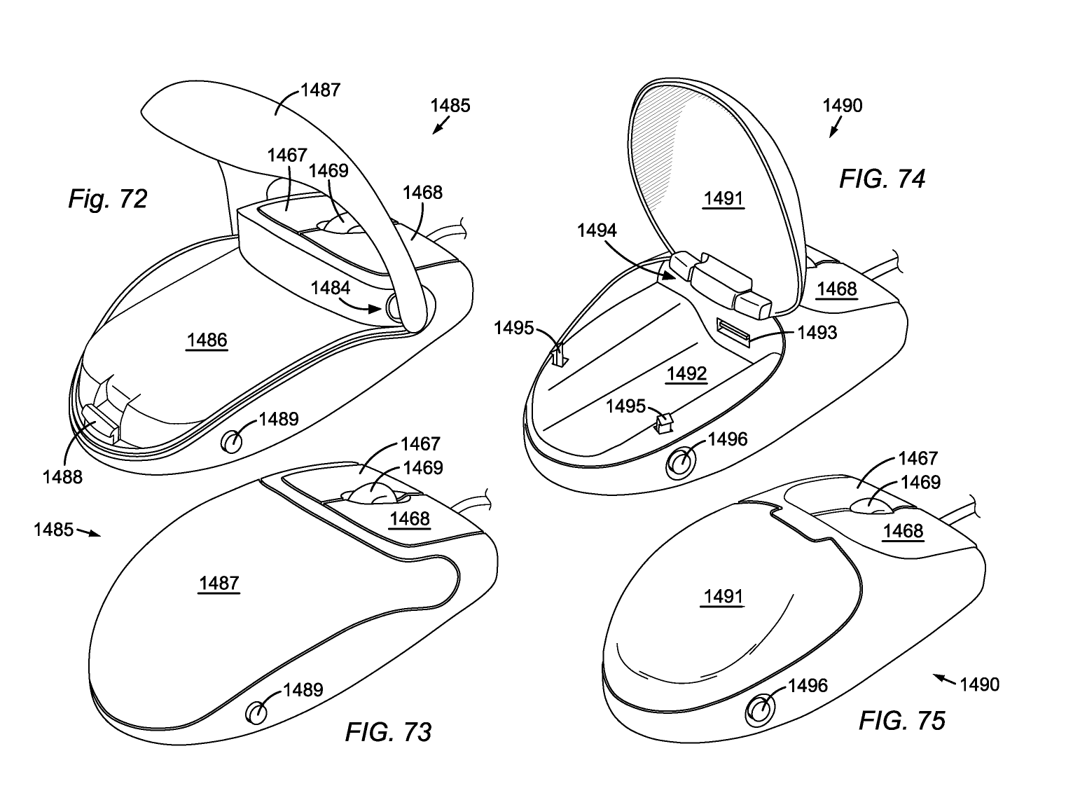

FIG. 72 shows a perspective view of a mouse apparatus 1485 with an enclosure cavity 1486 for storing small items within the mouse apparatus 1485 and close to the host PC. The enclosure cavity 1486 is similar to mouse cavity 415 of FIG. 32 but the USB jack 414 is omitted. An enclosure cover 1487 (shown in its open position) permits convenient access to any stored items. Examples of possible stored items include address books, keys, memory modules, password lists, stamps, coins, and the like. The enclosure cover 1487 is kept closed by the retaining hook 1488. To open the enclosure cover 1487, the release button 1489 is pressed.

FIG. 73 shows a perspective view of the mouse apparatus 1485 of FIG. 72 with its enclosure cover 1487 in a closed position. A transparent window made of glass, polycarbonate plastic, or other similar materials may be fitted onto the enclosure cover 1487 to permit the user to visually inspect the enclosure cavity 1486 without opening the enclosure cover 1487 to see if any items are present inside.

FIG. 74 shows a perspective view of a mouse apparatus 1490 with its enclosure cover 1491 open. The enclosure cavity 1492 contains a USB jack 1493 suitably positioned towards the front of the mouse apparatus 1490 to allow a USB flash memory drive or similar sized USB dongle to be inserted securely within the enclosure cavity 1492. The mouse apparatus of FIG. 74 employs a different hinge 1494 design and two retaining hooks 1495 to secure the enclosure cover 1491 on the mouse apparatus 1490 body compared to the mouse apparatus 410, 420 of FIGS. 32-34. There is sufficient space within the enclosure cavity 1492 to permit most cords or ropes attached to the USB device to fit within the enclosure cavity. When pressed, the release button 1496 retracts the retaining hooks 1495 and permits the spring-tensioned enclosure cover 1491 to rise to its open position (shown). The enclosure cover 1491 is closed by pushing down the spring-tensioned cover down until the retaining hooks 1495 latch onto and retain the enclosure cover it in a closed position. FIG. 75 shows a perspective view of the mouse apparatus 1490 of FIG. 74 with its enclosure cover 1491 in a closed and latched position.

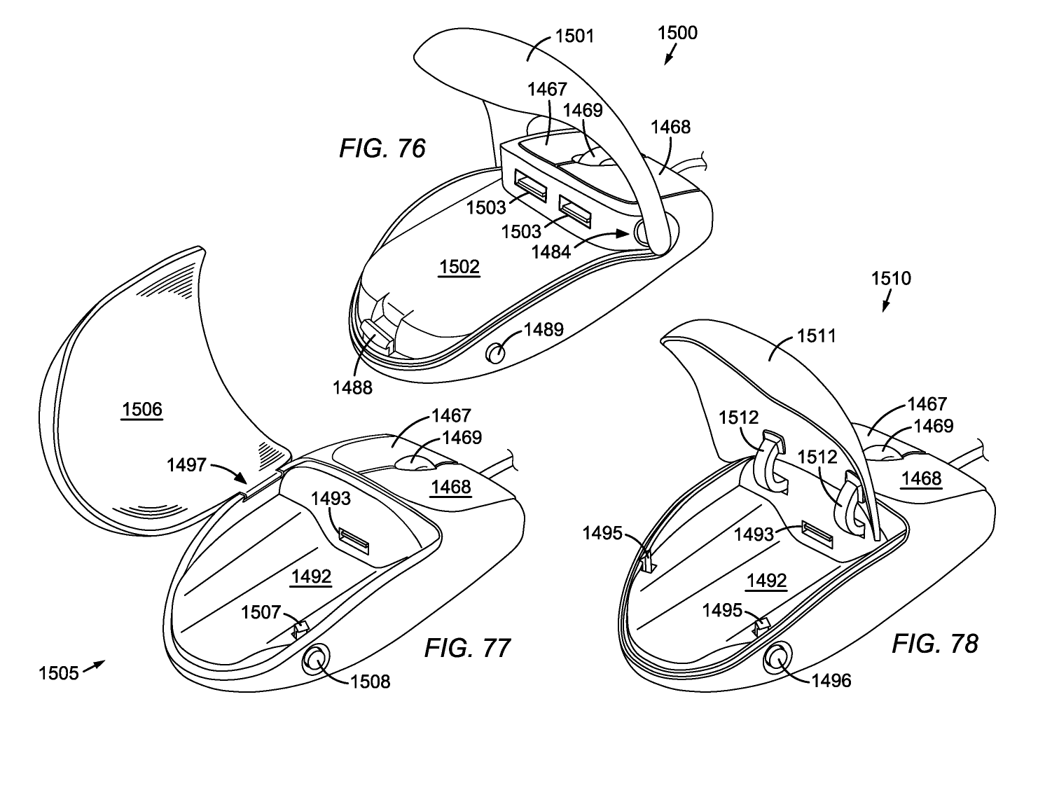

FIG. 76 shows a perspective view of a mouse apparatus 1500 similar to the mouse apparatus 410, 420, 1485 shown in FIGS. 32-33, and 72 but employing two adjacent USB jacks 1503 within the enclosure cavity 1502. It should be understood that having two USB jacks 1503 permits two USB devices to be inserted and accessed from the mouse apparatus 1500. This may be convenient for moving or copying files from one flash memory device to another, for keeping backups of important data, or for having a second redundant USB port to the host PC. Similarly, one or both USB jacks 1503 shown may be replaced by other common or specialized connectors such as a Firewire jack, a microphone input jack, a headphone output jack, connectors for a PC headset, audio and/or video input or output jacks for digital downloads or uploads from a camcorder, digital camera, webcam, MP3 player, or other gadgets, a fiber optic connector, a digital audio input/output, an s-video connector, battery charger terminals, and the like. The enclosure cover 1501 serves to keep devices connected to the USB jacks 1503 out of reach or sight to prevent device damage or clutter in a work area.

FIG. 77 shows a perspective view of a mouse apparatus 1505 similar to the mouse apparatus 1490 shown in FIG. 74 but employing a side-mounted hinge 1497 design to secure the enclosure cover 1506 to the mouse apparatus 1505 body. Such a design may be convenient for users who may have to operate their mouse on occasion when the enclosure cover 1506 is open as shown. For example, the device inserted into the USB jack 1493 may require a visual readout from a display, or the user may need to frequently insert and remove several USB devices. It should be understood that the enclosure cover 1506 may be designed to be removed or detached from the mouse apparatus 1505 entirely. There may be one or more retaining hooks 1507 that secure the enclosure cover 1506 in its closed position (not shown).

FIG. 78 shows a perspective view of a mouse apparatus 1510 similar to the mouse apparatus 1490 shown in FIG. 74 but employing a different car trunk-style hinge 1512 design to secure the enclosure cover 1511 to the mouse apparatus 1510 body. Aside from user preference and aesthetics, the choice of a hinge design for the enclosure cover is also dictated by durability, manufacturing costs, the size of typical items placed within the mouse cavity, and the like. Similar to mouse apparatus 1490, mouse apparatus 1510 also has an enclosure cavity 1492 where a USB jack 1493 is located. Two retaining hooks 1495 secure the enclosure cover 1511 and are released by pressing the release button 1496.

FIG. 79 shows a perspective view of a mouse apparatus 1515 with an integrated biometric scanner 1471 and a USB jack 1517 within the mouse cavity. A biometric scanner 1471 such as a fingerprint reader is similar to that shown in FIGS. 24 and 69. Two indicator LEDs 1472 that indicate the device status (enabled, disabled) and/or the authentication status (go, no-go) are shown. A reset button 1516 associated with the biometric scanner 1471 is also shown. Such a computer apparatus is suitable for users who require occasional or frequent access to a biometric scanner 1471 and a USB or Firewire jack for authentication purposes and prefer that such access is inconspicuous or does not create desktop clutter.

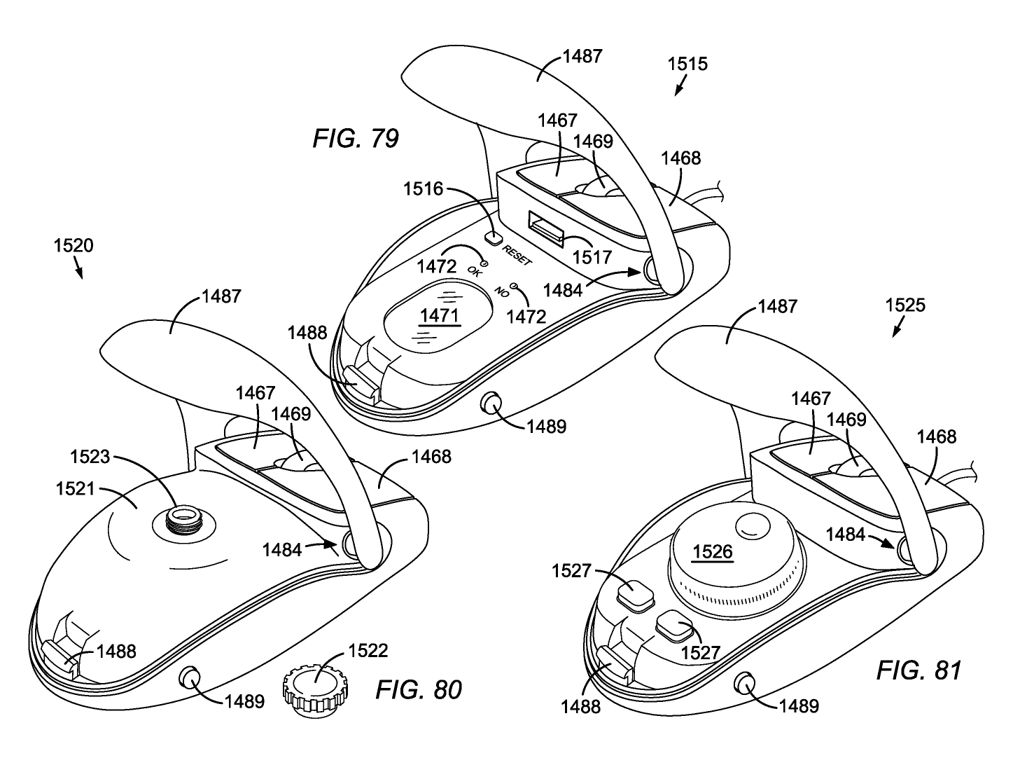

FIG. 80 shows a perspective view of a mouse apparatus 1520 with an integrated fuel cell 1521 to power the mouse apparatus electronics. Such a mouse apparatus is typically cordless. The representative fuel cell shown implies that the fuel cell 1521 may be refilled with fuel through the fuel inlet 1523 as required. A fuel tank safety cap 1522 prevents the fuel from spilling or evaporating. An alternative approach is to use a detachable and/or disposable fuel cell cartridge that is fitted into the mouse cavity to power the mouse apparatus. Fuel cell technologies that cater to small mobile device continue to be developed and commercialized. Any fuel cell technology that is used within the mouse apparatus should operate at moderate or low temperatures, have minimal byproducts (water is a common byproduct of large fuel cells), and allow convenient replacement of the spent fuel cartridges or easy refueling of the fuel cell. Fuel cell technology from other small mobile devices may also be adapted for use in the mouse apparatus. Potential technologies include direct methanol fuel cells (DMFC), which have a small methanol cartridge that converts methane to power. DMFCs have the ability to cleanly power a cordless mouse or keyboard apparatus.

FIG. 81 shows a perspective view of a mouse apparatus 1525 with an integrated rotating control knob 1526 located inconspicuously within the mouse cavity. The function of the rotating control knob 1526 is similar to that depicted in FIG. 70. Buttons 1527 or toggle switches incorporated within the mouse cavity permit the user to switch the function of the rotating control knob 1526. For example, one button may toggle the rotating control knob 1526 from controlling speaker volume to radio station frequency, and the other button may toggle between AM or FM reception. The radio electronics may be incorporated within the mouse apparatus 1525. Other uses for the rotating control include scrolling backwards or forwards in a video editing program, positioning an open order icon in a grid-based online trading program, or scrolling along the timeline of an audio or video editing program, and the like.

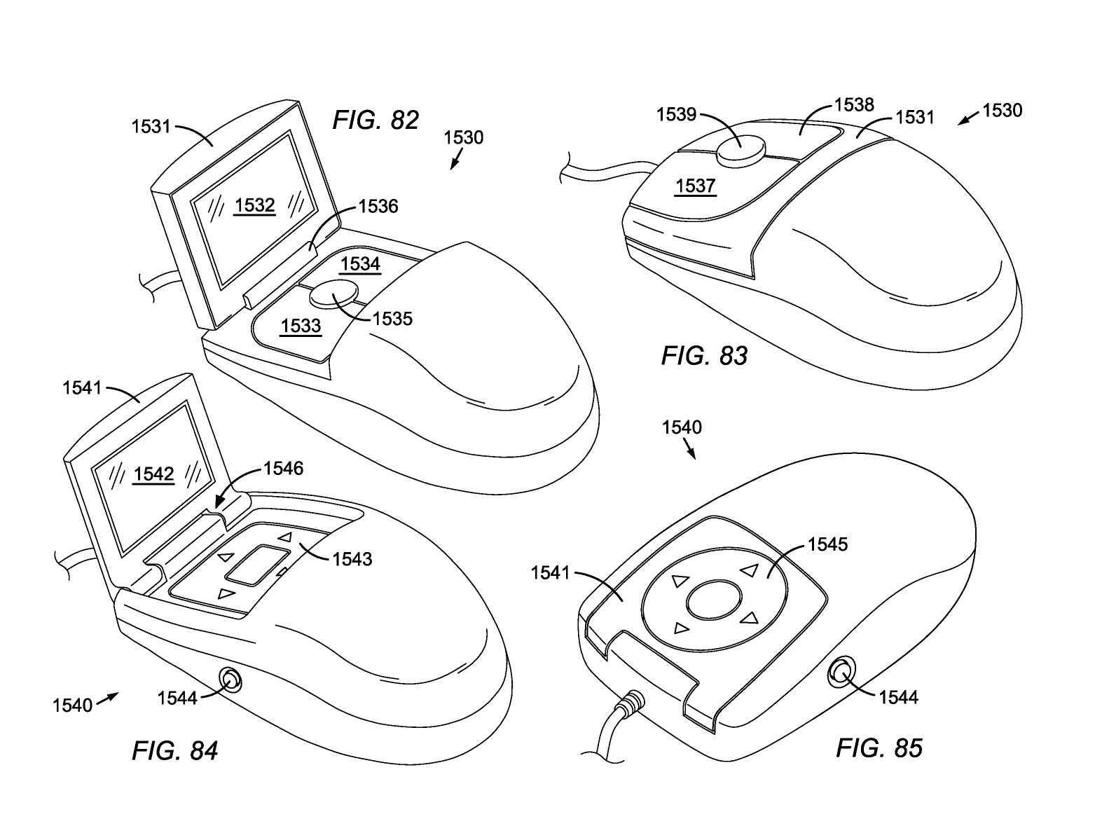

FIG. 82 shows a south-west perspective view of the mouse apparatus 1530 also shown in FIG. 83 but with the integrated display enclosure 1531 in its open position. The mouse apparatus 1530 of FIGS. 82-83 have a left click button 1533, right click button 1534, and a Trackpoint-style device 1535 located beneath the display enclosure 1531. The buttons 1533, 1534, 1535 located beneath the display enclosure 1531 may be used when the display enclosure 1531 is in the open position. The display screen 1532 may be used to view video content such as IPTV content, podcast or videocast content, multimedia presentations, reminder notices, IM messages, inter-office communications, and the like. The display enclosure 1531 is attached to the mouse apparatus 1530 via a hinge 1536 that permits the user to adjust the angle of the display screen 1532 for optimum contrast and convenient viewing.

FIG. 83 shows a south-west perspective view of the mouse apparatus 1530 shown in FIG. 82 but with the integrated display enclosure 1531 in its closed position. In the closed position, the mouse apparatus 1530 operates as a conventional mouse. Shown on the closed side of the hinged integrated display enclosure 1531 are left and right click buttons 1537, 1538 and a Trackpoint-style device 1539. A scroll wheel mechanism is too thick to be placed on the display enclosure housing.

FIG. 84 shows a north-west perspective view of a mouse apparatus 1540 with an integrated display screen 1542. A release button 1544 for the spring-loaded display enclosure 1541 is shown. A 5-way navigation button 1543 is used in place of the scroll wheel and left and right mouse buttons. The hinge 1546 allows the viewing angle of the display enclosure 1541 to be adjusted.

FIG. 85 shows a south-west perspective view of the mouse apparatus 1540 shown in FIG. 84 but with the display enclosure 1541 in its closed position. A 5-way navigation button 1545 is also used in place of the scroll wheel, while another 5-way navigation button 1543 is located beneath the display enclosure 1541.

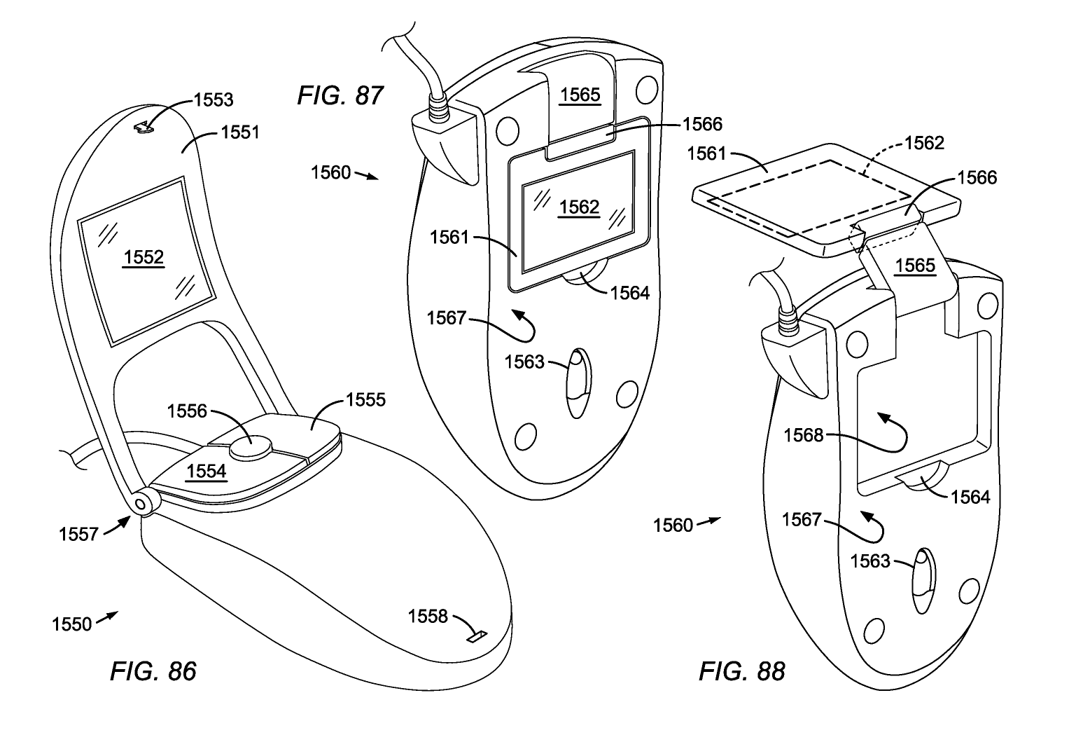

FIG. 86 shows a south-west perspective view of a mouse apparatus 1550 with an integrated clamshell-type display enclosure 1551. A retaining hook 1553 and its corresponding hook cavity 1558 for securing the clamshell-type display enclosure 1551 are shown.

FIG. 87 shows a perspective view of a mouse apparatus 1560 with an integrated display enclosure 1561 stored on the bottom surface of the mouse apparatus 1560. The bottom surface 1567 of the mouse apparatus 1560 is shown. The display enclosure 1561 may be manually opened and closed. Alternatively, a spring-loaded display enclosure with a release button (not shown) may be used to move the display enclosure in its open position.

FIG. 88 shows a perspective view of the mouse apparatus 1560 in FIG. 87 with the integrated display enclosure 1561 in its open position. The bottom surface 1567 of the mouse apparatus 1560 is shown. A finger indent 1564 is shown for conveniently lifting the display enclosure 1561 out of the display cavity 1568 when the display enclosure 1561 is in closed position. The display enclosure 1561 has two hinges 1565, 1566 in two to permit the display enclosure 1561 to swivel back and forth and left and right for optimum viewing by the user.

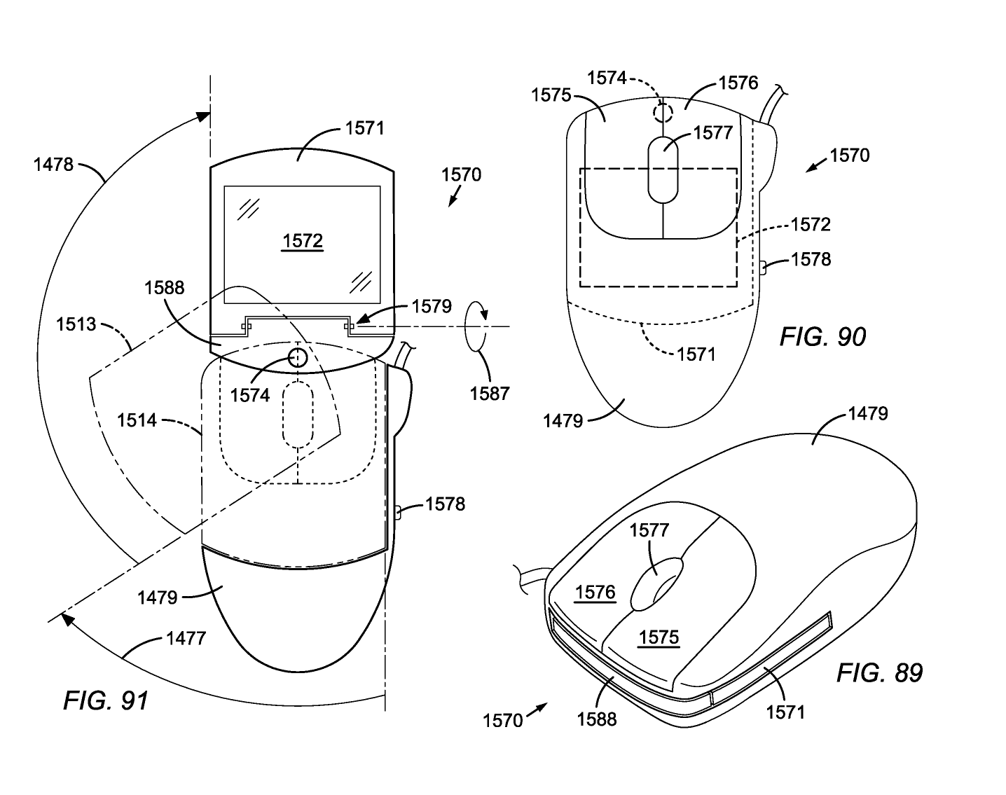

FIGS. 89-91 show views of a mouse apparatus 1570 with an integrated display screen 1572 stored inside the body of the mouse apparatus 1570. FIG. 89 shows a perspective view of the mouse apparatus 1570 with its display enclosure 1571 (shown in FIG. 91) in a closed or retracted position and stored within the mouse apparatus enclosure 1479. The left-click button 1575, right-click button 1576, and scroll wheel 1577 of mouse apparatus 1570 function in a conventional manner regardless of the position of the integrated display screen 1572.

FIG. 90 shows a top view of the mouse apparatus 1570 of FIG. 89. Shown in hidden outline are the relative positions of the display enclosure 1571, display screen 1572, and pivot hinge 1574 when the display enclosure 1571 is in a closed, retraced, or stored position. Release button 1578 unhooks the display enclosure 1571 and causes it to spring out of its storage cavity so that a user may further extend and position the display into its operating position. The operating position (not shown) of display enclosure 1571 is similar to the operating position of display enclosure 1581 shown in FIG. 94.

FIG. 91 illustrates a schematic top view of the mouse apparatus 1570 of FIG. 89 depicting the display enclosure 1571 as it pivots from inside to outside the mouse apparatus enclosure 1479. The display enclosure 1571

The display enclosure 1571 is shown in its stored position within the mouse apparatus 1570 as indicated by phantom line representation 1514. When released, the display enclosure 1571 may be pivoted outward as indicated by phantom line representation 1513 and pivot direction arrow 1477. The display enclosure 1571 is further pivoted and extended to its operating position as indicated by pivot direction arrow 1478.

The hinge enclosure 1588 is a part of the display enclosure 1571. The display enclosure 1571 is pivotably attached to the hinge enclosure 1588 via hinge pins 1579. The hinge enclosure 1588 is further pivotably attached to the mouse apparatus 1570 via pivot hinge 1574. The display enclosure 1571 has a pivot hinge 1574 that allows it to rotate in and out of the mouse apparatus 1570. Hinge pins 1579 allow the display enclosure 1571 to pivot upward as indicated by pivot axis direction arrow 1587 for optimum viewing by the user. The display screen 1572 is fixedly attached to display enclosure 1571. The display screen is typically the size of a cell phone display screen and may be color or black and white and available in a variety of resolutions and display technologies such as color active-matrix LCD, OLED, and the like.

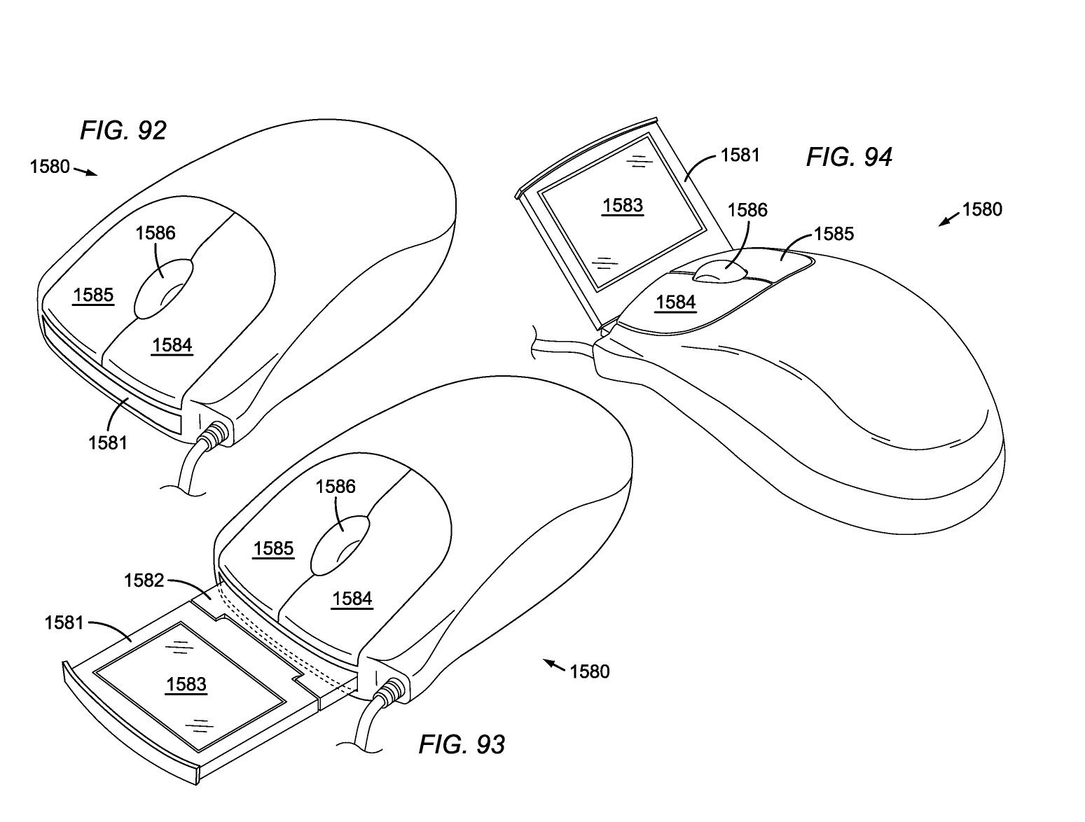

FIGS. 92-94 show various views of a mouse apparatus 1580 with an integrated display screen 1583 stored inside the body of the mouse apparatus. FIG. 92 shows a north-west perspective view of a mouse apparatus 1580 with its integrated display enclosure 1581 in a closed or retracted position. FIG. 94 shows a perspective view of a mouse apparatus 1580 with its integrated display enclosure 1581 extended from within the mouse apparatus 1580. FIG. 93 shows a south-west perspective view of a mouse apparatus 1580 with its integrated display enclosure 1581 in an open, extended, and pivoted forward operating position. A hinge enclosure 1582 on the display enclosure 1581 permits the display enclosure 1581 to pivot upward for optimum viewing by the user.

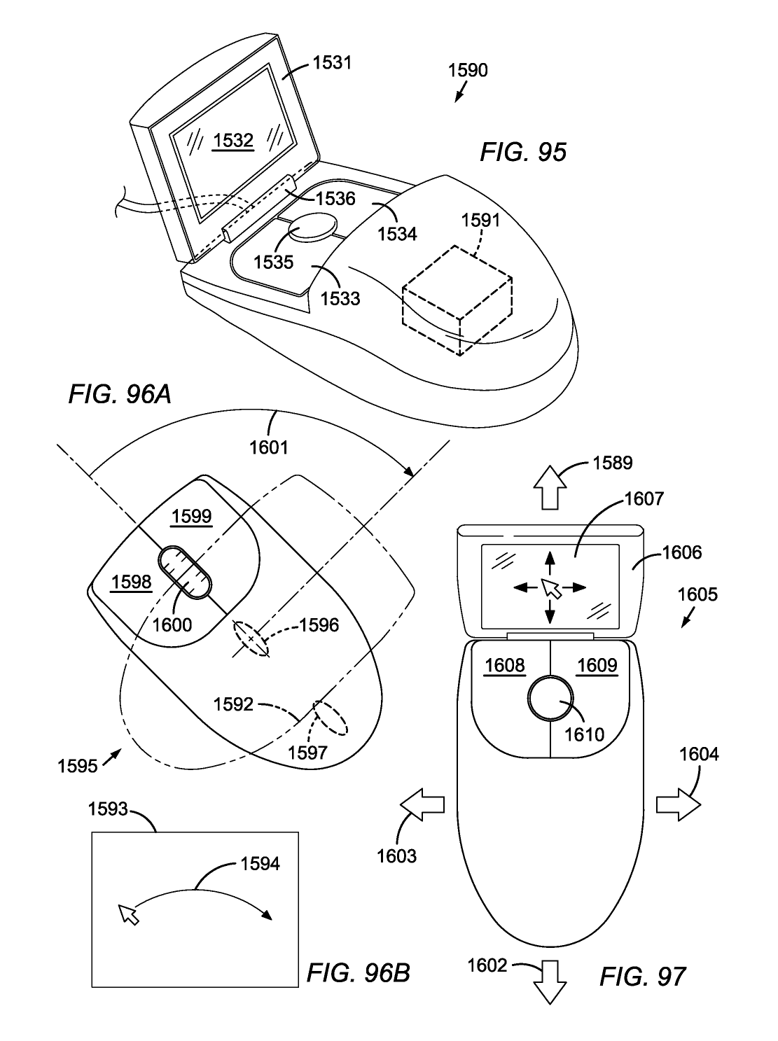

FIG. 95 shows a south-west perspective view of the mouse apparatus 1590 with an integrated display enclosure 1531 and a built-in TV tuner 1591. The TV tuner 1591 and its associated circuitry allow the integrated display screen 1532 and/or the host PCs' main display to present analog or digital radio and television programming. The TV tuner 1591 may also support reception of mobile cellular phone 3G, video, or television subscription content.

In conventional prior art mouse apparatus, a single displacement sensor cannot sense the rotation of the mouse about a pivot point. In a further embodiment of the present invention, mouse apparatus may incorporate two or more motion sensors or displacement sensors. Typically, each sensor is an optical sensor and each sensor is capable of providing X and Y displacement information to its host PC or host device. The two or more displacement sensors are physically separate to allow the mouse apparatus or host PC to adequately resolve a rotation component (if one is present) in the mouse apparatus movement. The two or more displacement sensors also provide redundancy in the motion sensing function of the mouse apparatus.

Accordingly, FIG. 96A shows a top view of a mouse apparatus 1595 with two integrated displacement sensors 1596, 1597. Also shown are a conventional left-click button 1598, right-click button 1599, and scroll wheel 1600. Typically, the representative displacement sensors 1596, 1597 are optical sensors. With data from two or more displacement sensors, and a suitable control algorithm, rotating the mouse apparatus 1595, as indicated by phantom line representation 1592 and pivot direction arrow 1601, on or about a stationary spot will result in the cursor (shown in FIG. 96B) on the host PC display screen 1593 to trace an arch or curve, as indicated by direction arrow 1594.

FIG. 96B shows a representative host PC display screen 1593 and the resulting path of a GUI style cursor, as indicated by direction arrow 1594, when the mouse apparatus 1595 is rotated as indicated by phantom line representation 1592 and pivot direction arrow 1601. When the mouse apparatus 1595 is moved left, right, up, and down in a linear fashion, the display cursor moves in a corresponding linear left, right, up, and down motion on the display screen 1593. When the mouse apparatus 1595 is rotated or pivoted about a pivot point on a physical surface, the display cursor moves in an arch or curve corresponding to the arch or curved path of the physical mouse apparatus 1595.

A mouse apparatus capable of detecting rotational motion and effecting such motion on the display cursor allows for more natural curved movements of the mouse apparatus when locating and interacting with icons or other GUI objects on the display screen 1593. A natural pivot point for the mouse apparatus is the user's wrist area. In such a case, the pivot point is located below the mouse apparatus. It should be understood that the pivot point associated with any rotational motion may exist within the mouse apparatus enclosure, for example, at the center of the mouse apparatus. The pivot point may also exist to the left, right, or above the mouse apparatus.

Preference settings on the mouse control panel allow each user to configure the speed of the cursor motion and the apparent radius of the cursor arch or curve. The second displacement sensor also provides a measure of redundancy and precision for interpolating or averaging the displacement data from both displacement sensors 1596, 1597 into one common value.

FIG. 97 shows a schematic top view of a mouse apparatus 1605 with an integrated display screen 1607 similar to the mouse apparatus of FIG. 95. If the integrated display screen 1607 is configured to show a cursor, the displayed cursor may be moved by a Trackpoint-style device 1610 which is accessible when the display enclosure 1606 is in its open or extended position, as shown in FIG. 97. The left-click button 1608 and right-click button 1609 are used, in such a case, to interact with and select items on the display screen 1607.

An alternative approach to controlling the cursor on the display screen 1607 is to calibrate the cursor control algorithm for the display screen 1607 to move in the opposite direction to the mouse apparatus 1605 movement or motion. The resulting effect is such that the display cursor appears stationary with respect to the physical surface the mouse apparatus rests or moves on.

For example, if the mouse apparatus 1605 moves left, as indicated by direction arrow 1603, by 1 cm, the display screen 1607 cursor may move right by 1 cm, thus appearing to be stationary relative to the surface on which the mouse apparatus 1605 moves. Similarly, a mouse apparatus up motion as indicated by direction arrow 1589, a down motion as indicated by direction arrow 1602, and a right motion as indicated by direction arrow 1604, result in the display screen 1607 cursor moving in an opposite motion down, up, and left direction respectively.

The display cursor motion need not correspond 1:1 with physical the mouse apparatus physical motion. The cursor motion may be a multiple or fraction of the physical motion. Such settings would be configured on the mouse configuration panel. The apparent stationary cursor (with respect to the physical surface) on a moving display screen 1607 permits the user with an alternative approach to using the display cursor to select items from menus, drop down lists, and the like, present on the display screen 1607. It should be understood that in a conventional host PC monitor, the monitor is stationary with respect to the desktop surface and the display screen cursor moves in the same direction as the mouse apparatus on its physical surface.

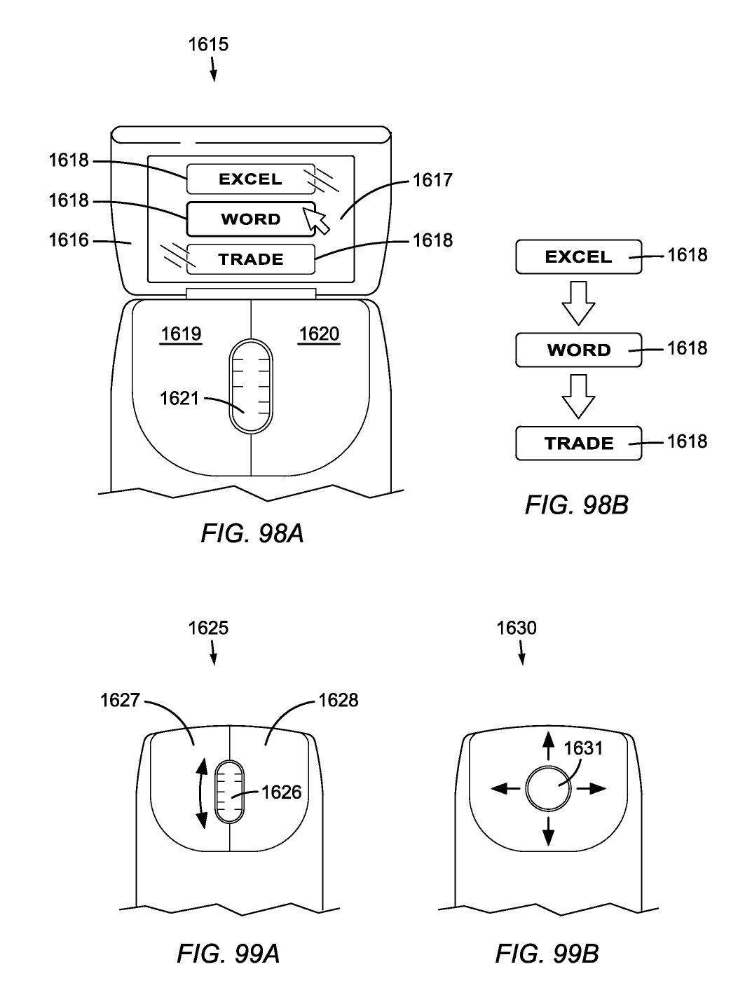

FIG. 98A shows a partial top view of a mouse apparatus 1615 with an integrated display screen 1617 fixedly attached to pivoting display enclosure 1616. The mouse apparatus 1615 of FIG. 98A is similar to the mouse apparatus 1580 of FIG. 94. Several display icons 1618 with their associated text labels are shown on the display screen 1617. Each display icon 1618 is selected, in sequence, by rotating the scroll wheel 1621. The selection may be effected by pressing the buttons associated with the scroll wheel 1621, left-click button 1619, and right-click button 1620. In such a manner, the display screen 1617 may be used to facilitate opening applications, or switching between applications, to select files stored on the host PC or the mouse apparatus, or to activate functions within applications without interrupting the primary host PC's display screen. Such an arrangement may be used, for example, to play movies or in gaming applications where it is undesirable to have windows or control panels pop into view on the host PC's display screen.

FIG. 98B shows a diagram of the display icon 1618 highlight sequence as each display icon 1618 is selected as the scroll wheel 1621 is scrolled down the list of available applications presented on the display screen 1617 of FIG. 98A.

FIG. 99A shows a partial top view of a mouse apparatus 1625 with an integrated display screen (not shown). The mouse apparatus 1625 of FIG. 99A is similar to the mouse apparatus 1580 of FIG. 92. When a scroll wheel 1626 is present, the scroll wheel 1626 may be used to scroll or toggle between choices presented on the integrated display (not shown) of mouse apparatus 1625. Choices are effected by pressing the buttons associated with the scroll wheel 1626, the left-click button 1627, or the right-click button 1628.

FIG. 99B shows a partial top view of a mouse apparatus 1630 with an integrated display screen (not shown). The mouse apparatus 1630 of FIG. 99B is similar to the mouse apparatus 1550 of FIG. 86. When it is present, the Trackpoint-style device 1631 may be used to scroll up and down, or left and right, or used to toggle between choices presented on the integrated display of the mouse apparatus 1630. Direction arrows near the scroll wheel 1626 of FIG. 99A or near the Trackpoint-style device 1631 of FIG. 99B indicate how GUI objects, icons, or items are scrolled or how a cursor is moved on such integrated displays.

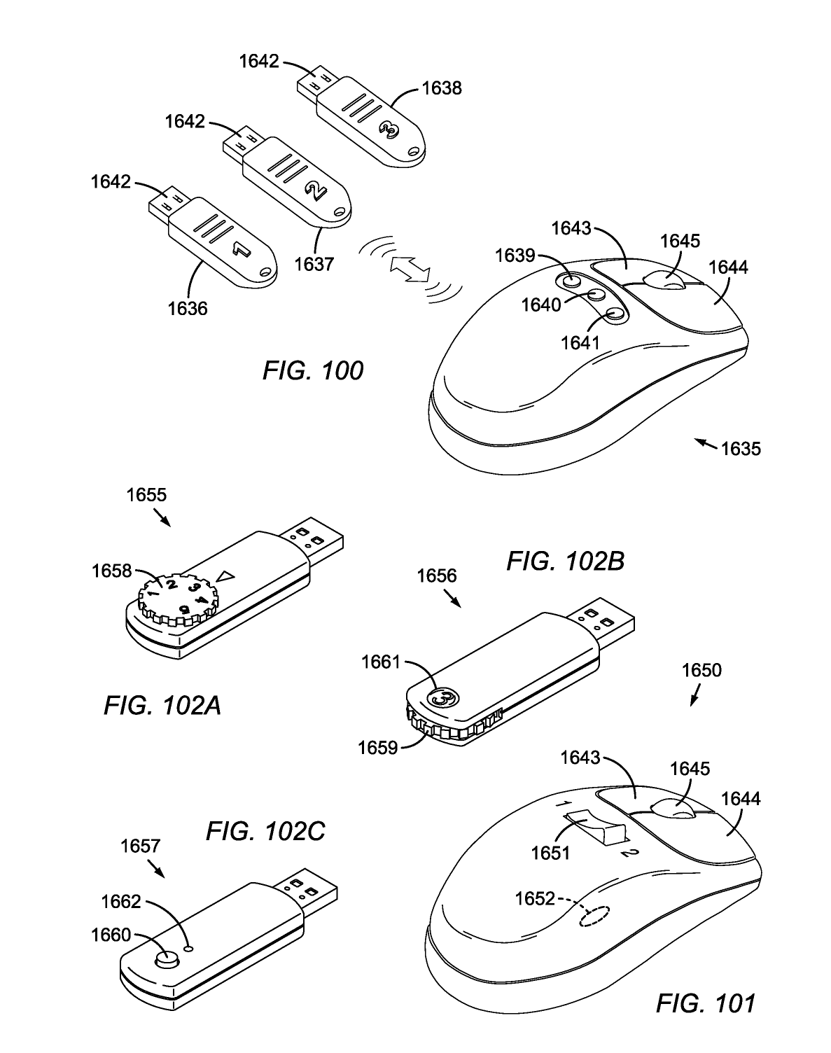

FIG. 100 shows a perspective view of a wireless multiple host mouse apparatus 1635 which may operate across multiple host PCs. A dongle 1636, 1637, 1638 is attached to one or more host PCs. The user presses a button 1639, 1640, 1641 on the mouse apparatus associated with a specific dongle that is attached to a specific host PC. Content buttons may also be present to reset or change the frequency used to communicate with each dongle. Typically, the dongle 1636, 1637, 1638 connects to the host PC using a USB plug 1642. When the user switches the wireless multiple host mouse apparatus 1635 to a different host PC, the previous host PC does not warn of a missing mouse apparatus but merely shows the mouse cursor in a stationary position on the host PC display.

FIG. 101 shows a south-east perspective view of a multiple host mouse apparatus 1650 using a toggle switch 1651 to switch between 2 host PCs in a convenient and intuitive manner. The LED sensor 1652 is shown in hidden outline. Although a wireless approach is preferred, a multiple host mouse apparatus 1650 may also utilize a wired connection to the host PCs. In a wired arrangement, the cable used will branch out and connect to the desired host PCs. Similarly, a combination wired (cable attached to one host PC) and wireless approach (using a dongle attached to the other host PCs) may be used.

FIGS. 102 (A, B, and C) show isometric views of various wireless dongles 1655, 1656, 1657 that may connect to a host PC when a multiple host mouse apparatus is used. FIG. 102A illustrates a dongle 1655 with a selection knob 1658. The selection knob 1658 is rotated until the desired button on the multiple host mouse apparatus to control the host PC is selected. FIG. 102B illustrates a dongle 1656 with a selection knob 1659. The selection knob 1659 is rotated until the desired button on the multiple host mouse apparatus to control the host PC is seen through the selection indicator window 1661. FIG. 102C illustrates a dongle 1657 with a selection button 1660. The selection button 1660 controls whether a multiple host mouse apparatus can or cannot communicate with the dongle 1657. Communication to and from the multiple host mouse apparatus to the dongle 1657 may be indicated by the status LED 1662.

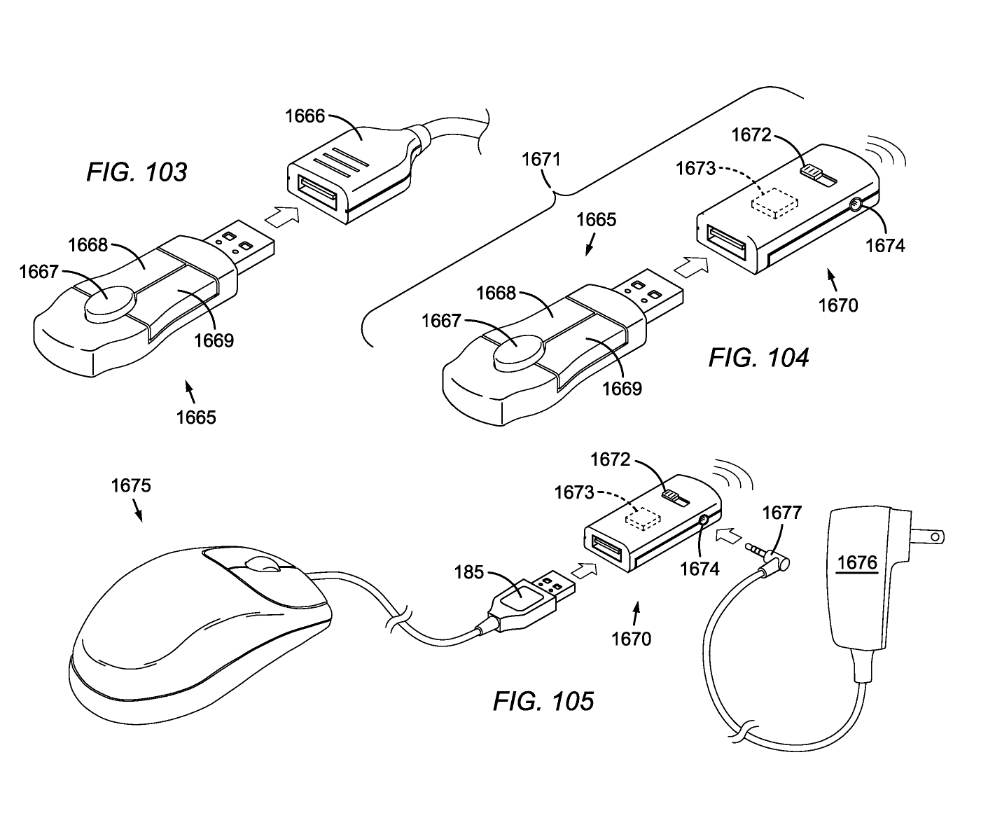

FIG. 103 shows an isometric view of a miniature USB mouse apparatus 1665 being connected to a USB extension cable 1666. The miniature USB mouse apparatus 1665 may utilize an optical sensor (not shown) as the displacement element or a Trackpoint-style device 1667 to move the cursor on a host PC display. The miniature USB mouse apparatus 1665 may be powered by internal rechargeable batteries (not shown) or via the USB extension cable 1666.

FIG. 104 shows an isometric view of the miniature USB mouse apparatus 1665 of FIG. 103 being connected to a wireless transmitter module 1670. Used together, the miniature mouse apparatus 1665 and the wireless transmitter module 1670 function as a wireless mouse apparatus 1671. The wireless transmitter and interface electronics circuitry are shown as a wireless module 1673 in representative hidden outline. The transmitter sends the mouse's displacement data to a wireless dongle connected to a host PC. Examples of such wireless dongles are shown in FIGS. 100, 102, and 106. The wireless transmitter module 1670 has an on/off switch 1672. The wireless transmitter module 1670 may also accept input from a cable-wired mouse apparatus shown in FIG. 105 or cable wired keyboard apparatus. The wireless transmitter module 1670 may be powered by internal rechargeable batteries or via the USB connection. A power supply jack 1674 is included on the wireless transmitter module 1670 for power charging purposes. A left-click button 1668, right-click button 1669, and a Trackpoint-style device 1667 are included in the miniature USB mouse apparatus for basic mouse operations like cursor pointing and icon selection.

FIG. 105 shows a perspective view of a cable-wired mouse apparatus 1675 with a corresponding USB plug 185 being connected to a wireless transmitter module 1670. An AC/DC adapter 1676 with a power supply plug 1677 is available for connection to the wireless transmitter module 1670 through the power supply jack 1674 and supplies power to both the cable-wired mouse apparatus 1675 and the wireless transmitter module 1670 if necessary. The wireless transmitter and the interface electronics circuitry is shown as an wireless module 1673 in representative hidden outline.

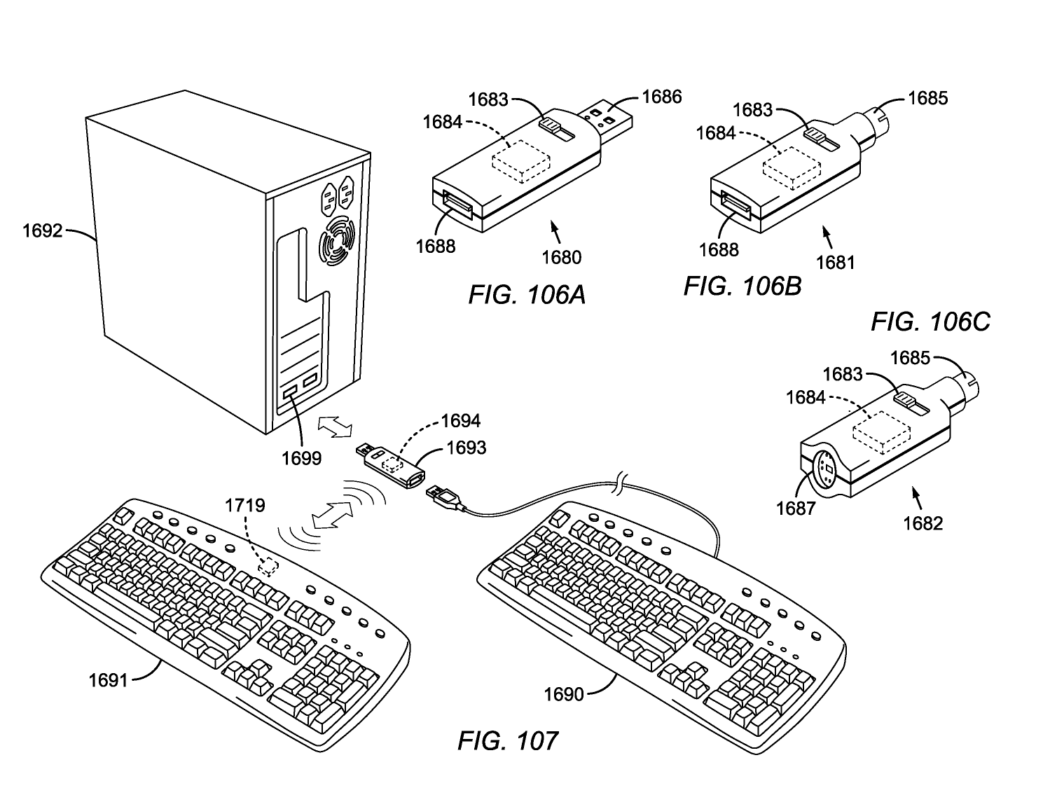

FIGS. 106A-106C show an isometric view of hybrid dongle adapters 1680, 1681, 1682 (either wired and wireless) suitable for supporting the function of a multiple host mouse apparatus as shown in FIGS. 100 and 101 or a multiple host keyboard apparatus as shown in FIGS. 107-115, and 117. The hybrid dongle adapters 1680, 1681, 1682 permit a conventional wired keyboard or mouse to be used on a host PC and also permit signals from a wireless multiple host mouse or keyboard apparatus to communicate with the host PC to which a hybrid dongle is attached. Typically, the host PC system cannot detect if the keyboard signal or mouse signal is arriving from the conventional wired keyboard or mouse or from the wireless multiple host mouse or keyboard apparatus. The hybrid dongle adapters 1680, 1681, 1682 feature an on/off switch 1683 to disable the wireless dongle circuitry. A representative wireless module 1684 (shown in hidden outline) defines the circuitry of the wireless dongle receiver and the interface and switching electronics associated with a hybrid dongle adapter 1680, 1681, 1682. The hybrid dongle adapters 1680, 1681, 1682 may connect to the host PC using a PS2 connector 1685 or USB connector 1686. A PS2 port 1687 or USB port 1688 may be provided on the hybrid dongle adapters 1680, 1681, 1682 to permit a variety of conventional keyboards or mouse apparatus to be attached to the host PC through the hybrid dongle adapters 1680, 1681, 1682. The hybrid dongle adapter 1680, 1681, 1682 takes its power from the host PC.

FIG. 107 shows a perspective view of a conventional keyboard apparatus 1690 attached to a host PC 1692 through a hybrid dongle 1693. The hybrid dongle 1693 connects to the host PC 1692 via a USB port 1699. A multiple host keyboard apparatus 1691 is also shown communicating wirelessly with the host PC 1692 via representative wireless transmitting and receiving wireless module 1719 shown in hidden outline. As mentioned previously, the host PC 1692 generally cannot distinguish between keyboard input arriving from the conventional keyboard apparatus 1690 or the multiple host keyboard apparatus 1691. The wireless module 1694 shown in hidden outline represents the buffer memory and switching circuitry within the hybrid dongle 1693 necessary to prevent the two keyboard signals from interfering with each other. Generally, only one keyboard is used with each host PC 1692 at one time.

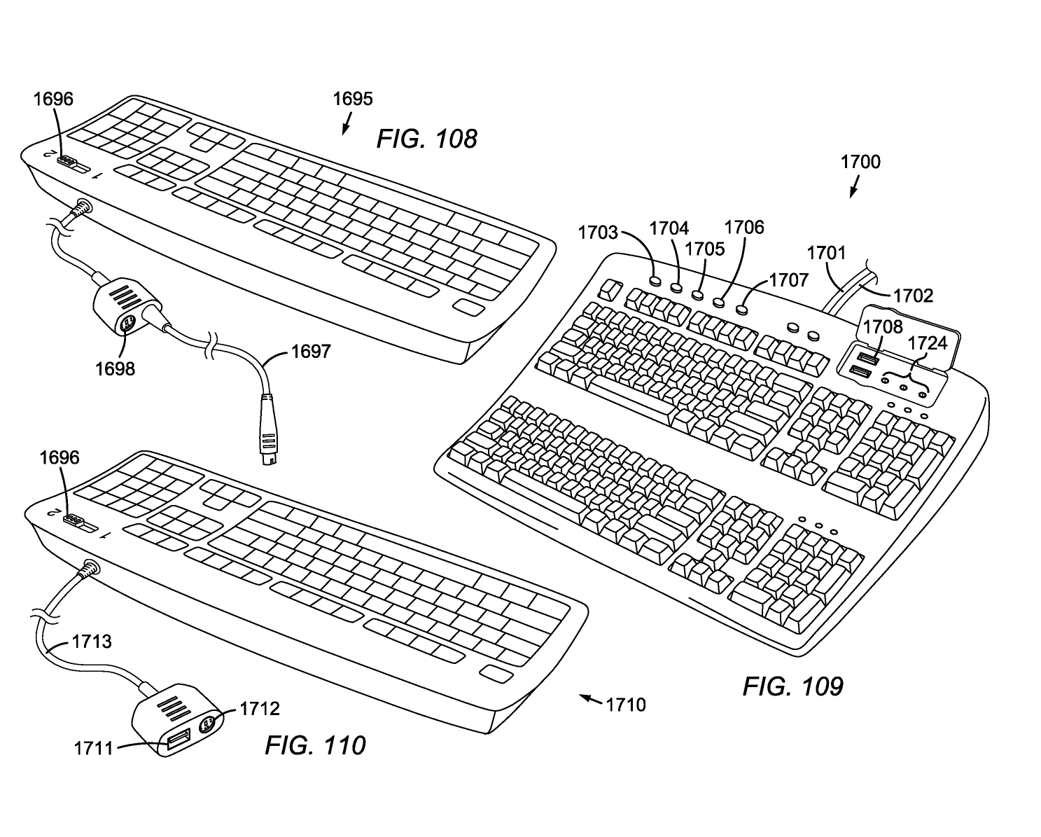

FIG. 108 shows a perspective view of a wired multiple host keyboard apparatus 1695. A switch 1696 is provided to indicate the host PC to which the keyboard output (keystrokes) is directed toward. Although two separate PS2 keyboard cables 1697 (one for each host PC) may attach to the multiple host keyboard apparatus 1695, FIG. 108 indicates only one PS2 keyboard cable 1697 is provided. If a second host PC connection is desired, the user may obtain an extension cable to connect to the second host PC from the PS2 port 1698 on the cable connector. Although a PS2 keyboard cable 1697 and PS2 port 1698 are shown, the multiple host keyboard apparatus 1695 may connect to each host PC through other means, such as a USB jack and connector.

FIG. 109 shows a perspective view of a dual keyboard apparatus 1700. The dual keyboard apparatus 1700 shown contains two full sets of standard keys, one for each host PC or host PC group. The two cables 1701, 1702 from the keyboard apparatus are inserted into their respective host PCs. The top keyboard may also connect to other host PCs via wireless dongles. Each of the five (5) buttons 1703, 1704, 1705, 1706, 1707 on the top row of the first keyboard is associated with a specific wireless dongle. Also shown are USB jacks 1708 for connection of additional devices to extend the functionality of the keyboard apparatus. Headset and speaker jacks 1724 are included on the dual keyboard apparatus 1700 for additional connectivity to devices such as earphones, speakers, and microphones.

FIG. 110 shows a perspective view of a wired multiple host keyboard apparatus 1710 similar to FIG. 108 but with two different host PC connector ports. A USB port 1711 and a PS2 port 1712 are shown terminating a single cable 1713 from the multiple host keyboard apparatus 1710. Such an arrangement may be desirable for mixing different host PCs to the multiple host keyboard apparatus 1710. A switch 1696 is used to indicate which host PC the keyboard output is directed toward.

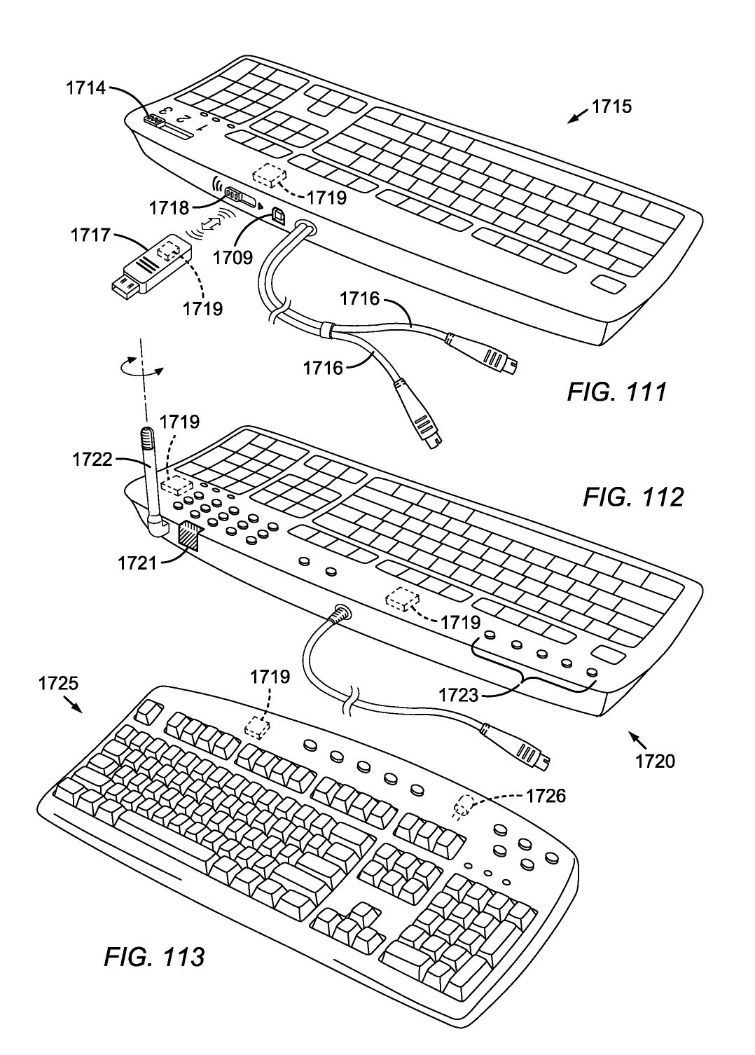

FIG. 111 shows a perspective view of a hybrid multiple host keyboard apparatus 1715 having wired and wireless functionality. The hybrid multiple host keyboard apparatus 1715 supports three (3) host PCs. A 3-way switch 1714 is provided on the hybrid multiple host keyboard apparatus 1715 to indicate to which host PC the keyboard output is directed. Two host PCs may be connected to the hybrid multiple host keyboard apparatus 1715 by standard PS2 keyboard cables 1716. A third host PC may be connected either using a wireless dongle 1717 or a USB-style extension cable (not shown). A switch 1718 is provided to indicate the manner of connecting to the third host PC. Representative wireless transmitting and receiving wireless module 1719 are shown in hidden outline. A USB port 1709, which is a series “B” receptacle, is included for additional connectivity to other devices.

FIG. 112 shows a perspective view of a multiple host keyboard apparatus 1720 with an integrated remote control. The remote control device may use an RF approach, an IR approach, or both. The functionality of the multiple host keyboard apparatus 1720 of FIG. 112 is similar to the functionality of the mouse apparatus 1450 of FIG. 66. The keyboard apparatus of FIG. 112 may also operate on multiple host PCs. The IR emitter 1721 is typically mounted on the forward edge of the multiple host keyboard apparatus 1720. An antenna 1722 or swiveling optical waveguide may also be used to extend the range of the remote control transmitting element. Representative wireless transmitting and receiving wireless module 1719 are shown in hidden outline. A wired cable (not shown) is provided for the first host PC. Buttons 1723 on the keyboard apparatus allow the user to direct the keyboard output to other host PCs connected to the multiple host keyboard apparatus via a wireless dongle.

FIG. 113 shows a perspective view of a multiple host keyboard apparatus 1725 that can support multiple wireless host PCs. The multiple host PCs are connected to the multiple host keyboard apparatus 1725 via their respective wireless dongles. An IR emitter 1726 built into the device permits the multiple host keyboard apparatus 1725 of FIG. 113 to direct keyboard output or remote control signals to devices that accept IR input signals. Such devices include WebTV, televisions, home entertainment systems, DVD players, digital video recorders, and the like.

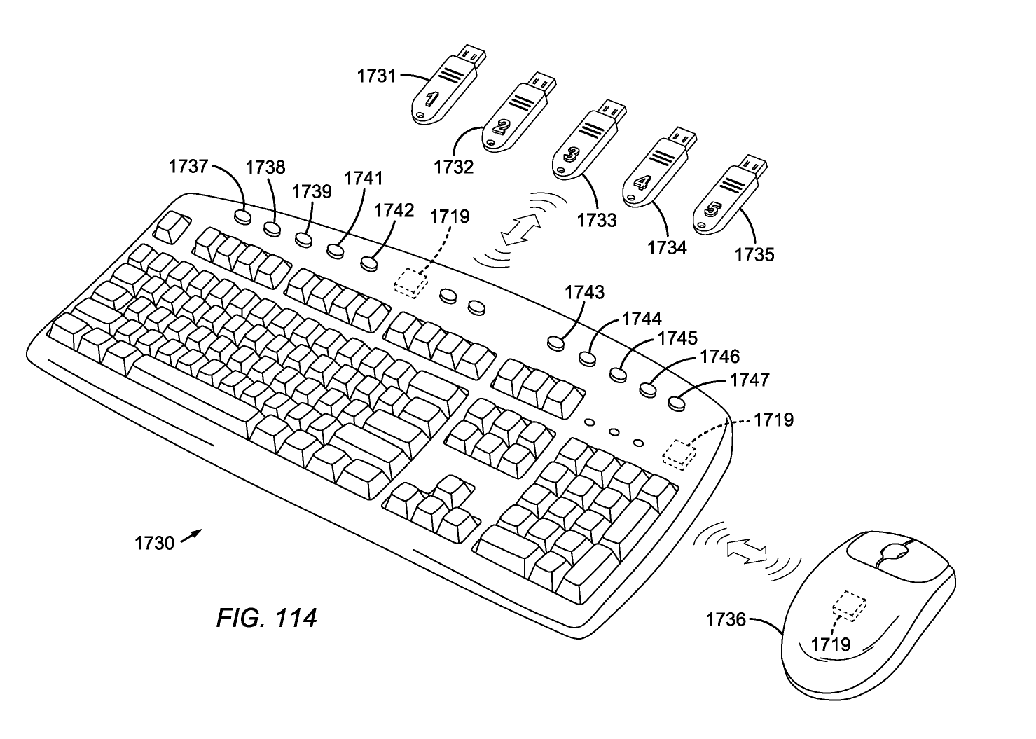

FIG. 114 shows a perspective view of a multiple host keyboard apparatus 1730. Five (5) host PC wireless dongles 1731, 1732, 1733, 1734, 1735 and a multiple host mouse apparatus 1736 are also shown. The multiple host mouse apparatus 1736 may operate independently of the multiple host keyboard apparatus 1730 or in conjunction with it. For example, the keyboard apparatus host PC selection buttons 1743, 1744, 1745, 1746, 1747 that select which host PC the keyboard output is directed towards may also simultaneously switch the multiple host mouse apparatus 1736 output to the same host PC. In this arrangement, only one host PC button needs to be pressed to change both the keyboard apparatus and the mouse apparatus output. Otherwise, 2 sets of buttons will be needed. In FIG. 114, the mouse apparatus host PC selection buttons 1737, 1738, 1739, 1741, 1742 are located on the top left side of the multiple host keyboard apparatus 1730 while the keyboard apparatus host PC selection buttons 1743, 1744, 1745, 1746, 1747 are located on the top right. Representative wireless transmitting and receiving wireless module 1719 are shown in hidden outline.

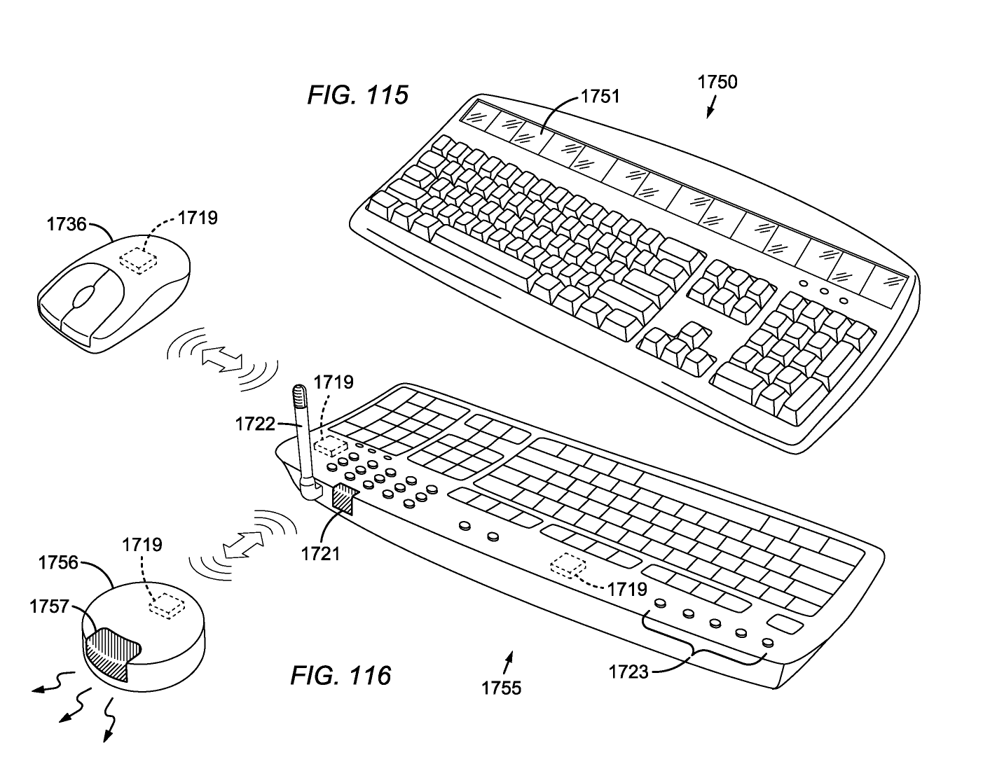

FIG. 115 shows a perspective view of a multiple host keyboard apparatus 1750 (for wireless operation) with an integrated solar panel 1751. The solar panel 1751 powers the keyboard electronics and the wireless dongle transmitter (not shown). If the wired host PC connections are all powered off or shut down, the multiple host keyboard apparatus 1750 may still communicate with other wireless host PCs if it is able to provide a secondary means of obtaining power for the keyboard apparatus electronics. Such secondary means may include batteries, an AC/DC adapter, or solar power.

FIG. 116 shows a perspective view of a multiple host keyboard apparatus 1755 with an integrated remote control similar to the multiple host keyboard apparatus 1720 of FIG. 112. However, the multiple host keyboard apparatus 1755 of FIG. 116 has an IR repeater puck 1756 that extends the range of the IR signal from the multiple host keyboard apparatus 1755. The signal to the IR repeater puck 1756 is supplied from the multiple host keyboard apparatus 1755 by longer-range RF frequencies. When the IR repeater puck 1756 receives the RF signal, the signal is demodulated and re-modulated for the signal requirements of the IR emitter 1757 on the IR repeater puck 1756. The IR repeater puck 1756 is positioned closer to the IR devices than the multiple host keyboard apparatus 1755 itself. With the multiple host keyboard apparatus 1755 of FIG. 116, the user may control a TV or a home entertainment system at considerable distances from the multiple host keyboard apparatus 1755 without leaving their desk to adjust such units manually.

FIG. 117 shows a perspective view of a multiple host keyboard apparatus 1760 that supports Bluetooth and other mobile device wireless standards such as IR. The multiple host keyboard apparatus 1760 of FIG. 117 permits output keystroke data from the multiple host keyboard apparatus 1760 to be directed to cellular phones 1761, PDAs 1762, and other devices at the flick of a switch on the multiple host keyboard apparatus 1760. Applications include using the multiple host keyboard apparatus 1760 to compose SMS messages, input PDA data, and copy and paste content from one host PC to the targeted mobile device. A display 1759 is included in the multiple host keyboard apparatus 1760 to monitor the current functions of the keyboard apparatus. A liquid crystal display (LCD) may be used for the display 1759.

FIG. 118 shows a perspective view of a mouse apparatus 1752 with an integrated USB cable powered battery charger. The battery charger may be designed to charge different battery chemistry (Lithium Ion, Ni-MH, Ni—Cd, Alkaline, and the like) and different battery sizes, types, or models. Shown are exemplary rechargeable battery 1754 which are removably inserted into associated battery cavity 1753 for charging. A status LED 1662 disposed on or within the mouse apparatus 1752 indicate when battery charging is active or complete. The mouse apparatus 1752 and the integrated battery charger receive their power from a wired connection 108 to a USB port typically located on a host PC.

The battery charger may be adapted to charge several AA and/or AAA battery types simultaneously. The battery charger section may also be adapted to charge cell phone batteries, similar small battery types, or provide a dock to charge small devices with an embedded rechargeable battery. Examples of such small devices include MP3 players, cell phones, and iPod™ branded devices. An iPod Shuffle or small MP3 player may also dock to a host device for downloading music or recharging through such a mouse apparatus. Also shown are left-click button 1467, right-click button 1468, scroll wheel 1469, enclosure cover 1487, retaining hook 1488, and release button 1489 which share a common purpose with the mouse apparatus embodiments shown in FIGS. 72, 79, 80, 81, and the like.

It should be understood that the various mouse apparatus and keyboard apparatus devices depicted in FIGS. 1-117 are sub-categories of the computer apparatus referred to within this specification as the present invention. Generally, the mouse apparatus, the keyboard apparatus, and other apparatus depicted in FIGS. 1-117 may establish a wired or wireless connection to their host PCs or other electronic devices. Although a single cable is preferred, a wired approach does not always imply a single cable from the computer apparatus terminating in a single wired connector, nor does a wireless approach imply a single wireless communications channel to a mobile device or dongle connected to a host PC. Rather, multiple wires or cables each terminating with a specific connector may be used as necessary or desirable. Similarly, multiple wireless frequencies, channels, and wireless standards such as Bluetooth, w-USB, or Wi-Fi may be used in the case of a wireless approach. Furthermore, one or more specific devices, modules, or electronic circuitry within the computer apparatus may communicate with their host device or other devices with a wired connection, while other devices, modules, or electronic circuitry within the computer apparatus may communicate using a wireless approach. In each case, the choice of a wired, wireless, or combination approach depends on many design considerations including manufacturing costs, performance, usability, set-up time, reliability, battery life, power consumption, repair times, software, drivers, and the like. A wired connection implies a physical connection from the computer apparatus to a host PC, network device, gadget, and the like. The wired connection also implies one or more metallic wires capable of conducting electricity, a fiber optic link, or both. A wireless connection implies either an RF approach using antennas, receivers, transmitters, and/or transceivers, an optical approach using optical or IR emitters and/or detectors, or a magnetic, capacitive, or inductive approach, or some combination of all such wireless approaches.

As will be apparent to those skilled in the art, the present invention may be embodied in other specific forms and variations without departing from the essential characteristics and true spirit thereof. Accordingly, the foregoing description is intended to be illustrative, but not limiting. The intended scope of the invention may thus include other embodiments that do not differ from the literal language of the claims. The scope of the present invention is accordingly defined as set forth in the following claims.

The embodiments of the invention in which an exclusive property or privilege is claimed are defined as follows.

What is claimed is:

1. A computer mouse apparatus comprising an enclosure, at least two displacement sensors, electronics and software associated with the function of said at least two displacement sensors, a wired or wireless connection to a host device, and at least one button to select icons or GUI objects on a display screen; wherein said electronics and software associated with the function of said at least two displacement sensors detect mouse apparatus pivot or rotational movements and facilitate the plotting of said pivot or rotational movements on a display screen as a curved or arched cursor path.

2. A multiple host keyboard apparatus comprising an enclosure, electronics and software associated with the function of said keyboard apparatus, a wired or wireless connection to one or more host PCs or related devices, at least one button to select icons or GUI objects on a display screen associated with a specific host PC or related device, and one or more buttons to direct the keyboard apparatus data output to at least two different host PCs or related devices.

3. A multiple host mouse apparatus comprising an enclosure, at least one displacement sensor, electronics and software associated with the function of said mouse apparatus, a wired or wireless connection to one or more host PCs or related devices, at least one button to select icons or GUI objects on a display screen associated with a specific host PC or related device, and one or more buttons to direct the mouse apparatus data output to at least two different host PCs or related devices.
